(19) United States
(12) Patent Application Publication
(10) Pub. No.: US 2024/0397252 A1
(43) Pub. Date: Nov. 28, 2024

(54) SPEAKERS

(71) Applicant: SHENZHEN SHOKZ CO., LTD., Shenzhen (CN)

(72) Inventors: Wenbing ZHOU, Shenzhen (CN); Lei ZHANG, Shenzhen (CN); Xin QI, Shenzhen (CN); Fengyun LIAO, Shenzhen (CN); Shanyong GU, Beijing (CN)

(73) Assignee: SHENZHEN SHOKZ CO., LTD., Shenzhen (CN)

(21) Appl. No.: 18/797,459

(22) Filed: Aug. 7, 2024

Related U.S. Application Data
(63) Continuation of application No. PCT/CN2023/125459, filed on Oct. 19, 2023.

(30) Foreign Application Priority Data
Nov. 8, 2022 (CN) 202211392438.X

(51) Int. Cl. H04R 1/28; H04R 1/02; H04R 7/04; H04R 7/18; H04R 17/00

(52) U.S. Cl. CPC H04R 1/2811; H04R 1/025; H04R 7/04; H04R 7/18; H04R 17/00

(57) ABSTRACT

Embodiments of the present disclosure provide a speaker. The speaker may include a driving unit, a vibrating unit, a vibration transmission part, and a housing. The driving unit may be configured to generate vibrations under the drive of an electrical signal. The vibration transmission part may be connected to the driving unit and the vibrating unit, and configured to transmit the vibrations to the vibrating unit to produce sound radiated outwardly. The housing may be configured to accommodate the driving unit, the vibrating unit, and the vibration transmission part.

### CROSS-REFERENCE TO RELATED APPLICATIONS

This application is a Continuation of International Patent Application No. PCT/CN2023/125459, filed on Oct. 19, 2023, which claims priority to Chinese Patent Application No. 202211392438.X, filed on Nov. 8, 2022, the entire contents of each of which are incorporated herein by reference.

### TECHNICAL FIELD

The present disclosure relates to the field of acoustic technology, and in particular to a speaker.

### BACKGROUND

A speaker mainly includes a driving part, a vibrating part, a vibration transmission part, and a housing. The vibrating portion may include a diaphragm assembly including a diaphragm, a central reinforcing part, or the like. For a constant driving force of the driving portion, by reasonably designing the vibrating part, the vibrating part may achieve a better mechanical impedance matching with the driving part, so as to obtain an output effect with a high sound pressure level and a high bandwidth.

However, the currently used speakers, especially micro speakers, suffer from problems such as insufficient driving capability of the vibrating part. Therefore, to achieve high sound pressure level output, it is desirable to study and improve the driving ability of the driving part of the speaker and optimize a structure of the vibrating part that matches the driving part, so as to obtain better acoustic output.

### SUMMARY

One of the embodiments of the present disclosure provides a speaker. The speaker may include a driving unit, a vibrating unit, a vibration transmission part, and a housing. The driving unit may be configured to generate vibrations under the drive of an electrical signal. The vibration transmission part may be connected to the driving unit and the vibrating unit, and configured to transmit the vibrations to the vibrating unit to produce sound radiated outwardly. The housing may be configured to accommodate the driving unit, the vibrating unit, and the vibration transmission part.

Additional features will be set forth in part in the following descriptions and will become apparent to those skilled in the art by reference to the following and the accompanying drawings, or may be understood through the practice or use of the embodiments. Features of the present disclosure may be realized and obtained by practicing or using aspects of the methods, tools, and combinations set forth in the following detailed embodiments.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating a structure of an exemplary speaker according to some embodiments of the present disclosure;

FIG. 2A is a schematic diagram illustrating a structure of an exemplary speaker according to some embodiments of the present disclosure;

FIG. 2B is a schematic diagram illustrating an exemplary cross-sectional view of the speaker illustrated in FIG. 2A;

FIG. 2C is a schematic diagram illustrating another exemplary cross-sectional view of the speaker illustrated in FIG. 2A;

FIG. 2D is a schematic diagram illustrating yet another exemplary cross-sectional view of the speaker illustrated in FIG. 2A;

FIG. 3 is a schematic diagram illustrating a structure of an exemplary diaphragm assembly according to some embodiments of the present disclosure;

FIG. 4 is a schematic diagram illustrating a structure of an exemplary driving unit according to some embodiments of the present disclosure;

FIG. 5 is a schematic diagram illustrating an enlarged view of a structure of an exemplary piezoelectric beam according to some embodiments of the present disclosure;

FIG. 6 is a schematic diagram illustrating a structure of exemplary piezoelectric layers according to some embodiments of the present disclosure;

FIG. 7 is a schematic diagram illustrating a structure of an exemplary vibrating unit according to some embodiments of the present disclosure;

FIG. 8 is a schematic diagram illustrating frequency response curves of a speaker with a diaphragm assembly having different area ratios according to some embodiments of the present disclosure;

FIG. 9 is a schematic diagram illustrating an exemplary structure of a central reinforcing part according to some embodiments of the present disclosure;

FIG. 10 is a schematic diagram illustrating frequency response curves of a speaker with a central reinforcing part having different area ratios according to some embodiments of the present disclosure;

FIG. 11 is a schematic diagram illustrating an exemplary structure of a central reinforcing part according to some embodiments of the present disclosure;

FIG. 12 is a schematic diagram illustrating an exemplary structure of a central reinforcing part according to some embodiments of the present disclosure;

FIG. 13 is a schematic diagram illustrating an exemplary structure of a central reinforcing part according to some embodiments of the present disclosure;

FIG. 14 is a schematic diagram illustrating frequency response curves of a speaker with a central reinforcing part having different structures according to some embodiments of the present disclosure;

FIG. 15A is a schematic diagram illustrating an exemplary structure of a coupling elastic structure according to some embodiments of the present disclosure;

FIG. 15B is a schematic diagram illustrating a distribution of layers of a piezoelectric beam along a vibration direction according to some embodiments of the present disclosure;

FIG. 16 is a schematic diagram illustrating frequency response curves of a speaker when a parameter of a coupling elastic structure varies according to some embodiments of the present disclosure;

FIG. 17 is a schematic diagram illustrating another exemplary structure of a coupling elastic structure according to some embodiments of the present disclosure;

FIG. 18 is a schematic diagram illustrating c frequency response curves of speakers having coupling elastic structures with different structures according to some embodiments of the present disclosure;

FIG. 19 is a schematic diagram illustrating frequency response curves of a speaker corresponding to different parameters a according to some embodiments of the present disclosure;

FIG. 20 is a schematic diagram illustrating a structure of a speaker according to some embodiments of the present disclosure;

FIG. 21 is a schematic diagram illustrating frequency response curves of a speaker when a physical parameter β takes different values according to some embodiments of the present disclosure;

FIG. 22A and FIG. 22B are schematic diagrams illustrating deformations of piezoelectric beams with different shapes according to some embodiments of the present disclosure;

FIG. 23 is a schematic diagram illustrating a structure of a trapezoidal piezoelectric beam according to some embodiments of the present disclosure;

FIG. 24 is a schematic diagram illustrating frequency response curves of a speaker when a physical parameter θ takes different values according to some embodiments of the present disclosure;

FIG. 25A-FIG. 25F are schematic diagrams illustrating piezoelectric beams with different shapes and structures according to some embodiments of the present disclosure;

FIG. 26 is a schematic diagram illustrating a structure including a plurality of piezoelectric beams according to some embodiments of the present disclosure;

FIG. 27A and FIG. 27B are schematic diagrams illustrating deformations of piezoelectric beams with different electrode distributions according to some embodiments of the present disclosure;

FIG. 28 is a schematic diagram illustrating a distribution of electrodes on a piezoelectric beam according to some embodiments of the present disclosure;

FIG. 29A and FIG. 29B are schematic diagrams illustrating simulated deformations of piezoelectric beams with different electrode distributions according to some embodiments of the present disclosure;

FIG. 30 is a schematic diagram illustrating frequency response curves of a speaker corresponding to the two electrode distributions shown in FIG. 29 A and FIG. 29 B;

FIG. 31 is a schematic diagram illustrating frequency response curves of a speaker when a physical parameter γ takes different values according to some embodiments of the present disclosure;

FIG. 32 is a schematic diagram illustrating frequency response curves of a speaker when a physical parameter τ takes different values according to some embodiments of the present disclosure;

FIG. 33 is a schematic diagram illustrating a distribution of electrodes on a piezoelectric beam according to some embodiments of the present disclosure;

FIG. 34 is a schematic diagram illustrating frequency response curves of a speaker when a physical parameter μ takes different values according to some embodiments of the present disclosure;

FIG. 35 is a schematic diagram illustrating frequency response curves of a speaker when a physical parameter x takes different values according to some embodiments of the present disclosure;

FIG. 36 is a schematic diagram illustrating another distribution of electrodes on a piezoelectric beam according to some embodiments of the present disclosure;

FIG. 37 is a schematic diagram illustrating frequency response curves of a speaker when a physical parameter z takes different values according to some embodiments of the present disclosure;

FIG. 38 is a schematic diagram illustrating frequency response curves of a speaker when a physical parameter m takes different values according to some embodiments of the present disclosure;

FIG. 39 is a schematic diagram illustrating frequency response curves of a speaker when a physical parameter γ takes different values according to some embodiments of the present disclosure;

FIG. 40 is a schematic diagram illustrating another distribution of electrodes on a piezoelectric beam according to some embodiments of the present disclosure;

FIG. 41 is a schematic diagram illustrating frequency response curves of a speaker when a physical parameter μ′ takes different values according to some embodiments of the present disclosure;

FIG. 42 is a schematic diagram illustrating frequency response curves of a speaker when a physical parameter γ′ takes different values according to some embodiments of the present disclosure;

FIG. 43 is a schematic diagram illustrating frequency response curves of a speaker corresponding to different electrode shapes according to some embodiments of the present disclosure;

FIG. 44 is a schematic diagram illustrating another distribution of electrodes on a piezoelectric beam according to some embodiments of the present disclosure;

FIG. 45 is a schematic diagram illustrating frequency response curves of a speaker when a physical parameter n takes different values according to some embodiments of the present disclosure;

FIG. 46 is a schematic diagram illustrating another distribution of electrodes on a piezoelectric beam according to some embodiments of the present disclosure;

FIG. 47 is a schematic diagram illustrating frequency response curves of a speaker provided with a double-arc electrode and a full-coverage electrode, respectively, according to some embodiments of the present disclosure;

FIG. 48 is a schematic diagram illustrating a structure of an electrode lead-out manner on a piezoelectric beam according to some embodiments of the present disclosure;

FIG. 49A and FIG. 49B are schematic diagrams illustrating electrodes on a piezoelectric beam according to some embodiments of the present disclosure;

FIG. 50A and FIG. 50B are schematic diagrams illustrating structures of a piezoelectric beam according to some embodiments of the present disclosure;

FIG. 50C is a schematic diagram illustrating a cross-section view of the piezoelectric beam shown in FIG. 50A along section A-A;

FIG. 50D is a schematic diagram illustrating a cross-section view of the piezoelectric beam shown in FIG. 50A along section B-B;

FIG. 51A is a schematic diagram illustrating another structure of a piezoelectric beam according to some embodiments of the present disclosure;

FIG. 51B is a schematic diagram illustrating an enlarged view of region D in FIG. 51A; and

FIG. 51C is a schematic diagram illustrating a cross-section view of the piezoelectric beam shown in FIG. 51A along section A-A.

### DETAILED DESCRIPTION

In order to more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, the operations may be executed in reverse order or simultaneously. Additionally, one or more other operations may be added to these processes, or one or more operations may be removed from these processes.

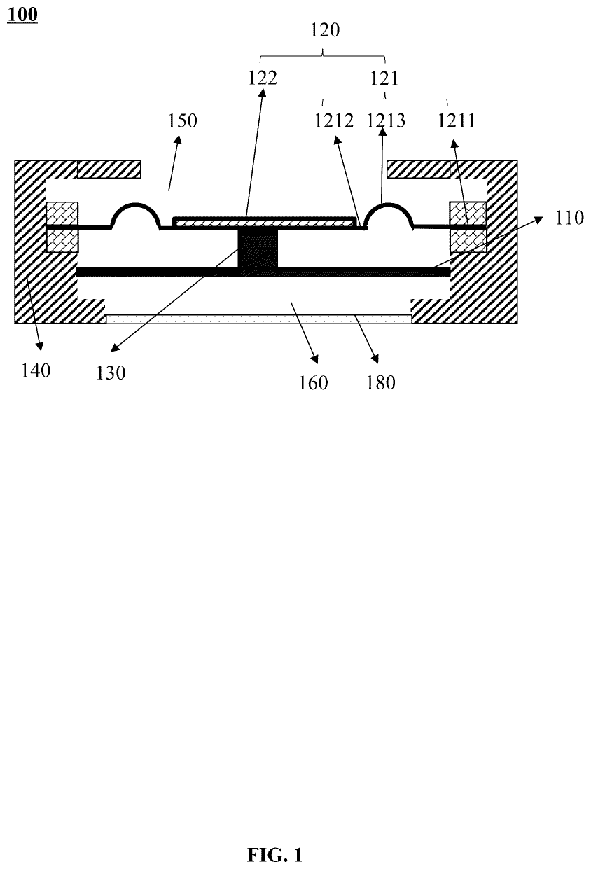

FIG. 1 is a schematic diagram illustrating a structure of an exemplary speaker according to some embodiments of the present disclosure. In some embodiments, as illustrated in FIG. 1, a speaker 100 may include a driving unit 110, a vibrating unit 120, a vibration transmission part 130, and a housing 140.

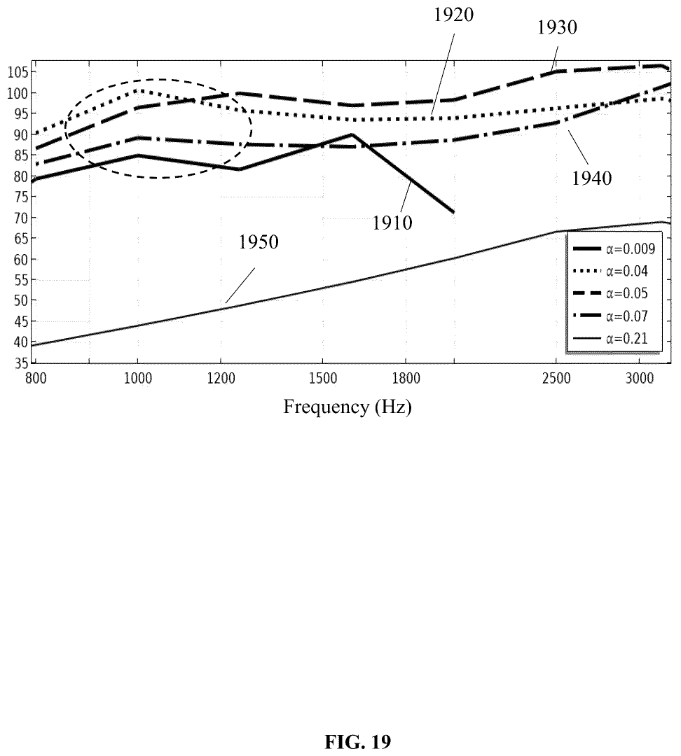

The driving unit 110 is a transducer member of the speaker 100 and may be configured to generate vibrations under the drive of an electrical signal, i.e., the driving unit 110 may provide a driving force for the speaker 100 (e.g., the vibrating unit 120) by converting the electrical signal into a vibration signal. In some embodiments, the driving manners of the driving unit 110 may include different forms such as electromagnetic, electrostatic, piezoelectric, or the like. More descriptions of the driving unit 110 may be found elsewhere in the present disclosure (e.g., FIGS. 19-26 and the related descriptions thereof).

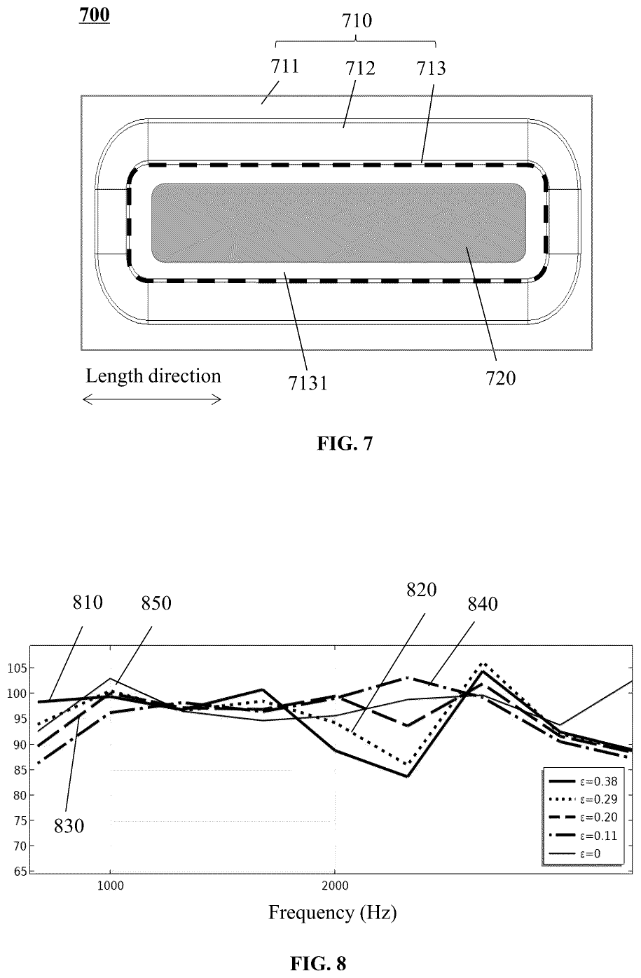

The vibrating unit 120 (or referred to as a diaphragm assembly) may also be referred to as a load portion of the speaker 100, which may be configured to radiate sound pressure outwardly in response to the vibration signal generated by the driving unit 110. In some embodiments, the vibrating unit 120 may include a diaphragm 121 and a central reinforcing part 122. The diaphragm 121 may include a fixing part 1211, a central part 1212, and a corrugation part 1213, wherein the diaphragm 121 may be connected to the housing 140 via the fixing part 1211, and the corrugation part 1213 may be located between the fixing part 1211 and the central part 1212. In some embodiments, the diaphragm 121 may be configured to recess inwardly (e.g., in a direction toward the driving unit 110) or protrude outwardly (e.g., in a direction away from the driving unit 110) relative to the housing 140 via the corrugation part 1213. Merely by way of example, the corrugation part 1213 may be recessed inwardly such that a front cavity 150 does not need to accommodate the corrugation part 1213, which may reduce a thickness of the front cavity 150, and thus reduce a thickness of the speaker. As another example, if the diaphragm 121 is close to the driver unit 110, a depth of the corrugation part 1213 in a vibration direction of the vibrating unit 120 may be limited. In such cases, the corrugation part 1213 may protrude outwardly such that the corrugation part 1213 may have a relatively large depth, thereby enhancing an elasticity coefficient of the diaphragm 121 and ensuring an output effect of the speaker 100. The central reinforcing part 122 may be a reinforcing structure disposed at the central part 1212 for reinforcing vibration of the central part 1212. In some embodiments, the central reinforcing part 122 may be located in a portion or an entire region of the central part 1212. The central reinforcing part 122 may be configured to modulate modes of the diaphragm 121 in different frequency ranges (e.g., higher-order modes at high frequencies). In some embodiments, the driving unit 110 may be connected to the central reinforcing part 122 or may be connected to the central part 1212 to enable mechanical energy transfer from a drive end to a load end. More descriptions of the vibrating unit 120 may be found elsewhere in the present disclosure (e.g., FIGS. 7-14 and the related descriptions thereof).

The vibration transmission part 130 refers to a structure or a component for transmitting vibrations. In some embodiments, the vibration transmission part 130 may include a vibration transmission column 131 and a coupling elastic structure 132. In some embodiments, the vibration transmission part 130 may be connected to the driving unit 110 and the vibrating unit 120 and configured to transmit the vibrations to the vibrating unit 120 to produce sound radiated outward. For example, the coupling elastic structure 132 in the vibration transmission part 130 may be connected to the driving unit 110 and the vibration transmission column 131, respectively, for coupling vibrations generated by the driving unit 110 to the vibration transmission column 131. The vibration transmission column 131 may be connected to the vibrating unit 120 so as to further transmit the vibrations generated by the driving unit 110 to the vibrating unit 120, thereby generating a sound radiated outward. In some embodiments, the coupling elastic structure 132 may facilitate an adjustment of the overall stiffness of the vibration transmission part 130, so that the stiffness of the vibration transmission part is within a preset range. For example, if the vibration transmission part 130 includes only the vibration transmission column 131, the stiffness of the vibration transmission part 130 as a whole may be too large, which is unfavorable to the vibration transmission of the vibration transmission part 130. If the vibration transmission part 130 includes the coupling elastic structure 132, the stiffness of the vibration transmission part 130 may be adjusted by adjusting a count, a structure (e.g., size, etc.), etc., of the coupling elastic structure 132, so as to enhance a vibration transmitting effect of the vibration transmission part 130.

The housing 140 refers to a structure for accommodating other components of the speaker 100. In some embodiments, the housing 140 may be configured to accommodate the driving unit 110, the vibrating unit 120, and the vibration transmission part 130. In some embodiments, the housing 140 may enclose a cavity, the cavity including the front cavity 150 and a back cavity 160. For example, as shown in FIG. 1, the housing 140 may form the front cavity 150 of the speaker 100 with a side of the vibrating unit 120 that is away from the driving unit 110, and form the back cavity 160 of the speaker 100 with a side of the driving unit 110 that is away from the vibrating unit 120. In some embodiments, structures such as a sound hole (not shown in the drawings), a damping mesh 180, or the like, may be provided in the front cavity 150 and the back cavity 160 to form a cavity damping adjustment portion of the speaker 100, so as to adjust the sensitivity of a frequency response curve and a Q-value of the speaker 100, thereby making the frequency response curves of the sound pressure levels (SPLs) of the speaker 100 flatter.

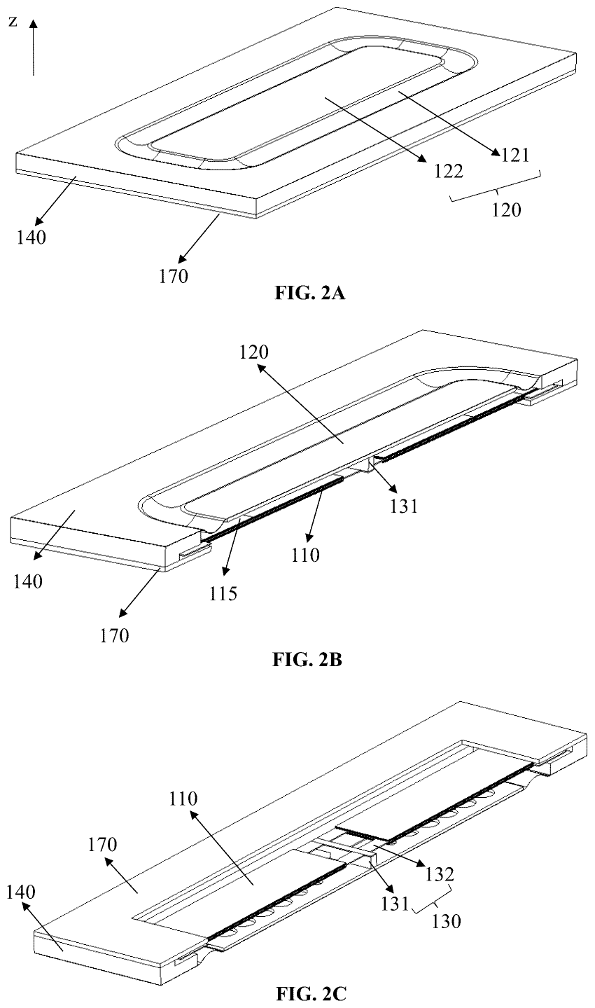

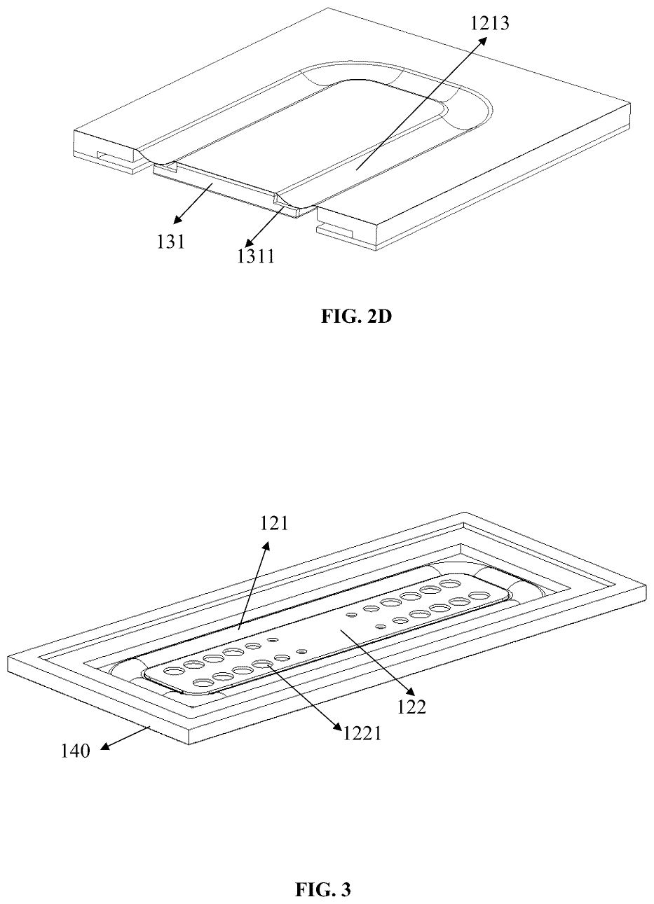

FIG. 2A is a schematic diagram illustrating a structure of an exemplary speaker according to some embodiments of the present disclosure. FIG. 2B is a schematic diagram illustrating an exemplary cross-sectional view of the speaker illustrated in FIG. 2A. FIG. 2C is a schematic diagram illustrating another exemplary cross-sectional view of the speaker illustrated in FIG. 2A. FIG. 2D is a schematic diagram illustrating yet another exemplary cross-sectional view of the speaker illustrated in FIG. 2A.

As shown in FIGS. 2A-2D, an overall structure of the speaker 100 may be rectangular. It should be noted that a shape of the overall structure of the speaker 100 refers to the shape of one surface of the speaker 100 (e.g., the shape of an upper surface of the speaker 100 in a vibration direction of the vibrating unit 120). It should be noted that the structure of the speaker 100 shown in FIG. 2A is only an exemplary illustration, and in some other embodiments, the speaker 100 may have other shapes such as a circle, triangular, quadrilateral, runway shape, and other regular shapes or other irregular shapes.

As shown in FIGS. 2A-2D, the speaker 100 may include a driving unit 110, a vibrating unit 120, a vibration transmission part 130, a housing 140, and a back plate 170. The vibration transmission part 130 includes a vibration transmission column(s) 131 and a coupling elastic structure 132.

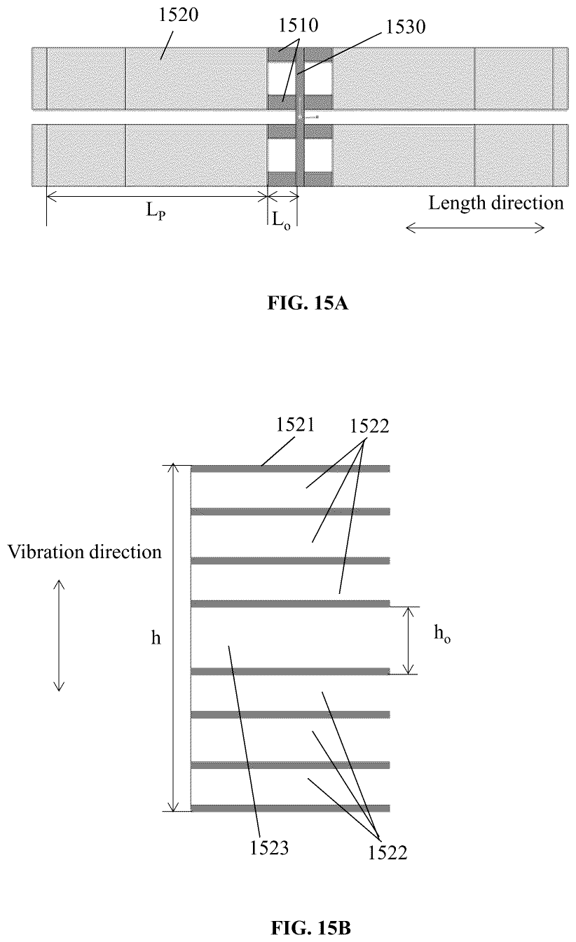

As shown in FIG. 2C, the back plate 170 may be connected to the housing 140 and configured to carry or support the driving unit 110. The coupling elastic structure 132 may be connected to the driving unit 110 and the vibration transmission column 131, respectively, for coupling vibrations generated by the driving unit 110 to the vibration transmission column 131. The vibration transmission column 131 may be connected to the vibrating unit 120 so as to further transmit the vibrations generated by the driving unit 110 to the vibrating unit 120 to produce sound radiated outward. In some embodiments, a material of the coupling elastic structure 132 may include a metallic material, such as stainless steel, an aluminum alloy, a magnesium-lithium alloy, a copper, a brass alloy, or the like. In some embodiments, the material of the coupling elastic structure 132 may include a single-layer semiconductor material, such as Si, SiO₂, SiNx, SiC, or the like. In some embodiments, the material of the coupling elastic structure 132 may include a multilayer semiconductor material, such as Si/SiO₂, SiO₂/Si, Si/SiNx, SiNx/Si, or the like. In some embodiments, the material of the coupling elastic structure 132 may include a monolayer polymer material, such as polyimide (PI), polyethylene terephthalate (PET), polyetherimide (PEI), parylene (poly-p-xylylene), polydimethylsiloxane (PDMS), hydrogel, photoresist, silicone, silicone gel, silicone sealant, flexible printed circuit (FPC), polyether ether ketone (PEEK), or the like. In some embodiments, the material of the coupling elastic structure 132 may include a multilayer composite polymer material or a semiconductor and polymer multilayer composite material. In some embodiments, the material of the coupling elastic structure 132 may include a variety of anisotropic materials such as carbon fiber, Flame Retardant 4 (FR4), or the like. More descriptions of the coupling elastic structure 132 may be found elsewhere in the present disclosure (e.g., FIGS. 15A-18 and the related descriptions thereof).

The vibrating unit 120 (e.g., diaphragm 121) may be connected to the housing 140. The vibration transmission column 131 may connect the driving unit 110 to the vibrating unit 120 (e.g., the central reinforcing part 122). In some embodiments, the vibration transmission column 131 and the coupling elastic structure 132 may act as vibration transmitting structures to transmit vibrations generated by the driving unit 110 to the vibrating unit 120, thereby causing the vibrating unit 120 to generate vibrations along its vibration direction (e.g., the z-direction shown in FIG. 2A). In some embodiments, a cavity 115 may be formed between the vibrating unit 120 and the driving unit 110. When the driving unit 110 generates vibrations, the vibrating unit 120 may be driven to vibrate due to a change in air pressure within the cavity 115 caused by the vibrations of the driving unit 110. In some embodiments, the vibration transmission column 131 may be provided with a relief groove 1311, as shown in FIG. 2D. The relief groove 1311 may be provided at a position on the vibration transmission column 131 facing the corrugation part 1213 of the diaphragm 121 (e.g., in a projection direction along a vibration direction of the diaphragm 121, the relief groove 1311 coincides with at least a portion of the corrugation part 1213). The relief groove 1311 may be configured to prevent the diaphragm 121 from interfering with the vibration transmission column 131 during the vibration of the diaphragm 121, and reduce a volume of the cavity of the speaker 100, thereby reducing a thickness of the speaker 100. In some embodiments, the vibration transmission column 131 may have a relatively great stiffness and a relatively small density to better transmit vibrations.

It should be noted that the back plate 170 may also be part of the housing 140, i.e., the back plate 170 may be integrally molded with the housing 140 for carrying or supporting the driving unit 110.

FIG. 3 is a schematic diagram illustrating a structure of an exemplary diaphragm assembly according to some embodiments of the present disclosure.

As shown in FIG. 3, the central reinforcing part 122 may be located in a central region of the diaphragm 121. In some embodiments, the central reinforcing part 122 may be disposed at the central part 1212 of the diaphragm 121, with the central reinforcing part 122 adhering to a surface of the central part 1212. For example, an area of the central reinforcing part 122 may be equal to an area of the central part 1212, and a projection of the central reinforcing part 122 may coincide with a projection of the central part 1212 in a vibration direction of the vibrating unit 120. As another example, the area of the central reinforcing part 122 may be smaller than the area of the central part 1212, and the central reinforcing part 122 may be symmetrically disposed along a center of the central part 1212 such that vibrations of the diaphragm 121 may be balanced. In some embodiments, a material of the central reinforcing part 122 may include a metallic material. Exemplary metallic materials may include, but are not limited to, stainless steel, aluminum alloys, magnesium-lithium alloys, copper, copper alloys, or the like. In some embodiments, the material of the central reinforcing part 122 may also include a variety of anisotropic materials. Exemplary anisotropic materials may include, but are not limited to, carbon fiber, FR4, plant fiber, or the like. In some embodiments, the material of the central reinforcing part 122 may also include various polymeric materials, such as polyimide (PI), polyethylene terephthalate (PET), polyetherimide (PEI), flexible printed circuit (FPC), polyether ether ketone (PEEK), or the like. In some embodiments, the central reinforcing part 122 may be configured to modulate modes of the diaphragm 121 in different frequency ranges. In some embodiments, by adjusting parameters (e.g., the mass, the area, etc.) of the central reinforcing part 122, a compliance of the diaphragm 121 may be adjusted, thereby adjusting an output of the speaker 100. In some embodiments, a plurality of openings 1221 may be provided on the central reinforcing part 122, and the plurality of openings 1221 may be arranged on a surface of the central reinforcing part 122. In some embodiments, a shape of an opening 1221 may include a regular geometric shape such as a circle, an oval, a triangle, a rectangle, a trapezoid, a pentagon, a hexagon, or the like, and/or an irregular geometric shape. In some embodiments, sizes (the sizes of individual openings 1221) of the plurality of openings 1221 may be the same or different, and distances between any two adjacent openings 1221 of the plurality of openings 1221 may be the same or different. More descriptions of the central reinforcing part 122 may be found elsewhere in the present disclosure (e.g., FIGS. 7-14 and the related descriptions thereof).

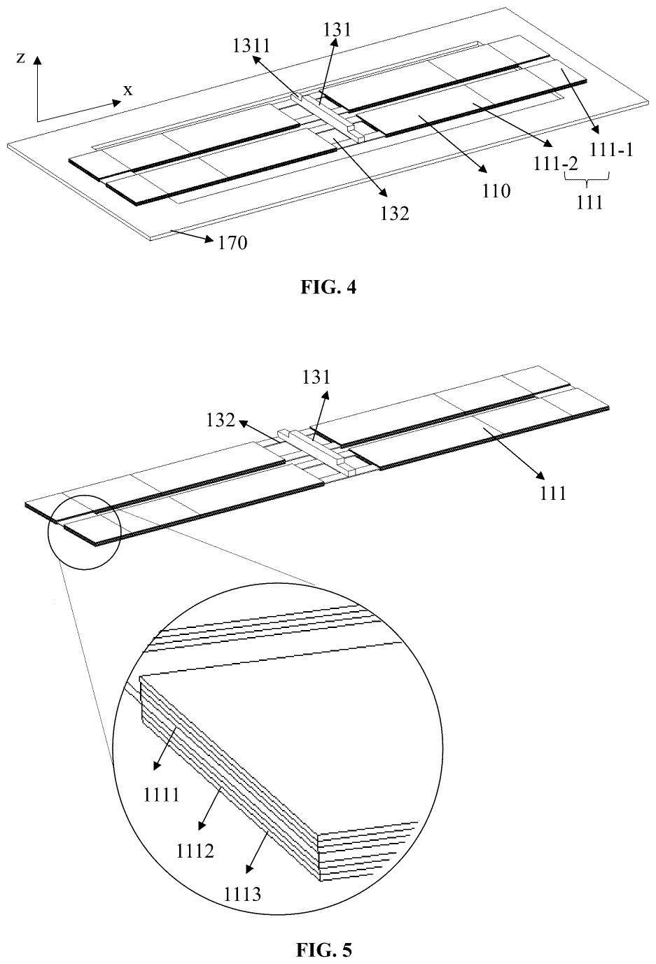

FIG. 4 is a schematic diagram illustrating a structure of an exemplary driving unit according to some embodiments of the present disclosure.

In some embodiments, the driving unit 110 may include one or more piezoelectric beams 111. For example, the driving unit 110 may include two, three, four, or a plurality of piezoelectric beams. The piezoelectric beam 111 may include a piezoelectric layer. The piezoelectric layer may be configured to deform in response to an electrical signal, and the deformation of the piezoelectric layer may drive the piezoelectric beam 111 to generate vibrations. In some embodiments, the vibration direction (e.g., the z-direction shown in FIG. 4) of the piezoelectric beam 111 may be perpendicular to a length direction (e.g., the x-direction shown in FIG. 4) of the piezoelectric beam 111. As shown in FIG. 4, a count of the one or more piezoelectric beams 111 may be four, and an end (or referred to as a fixed end) of each of the four piezoelectric beams 111 is fixed to the back plate 170, and another end (or referred to as a free end) of each of the four piezoelectric beams 111 is connected to the vibration transmission column 131 of the speaker 100 through the coupling elastic structure 132, so that the driving force and displacement generated by the driving unit 110 may be transmitted through the vibration transmission column 131 to the vibrating unit 120 (e.g., the diaphragm 121, the central reinforcing part 122, etc.), thereby radiating of sound pressure outward. In some embodiments, if the driving unit 110 includes a plurality of piezoelectric beams 111, the plurality of piezoelectric beams 111 may be symmetrically distributed in a circumferential direction of the vibration transmission structure. For example, if a count of the plurality of piezoelectric beams 111 is an odd number, the plurality of piezoelectric beams 111 may be distributed in a centrosymmetric manner around the vibration transmission column 131. As another example, if the count of the plurality of piezoelectric beams 111 is an even number, the plurality of piezoelectric beams 111 may be distributed in an axially symmetric manner around the vibration transmission column 131.

In some embodiments, a count of coupling elastic structures 132 corresponding to each of the piezoelectric beams 111 may be one or more. In some embodiments, each piezoelectric beam 111 may correspond to two coupling elastic structures 132. For example, one end of each piezoelectric beam 111 may be connected to two coupling elastic structures 132. When the count of the plurality of piezoelectric beams 111 is four, the count of the coupling elastic structures 132 may be eight.

In some embodiments, referring to FIGS. 1 and 4, the housing 140 may enclose a cavity, a portion of the piezoelectric beam 111 may be fixedly connected to the housing 140 (or the back plate 170) to form a fixed region 111-1, and another portion of the piezoelectric beam 111 may be suspended over the cavity to form a suspended region 111-2. The piezoelectric beam 111 may be connected to the housing 140 (or the back plate 170) via the fixing region 111-1 to enable mounting fixation of the piezoelectric beam 111. The suspended region 111-2 may be deformed under a piezoelectric action to generate vibrations. In some embodiments, in the length direction of the piezoelectric beam 111, one end of the piezoelectric beam 111 that forms the fixed region 111-1 may be referred to as a fixed end, and another end of the piezoelectric beam 111 may be referred to as a free end.

FIG. 5 is a schematic diagram illustrating an enlarged view of a structure of an exemplary piezoelectric beam according to some embodiments of the present disclosure.

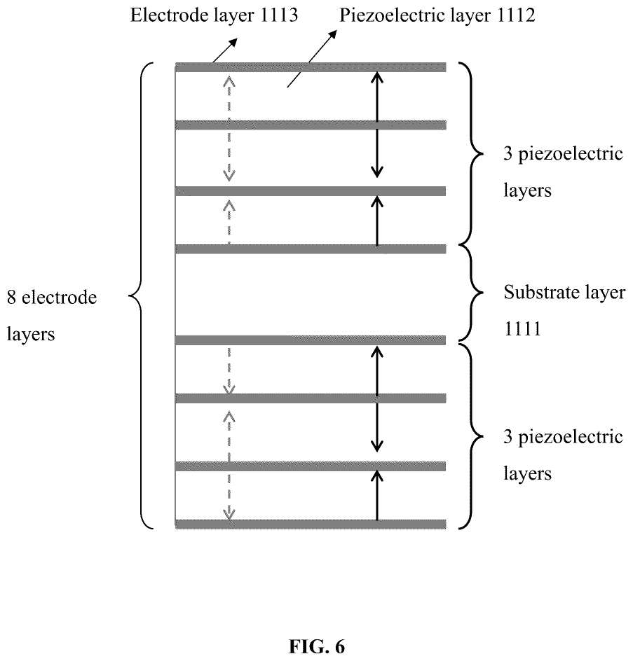

As shown in FIG. 5, the piezoelectric beam 111 may include a substrate layer 1111 and piezoelectric layers 1112 symmetrically disposed on two sides of the substrate layer 1111. An upper surface and a lower surface of each of the piezoelectric layers 1112 are further provided with electrode layers 1113. A count of the piezoelectric layers 1112 disposed on each of the two sides of the substrate layer 1111 may be one or more. For example, the count of the piezoelectric layers 1112 disposed on each of the two sides of the substrate layer 1111 may be two, three, four, five, or more. For example, the count of the piezoelectric layers 1112 may be one, thereby facilitating miniaturization of the structure of the speaker. In some embodiments, the count of the piezoelectric layers 1112 may be more than one, and a plurality of piezoelectric layers 1112 may be simultaneously deformed under the effect of an applied voltage, thereby enhancing an actuation force of the piezoelectric beam 111. For example, FIG. 6 is a schematic diagram illustrating a structure of exemplary piezoelectric layers according to some embodiments of the present disclosure. As shown in FIG. 6, the piezoelectric beam 111 includes one substrate layer 1111, and three piezoelectric layers 1112 may be disposed on each of the two sides of the substrate layer 1111 along a vibration direction of the piezoelectric beam 111, respectively. Each piezoelectric layer 1112 may be provided with an electrode layer 1113 on two sides of the piezoelectric layer 1112, and a count of electrode layers 1113 in the piezoelectric beam 111 may be eight in total. More descriptions of the electrode layer may be found elsewhere in the present disclosure (e.g., FIGS. 27A-51C and the related descriptions thereof).

In some embodiments, to ensure that the piezoelectric beam 111 has a relatively large displacement in its vibration direction, a polarization direction of each piezoelectric layer 1112 and polarity of an applied voltage may be configured such that the piezoelectric layers 1112 on the two sides of the substrate layer 1111 deform in opposite directions. In other words, piezoelectric layers 1112 on one side of the substrate layer 1111 undergo an elongation deformation, and piezoelectric layers 1112 on another side of the substrate layer 1111 undergo a shortening deformation. For example, for the piezoelectric layers 1112 on one side of the substrate layer 1111, a potential of the applied voltage may be opposite to the polarization direction of the piezoelectric layers such that the substrate layer 1111 undergoes the shortening deformation due to an inverse piezoelectric effect. For the piezoelectric layers 1112 on another side of the substrate layer 1111, the potential of the applied voltage may be the same as the polarization direction of the piezoelectric layers such that the the substrate layer 1111 undergoes the elongation deformation due to the inverse piezoelectric effect. The elongation deformation and the shortening deformation work together to cause the piezoelectric beam 111 to bend in a direction of the shortening deformation, causing the piezoelectric beam 111 to have a relatively large displacement and thereby generating vibrations. In some embodiments, the polarization directions of any two adjacent piezoelectric layers 1112 may be opposite, and the voltage applied may cause the potential direction of each piezoelectric layer 1112 on one side of the substrate layer 1111 to be in the same direction as the polarization direction of the piezoelectric layer 1112 on one side of the substrate layer 1111, and the potential direction of each piezoelectric layer 1112 on another side of the substrate layer 1111 to be opposite to the polarization direction of the piezoelectric layer 1112 on another side of the substrate layer 1111. In some embodiments, counts of the piezoelectric layers 1112 on the two sides of the substrate layer 1111 may be the same, in which case a neutral layer of the piezoelectric beam 111 may be located inside the substrate layer 1111. In some embodiments, the counts of piezoelectric layers 1112 on the two sides of the substrate layer 1111 may be different, in which case the neutral layer of the piezoelectric beam 111 may not be located inside the substrate layer 1111, which may obtain a desired neutral layer through asymmetric design of the piezoelectric layers 1112, thereby achieving a desired displacement output effect. In some embodiments, the polarization directions of the piezoelectric layers 1112 on the two sides of the substrate layer 1111 may be the same or opposite. In some embodiments, the polarization directions of the piezoelectric layers 1112 on the two sides of the substrate layer 1111 may be the same when a material of the substrate layer 1111 is a metal material.

In some embodiments, a material of the piezoelectric layers 1112 may include aluminum nitride (AlN), piezoelectric ceramics (PZT), zinc oxide (ZnO), or the like. A material of the electrode layers 1113 disposed on the two sides of the piezoelectric layer 1112 may include Ag, Mo, Cu, Au, Ti/Au, Al, or the like. In some embodiments, a material of the vibration transmission column 131 may be the same as the material of the substrate layer 1111. It should be noted that in some embodiments, the material of the substrate layer 1111 may also be different from the material of the coupling elastic structure 132.

In some embodiments, the speaker 100 described above may be prepared through a process including one or more of the following operations.

In operation 1, a piezoelectric driving layer (e.g., the piezoelectric layer 1112, the electrode layer 1113, etc., described in FIG. 5 or FIG. 6) may be prepared. In some embodiments, the piezoelectric driver layer may be prepared according to a first preparation process. For example, a monolithic ceramic sheet may be formed by sintering a block, then the electrode layer may be printed, and a plurality of electrode layers may be bonded to form a piezoelectric ceramic stack structure. The bonding may be performed using an electrode material, for example, the electrode material is silver paste, etc., or the bonding may be performed using a bonding glue, etc. In some embodiments, the piezoelectric driving layer may be prepared according to a second preparation process. For example, electrodes may be printed and cured on a substrate, and then piezoelectric ceramic slurry may be applied. This operation is repeated to form a multilayer co-fired structure (also referred to as a piezoelectric ceramic stack structure).

In operation 2, a piezoelectric beam structure may be prepared. In some embodiments, a substrate structure may be formed by machining, etching, or the like, and then the piezoelectric ceramic stacking structure may be connected (e.g., glued) to a corresponding location on the substrate to obtain the piezoelectric beam structure.

In operation 3, conduction electrodes may be prepared. In some embodiments, electrodes on which the same voltage needs to be applied may be electrically connected via silver paste electrodes.

In operation 4, the piezoelectric beam structure may be assembled with a back plate. In some embodiments, each of the piezoelectric beam and the back plate (e.g., the back plate 170 described in FIGS. 2A-2C) may be provided with a corresponding electrode structure, and an electrical and mechanical connection between the piezoelectric beam and the back plate may be realized via the corresponding electrode structures. In some embodiments, the piezoelectric beam may be connected to the back plate using glue, or the piezoelectric beam may be connected to the back plate using glue and the electrode structure.

In operation 5, the piezoelectric beam structure may be assembled with a vibration transmission structure. In some embodiments, the piezoelectric beam structure may be connected to the vibration transmission structure (e.g., the coupling elastic structure 132 and the vibration transmission column 131) using glue.

In operation 6, a housing and a central reinforcing part may be prepared. In some embodiments, the housing (e.g., the housing 140) and the central reinforcing part (e.g., the central reinforcing part 122) may be prepared using a metallic material or a non-metallic material. In some embodiments, the housing may be formed by machining, etching, or the like.

In operation 7, a vibrating unit (or referred to as a diaphragm assembly) may be prepared. In some embodiments, the housing and the central reinforcing part may be positioned respectively using a mold. The housing, the central reinforcing part, and a diaphragm (e.g., the diaphragm 121) may be formed into an assembly via hot pressing or injection molding. The diaphragm may be bonded to the housing and the central reinforcing part using glue, achieving connection through intermolecular forces.

In operation 8, a speaker may be assembled. In some embodiments, the driving unit and the vibrating unit may be positioned respectively using a positioning fixture. Glue may be applied to points between the vibration transmission structure and the diaphragm, and points between the housing and the back plate, thereby achieving bonding and assembly of the driving unit and the vibrating unit.

In some embodiments, the speaker 100 may also be prepared using a microelectromechanical systems (MEMS) process, including one or more of the following operations.

In operation 1, a piezoelectric driving layer may be prepared. In some embodiments, a plurality of piezoelectric driving layers may be prepared on a substrate by sputtering, lithography, etching, etc., and an electrical conduction structure corresponding to each layer may be formed.

In operation 2, a piezoelectric beam structure may be prepared. In some embodiments, for structures in which the piezoelectric driving layers are located on one side of the substrate, the substrate may be formed by photolithography, etching, etc., thus forming the piezoelectric beam structure. In some embodiments, the substrate may include a base material, such as a semiconductor material (e.g., silicon, silicon dioxide, silicon nitride, silicon carbide, etc.), and the substrate may be formed by lithographing, etching, etc., the base. In some embodiments, the substrate may include an additive material, such as a semiconductor material (e.g., silicon, silicon dioxide, silicon nitride, silicon carbide, etc.) or a polymer material (e.g., PI, PDMS, etc.), and the substrate may be formed by sputtering, deposition, spin-coating, photolithography, etching, or the like. For structures in which the piezoelectric driving layers are disposed on two sides of the substrate, the substrate may be formed by photolithography and etching, and the two sets of piezoelectric driving layers located on two sides of the substrate respectively can be bonded through bonding processes, thus forming the structures where the piezoelectric driving layers are distributed on the two sides of the substrate.

In operation 3, the piezoelectric beam structure may be assembled with the back plate. In some embodiments, each of the piezoelectric beam and the back plate may be provided with a corresponding electrode structure, and an electrical and mechanical connection between the piezoelectric beam and the back plate may be realized through the corresponding electrode structures. In some embodiments, the piezoelectric beam may be connected to the back plate using glue, or the piezoelectric beam may be connected to the back plate using glue and the electrode structure.

In operation 4, the piezoelectric beam structure may be assembled with a vibration transmission structure. In some embodiments, the piezoelectric beam structure may be connected to the vibration transmission structure (e.g., the coupling elastic structure 132 and the vibration transmission column 131) using glue.

In operation 5, a housing and a central reinforcing part may be prepared. In some embodiments, the housing (e.g., the housing 140) and the central reinforcing part (e.g., the central reinforcing part 122) may be prepared using a metallic material or a non-metallic material. In some embodiments, the housing may be formed by machining, etching, or the like.

In operation 6, a vibrating unit (or referred to as a diaphragm assembly) may be prepared. In some embodiments, the housing and the central reinforcing part may be positioned respectively using a mold. The housing, the central reinforcing part, and a diaphragm (e.g., the diaphragm 121) may be formed into an assembly via hot pressing or injection molding. The diaphragm may be bonded to the housing and the central reinforcing part using glue, achieving connection through intermolecular forces.

In operation 8, a speaker may be assembled. In some embodiments, the driving unit and the vibrating unit may be positioned respectively using a positioning fixture. Glue may be applied to points between the vibration transmission structure and the diaphragm, and points between the housing and the back plate, thereby achieving bonding and assembly of the driving unit and the vibrating unit.

FIG. 7 is a schematic diagram illustrating a structure of an exemplary vibrating unit according to some embodiments of the present disclosure.

As shown in FIG. 7, a vibrating unit 700 (or referred to as a diaphragm assembly) may include a diaphragm 710 and a central reinforcing part 720. In some embodiments, the central reinforcing part 720 may be located in a central region of the diaphragm 710. For example, the central reinforcing part 720 may be adhered to a surface of the central region of the diaphragm 710. In some embodiments, the diaphragm 710 and the central reinforcing part 720 may be connected through bonding (e.g., gluing), welding, riveting, one-piece molding, or the like. In some embodiments, the diaphragm assembly 700 may be connected to other components (e.g., the housing 140 described above) of a speaker via the diaphragm 710 (e.g., a fixing part 711). In some embodiments, the diaphragm 710 and the housing of the speaker may be adhesively connected (e.g., through glue bonding), etc.

In some embodiments, the diaphragm 710 may include a fixing part 711, a corrugation part 712, and a central part 713. The diaphragm 710 may be connected to the housing of the speaker via the fixing part 711, and the corrugation part 712 may be located between the fixing part and the central part. As shown in FIG. 7, the fixing part 711, the corrugation part 712, and the central part 713 may be connected sequentially in order from outside to inside. In some embodiments, the central part 713 may be disposed in the central region of the diaphragm 710, the corrugation part 712 may be disposed around a peripheral side of the central part 713, and an inner peripheral side of the corrugation part 712 may be connected with the peripheral side of the central part 713. The fixing part 711 may be disposed around a peripheral side of the corrugation part 712 and connected around an outer periphery of the corrugation part 712. In some embodiments, a projection of the central part 713 along a vibration direction of the diaphragm 710 may have a regular geometrical shape such as a circle, an ellipse, a rectangle, a triangle, a trapezium, or the like, and/or an irregular geometrical shape. A projection of the corrugation part 712 along the vibration direction of the diaphragm 710 may have an annular shape that corresponds to the projection of the central part 713. For example, the projection of the corrugation part 712 along the vibration direction of the diaphragm 710 may have a regular geometrical annular shape such as a circular annulus, an elliptical annulus, a rectangle, a triangular annulus, a trapezoidal annulus, or the like, and/or an irregular geometrical annular shape. A projection of the fixing part 711 along the vibration direction of the diaphragm 710 may have an annular shape that corresponds to the projection of the corrugation part 712. For example, the projection of the corrugation part 712 along the vibration direction of the diaphragm 710 may have a regular geometrical annular shape such as a circular annulus, an elliptical annulus, a rectangle, a triangular annulus, a trapezoidal annulus, or the like, and/or an irregular geometrical annular shape. In some embodiments, an inner peripheral side and an outer peripheral side of the fixing part 711 may have a same shape, e.g., both being a circle, an ellipse, or the like. In some embodiments, the shapes of the inner peripheral side and the outer peripheral side of the securing portion 711 may be different to facilitate the connection between the diaphragm assembly 700 and the housing of the speaker. For example, the inner peripheral side of the fixing part 711 may have an elliptical shape, and the outer peripheral side may have a rectangular shape, as shown in FIG. 7.

In some embodiments, the fixing part 711 and the central part 713 may have a plate structure or a membrane structure. In some embodiments, the corrugation part 712 may have a bending structure protruding with respect to a plane of the fixing part 711 (or the central part 713) to which the corrugation part 712 is connected. In some embodiments, the corrugation part 712 may have a planar structure, and the planar structure may be located in the same plane as the fixing part 711 (or the central part 713). In some embodiments, during vibration of the diaphragm assembly 700, the diaphragm 710 may deform, and there may be a tendency for the bending structure of the corrugation part 712 to straighten during vibration such that a deformation amount of the corrugation part 712 may be greater than a deformation amount of the fixing part 711 and a deformation amount of the central part 713, thereby increasing a displacement amount of the diaphragm assembly 700 in the vibration direction, and increasing sensitivity of the diaphragm assembly 700. In some embodiments, a cross-sectional shape of the corrugation part 712 in a cross-section parallel to the vibration direction may include, but is not limited to, one or more of a circular arc, an elliptic arc, a folded line, a pointed tooth, or a square tooth.

In some embodiments, a material of the diaphragm 710 may include one or more of an organic polymer material, a gum material, or the like. In some embodiments, the organic polymeric material may include one of Polyimide (PI), Polyethylene Terephthalate (PET), Polyetherimide (PEI), Polyetheretherketone (PEEK), or the like, or any combination thereof. In some embodiments, the material of the diaphragm 710 may include a multilayer composite polymer material. In some embodiments, materials of various components (e.g., the fixing part 711, the corrugation part 712, and the central part 713) of the diaphragm 710 may be the same or different.

In some embodiments, the central reinforcing part 720 may be configured to connect with at least a portion of the central part 713 to enhance the vibration of the diaphragm 710. In some embodiments, the central reinforcing part 720 may be located in the central region of the diaphragm 710. In some embodiments, the central reinforcing part 720 may be located at the central part 713 of the diaphragm 710, with the central reinforcing part 720 adhering to a surface of the central part 713. In some embodiments, a projection of the central reinforcing part 720 along the vibration direction of the vibrating diaphragm 710 may have a regular geometrical shape such as a circle, an ellipse, a rectangle, a triangle, a trapezoid, etc, and/or an irregular geometrical shape. In some embodiments, a material of the central reinforcing part 720 may include a metallic material. Exemplary metallic materials may include, but are not limited to, stainless steel, aluminum alloys, magnesium-lithium alloys, copper, copper alloys, or the like. In some embodiments, the material of the central reinforcing part 720 may include a variety of anisotropic materials. Exemplary anisotropic materials may include, but are not limited to, carbon fiber, Flame Retardant 4 (FR4), or the like. In some embodiments, the material of the central reinforcing part 720 may be the same as the material of the diaphragm 710, and exemplary materials may include any one of polyimide (PI), polyethylene terephthalate (PET), polyetherimide (PEI), polyetheretherketone (PEEK), etc., or a combination thereof. In some embodiments, the central reinforcing part 720 may include a foamed composite material or structure. Merely by way of example, the central reinforcing part 720 may include a metal film and a foam sheet, wherein the metal film may have two layers and the foam sheet is sandwiched between the two layers of the metal film. In some embodiments, a material of the metal film may include an aluminum alloy, a magnesium-lithium alloy, stainless steel, copper, or the like. In some embodiments, the foam sheet may be a polymer foam sheet. In some embodiments, a thickness of the foamed sheet may be in a range of 0.2 mm-0.3 mm or more. In some embodiments, the foamed composite material or structure may have properties such as low density, high Young's modulus/density ratio, high internal resistance, etc., which may enhance the acoustic performance of the central reinforcing part 720 or the speaker.

In some embodiments, a driving unit (e.g., the driving unit 110 described above) of the speaker may be connected to the diaphragm 710 to transmit vibrations to the diaphragm assembly 700, thereby enabling the transmission of mechanical energy from a driving end of the speaker to a load end of the speaker. In some embodiments, the driving unit of the speaker may also be connected to the central reinforcing part 720 to transmit vibrations to the diaphragm assembly 700.

In some embodiments, the central reinforcing part 720 may be configured to modulate modes of the diaphragm assembly 700 (or the speaker) in different frequency ranges. In some embodiments, the central reinforcing part 720 may be connected to the diaphragm 710, as a part of the diaphragm assembly 700, and the central reinforcing part 720 may affect an output of a vibration system formed by the diaphragm assembly 700. In some embodiments, by adjusting parameters (e.g., the mass, the area, etc.) of the central reinforcing part 720, the compliance of the diaphragm 710 may be adjusted, thereby adjusting the output of the vibration system formed by the diaphragm assembly 700. In some embodiments, the central reinforcing part 720 provides mass to the diaphragm assembly 700 and also provides the diaphragm assembly 700 with a vibration mode in a high frequency (e.g., greater than 4000 Hz) region, which in turn modulates the output of the speaker. In some embodiments, the compliance of the diaphragm 710 may be adjusted by adjusting an area of the central part 713 covered by the central reinforcing part 720. For example, given that other parameters are constant, the larger the area of the central part 713 covered by the central reinforcing part 720 is, the lower the compliance of the diaphragm 710 may be; the smaller the area of the central part 713 covered by the central reinforcing part 720 is, the higher the compliance of the diaphragm 710 may be.

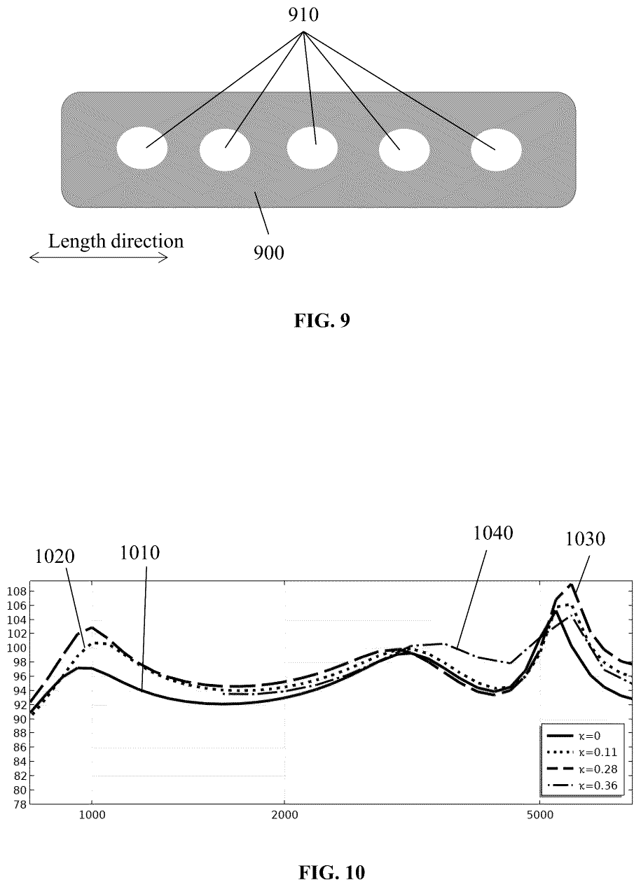

In some embodiments, when the central reinforcing part 720 is provided on a surface of the central part 713, an area of the central reinforcing part 720 may be smaller than an area of the central part 713. For example, the central reinforcing part 720 may cover only the surface of the center region of the central part 713 (e.g., the area of the central reinforcing part 720 is equal to the area of the center region of the central part 713 that is covered by the central reinforcing part 720), and a peripheral portion of the central part 713 is not covered by the central reinforcing part 720. For ease of description, the peripheral portion of the central part 713 that is not covered by the central reinforcing part 720 may be referred to as a suspended region 7131. In other words, the center region of the central part 713 is covered by the central reinforcing part 720, with the area of the central reinforcing part 720 equal to the area of the center region; and the suspended region 7131 is not covered by the central reinforcing part 720. In some embodiments, the central reinforcing part may be provided with one or more openings (e.g., openings 910 as shown in FIG. 9), in which case the area of the suspended region 7131 refers to an area of the central part 713 outside of an outer contour of the central reinforcing part 720. In some embodiments, the area of the suspended region 7131 may affect the compliance of the diaphragm 710, thereby affecting mid-frequency (e.g., 1500 Hz-4000 Hz) modes and low-frequency (e.g., less than 1500 Hz) modes of the diaphragm assembly 700 or the speaker. In some embodiments, if the area of the suspended region 7131 is relatively large, the compliance of the diaphragm 710 may be relatively high, which may cause a first-order resonance frequency of a frequency response curve of the speaker to be shifted forward (i.e., the first-order resonance frequency may be reduced), thereby improving a low-frequency output of the speaker. If the area of the overhang region 7131 is relatively small, the compliance of the diaphragm 710 may be relatively small, which may improve the mid-frequency output of the speaker. It may be understood that if the area of the suspended region 7131 is relatively large and the low-frequency output of the speaker is improved, a high-order mode may be generated in the mid-frequency of the frequency response curve of the speaker and a valley may be formed in the frequency response curve. If the area of the suspended region 7131 is relatively small and the mid-frequency output of the speaker is relatively good, the first-order resonance frequency of the frequency response curve of the speaker may be shifted backward, and the low-frequency output may be reduced. Based on the above description, it may be understood that the compliance of the diaphragm 710 may be adjusted by adjusting a relationship between the area of the suspended region 7131 and the total area of the central part 713, which may adjust the output of the diaphragm assembly 700, thereby ensuring that the low-frequency output and the mid-frequency output of the speaker are within a reasonable range.

It should be noted that the area of each of the components described in the embodiments of the present disclosure refers to an area of a surface of the corresponding component perpendicular to the vibration direction of the diaphragm assembly 700. For example, the total area of the central part 713 refers to an area of a surface of the central part 713 perpendicular to the vibration direction of the diaphragm assembly 700. As another example, the area of the suspended region 7131 refers to an area of a surface of the suspended region 7131 perpendicular to the vibration direction of the diaphragm assembly 700. As still another example, the area of the central reinforcing part 720 refers to an area of a surface of the central reinforcing part 720 perpendicular to the vibration direction of the diaphragm assembly 700. As yet another example, the area of the one or more openings disposed on the central reinforcing part 720 refers to the area(s) of surface(s) of the one or more openings perpendicular to the vibration direction of the diaphragm assembly 700.

FIG. 8 is a schematic diagram illustrating frequency response curves of a speaker with a diaphragm assembly having different area ratios (i.e., different ratios of an area of a suspended region to an area of a central part) according to some embodiments of the present disclosure. For ease of description, the area of the suspended region 7131 of the central part 713 of the diaphragm assembly (e.g., diaphragm assembly 700) is denoted as S₁, the total area of the central part 713 is denoted as Sₘ, and the ratio of S₁ to Sₘ is & (i.e., ε=S₁/Sₘ).

As shown in FIG. 8, the horizontal axis represents frequencies in Hz, and the vertical axis represents sound pressure levels of sound output by the speaker in dB. Curve 810 represents a frequency response curve of the speaker when ε=0.38; curve 820 represents a frequency response curve of the speaker when ¿=0.29; curve 830 represents a frequency response curve of the speaker when ε=0.2; curve 840 represents a frequency response curve of the speaker when ε=0.11; and curve 850 represents a frequency response curve of the speaker when ε=0. According to curve 810, curve 820, curve 830, curve 840, and curve 850, when & is relatively large (e.g., ε=0.38), a low-frequency output of the speaker is relatively high and a mid-frequency output of the speaker has an obvious valley; when & is relatively small (e.g., ε=0), the mid-frequency output of the speaker is relatively high and the low-frequency output is reduced. In some embodiments, to ensure both the low-frequency output and the mid-frequency output of the speaker, a range of E may be 0.01-0.35. In some embodiments, to broaden a mid-and-low frequency output bandwidth and to enhance a mid-and-low frequency output effect of the speaker, the range of ε may be 0.05-0.3. In some embodiments, to reduce a difference between the low-frequency output and the mid-frequency output of the speaker, the range of ε may be 0.1-0.25. In some embodiments, to further minimize the difference between the low-frequency output and the mid-frequency output of the speaker, the range of ε may be 0.15-0.2.

In some embodiments, according to the depictions of FIGS. 7 and 8, the mass of the central reinforcing part may affect the compliance of the diaphragm and thus affect the output of the vibrating unit. Therefore, the mass of the central reinforcing part may be adjusted by adjusting a parameter (e.g., a shape, a size) of the central reinforcing part to adjust the acoustic pressure level of sound output by the speaker. For example, a plurality of openings may be provided on the central reinforcing part to adjust the mass of the central reinforcing part, thereby adjusting the sound pressure level of the sound output by the speaker. As another example, the mass of the central reinforcing part may be adjusted by configuring a count of the plurality of openings, equivalent sizes (or referred to as sizes) of the plurality of openings, an arrangement manner of the plurality of openings, or the like, thereby adjusting the frequency response curve of the speaker.

FIG. 9 is a schematic diagram illustrating an exemplary structure of a central reinforcing part according to some embodiments of the present disclosure.

As shown in FIG. 9, a central reinforcing part 900 may be provided with a plurality of openings 910, and the plurality of openings 910 may be arranged on a surface of the central reinforcing part 900. A count of the plurality of openings 910 may be more than one, such as three, four, five, etc. In some embodiments, shapes of the plurality of openings 910 may include regular geometric shapes such as circles, ovals, triangles, rectangles, trapezoids, pentagons, hexagons, or the like, and/or irregular geometric shapes. As shown in FIG. 9, sizes of the plurality of openings 910 (the sizes of the individual openings 910) may be the same, and distances (distances along a length direction of the central reinforcing part 900) between two adjacent openings 910 of the plurality of openings 910 may be the same. In some embodiments, the mass of the central reinforcing part 900 may be adjusted by adjusting the count and the sizes of the plurality of openings 910. For example, when other parameters are constant (e.g., a peripheral dimension of the central reinforcing part 900 and the sizes of the openings 910 are constant), the greater the count of the plurality of openings 910, the smaller the mass of the central reinforcing part 900; and the fewer the count of the plurality of openings 910, the greater the mass of the central reinforcing part 900. As another example, when other parameters are constant (e.g., a peripheral dimension of the central reinforcing part 900 and the count of the plurality of openings 910 are constant), the larger the sizes of the openings 910, the smaller the mass of the central reinforcing part 900; and the smaller the size of the openings 910, the larger the mass of the central reinforcing part 900. In some embodiments, based on the above description, by adjusting the count of the plurality of openings 910 and/or the sizes of individual openings 910, a total size (or a total area) of the plurality of openings 910 may be adjusted, thereby adjusting the mass of the central reinforcing part 900. In such cases, in some embodiments, an area of the central reinforcing part 900 may be adjusted by adjusting a ratio of the total area of the plurality of openings 910 to the area of the central reinforcing part 900, thereby adjusting the output the vibrating unit or the speaker. The area of the central reinforcing part 900 refers to an area of a region enclosed by an outer contour of the central reinforcing part 900. In some embodiments, the larger the ratio of the total area of the plurality of openings 910 to the area of the central reinforcing part 900 is, the better the output of the speaker at low-and-midfrequency may be, but at the same time, the output effect of the speaker at high frequencies may be reduced. Therefore, the ratio of the total area of the plurality of openings 910 to the area of the central reinforcing part 900 may be within a suitable range (e.g., 0.01-0.35) to ensure that the output of the speaker has a good output performance in all frequency ranges.

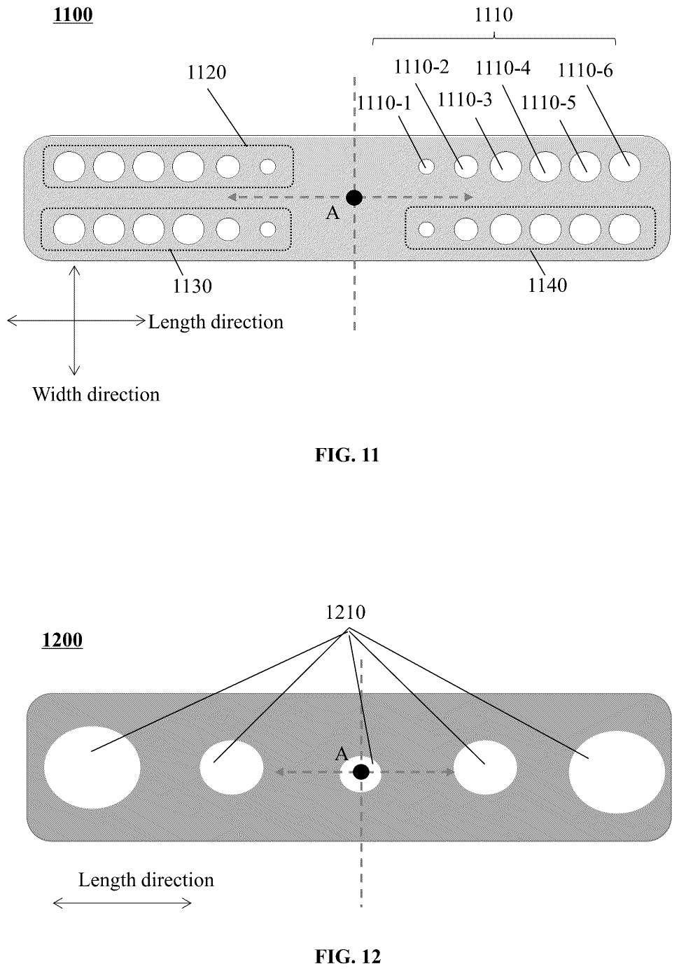

It should be noted that in some embodiments, the plurality of openings 910 may have different sizes. For example, the sizes of the plurality of openings 910 gradually increase or decrease. In some embodiments, the distances between two adjacent openings 910 of the plurality of openings 910 may be different. For example, the distances between two adjacent openings 910 of the plurality of openings 910 may gradually increase or decrease. More descriptions of the sizes of the plurality of openings 910 and the arrangement thereof may be found in FIGS. 11-14 and the related descriptions thereof. The count, sizes, and arrangement manner of the openings 910 may be configured according to actual needs (e.g., according to the mass of the central reinforcing part 900), and the embodiments of the present disclosure are not specifically limited thereto.

FIG. 10 is a schematic diagram illustrating frequency response curves of a speaker with a central reinforcing part having different area ratios (i.e., different ratios of a total area of a plurality of openings to an area of the central reinforcing part) according to some embodiments of the present disclosure. For ease of description, the area of the central reinforcing part (e.g., the central reinforcing part 900 in FIG. 9) is denoted as S_{q}, the total area of the plurality of openings 910 is denoted as Sₖ, and the ratio of Sₖ to S_{q} is κ (i.e., κ=Sₖ/S_{q}).

As shown in FIG. 10, the horizontal axis represents frequencies in Hz, and the vertical axis represents sound pressure levels of sound output by the speaker in dB. Curve 1010 represents a frequency response curve of the speaker when κ=0; curve 1020 represents a frequency response curve of the speaker when κ=0.11; curve 1030 represents a frequency response curve of the speaker when κ=0.28; and curve 1040 represents a frequency response curve of the speaker when κ=0.36. According to curve 1010, curve 1020, curve 1030, and curve 1040, the output of the speaker provided with the plurality of openings 910 is improved in all frequency ranges compared to the speaker without openings (i.e., κ=0). In addition, as the value of κ increases, the output of the speaker is significantly improved at low-and-mid frequencies (e.g., less than 5000 Hz) and reduced at high frequencies (e.g., greater than 5000 Hz). Therefore, in some embodiments, to enhance the output of the speaker in various frequency ranges, the value of κ may be in a range of 0.01-0.35. In some embodiments, to make the output of the speaker in the mid-to-high frequencies relatively flat, the value of κ may be in a range of 0.05-0.3. In some embodiments, to reduce a difference between an output of the speaker at high frequencies and an output of the speaker at mid-frequencies, the value of κ may be in a range of 0.1-0.25. In some embodiments, to further reduce the difference between the output of the speaker at high frequencies and the output of the speaker at mid frequencies, the value of κ may be in a range of 0.15-0.2.

In some embodiments, the aforementioned central reinforcing part (e.g., the central reinforcing part 720 shown in FIG. 7 and the central reinforcing part 900 shown in FIG. 9) has the same stiffness (or compliance) along the length direction of the central reinforcing part (in which case a plurality of openings having a same size are uniformly distributed across the central reinforcing part). Considering that in a high-frequency range (e.g., frequencies greater than 5000 Hz), the vibration mode of the central reinforcing part of the vibrating unit may affect the output of the speaker, the vibration mode of the central reinforcing part may be adjusted by configuring the structure of the central reinforcing part, thereby adjusting the frequency response of the speaker at high-frequencies. For example, a stiffness of the central reinforcing part along a length direction of the central reinforcing part may be variable (also referred to as the central reinforcing part having a variable stiffness structure) by setting a dimensional relationship and an arrangement relationship between the plurality of openings on the central reinforcing part, such that the frequency response of the speaker at high frequencies may be adjusted. For example, the stiffness of the central reinforcing part may be configured to gradually decrease from a middle (e.g., point A described below) of the central reinforcing part towards two ends of the central reinforcing part along the length direction of the central reinforcing part. As another example, the stiffness of the central reinforcing part may be configured to be variable along the length direction by configuring the structure of the central reinforcing part (e.g., a width or a thickness of the central reinforcing part along the vibration direction of the central reinforcing part), or the like.

FIG. 11 is a schematic diagram illustrating an exemplary structure of a central reinforcing part according to some embodiments of the present disclosure.

As shown in FIG. 11, a central reinforcing part 1100 may include a plurality of openings. The plurality of openings differ in size and/or distance between two adjacent openings, and the plurality of openings are non-uniformly distributed across the central reinforcing part 1100. In some embodiments, the plurality of openings may be distributed in different regions of the central reinforcing part 1100. With the center (e.g., the geometric center) of the central reinforcing part 1100 at point A as the center point, the line segment passing through point A and parallel to the length direction is a first line segment, the line segment passing through point A and parallel to the width direction is a second line segment, and the first line segment and the second line segment divide the central reinforcing part 1100 into four regions, i.e., an upper right region, an upper left region, a lower left region, and a lower right region. In some embodiments, the plurality of openings distributed across the center reinforced portion 1100 may include a first set of openings 1110, a second set of openings 1120, a third set of openings 1130, and a fourth set of openings 1140. The first set of openings 1110 may be distributed in the upper right region of the central reinforcing part 1100, the second set of openings 1120 may be distributed in the upper left region of the central reinforcing part 1100, the third set of openings 1130 may be distributed in the lower left region of the central reinforcing part 1100, and the fourth set of openings 1140 may be distributed in the lower right region of the central reinforcing part 1100. In some embodiments, a set of openings (e.g., the first set of openings 1110, the second set of openings 1120, the third set of openings 1130, and the fourth set of openings 1140) may include a plurality of openings, and the plurality of openings in the set of openings may have different sizes and be non-uniformly distributed in the corresponding region.

Taking the plurality of openings in the first set of openings 1110 as an example, the first set of openings 1110 may include a first sub-opening 1110-1, a second sub-opening 1110-2, a third sub-opening 1110-3, a fourth sub-opening 1110-4, a fifth sub-opening 1110-5, and a sixth sub opening 1110-6. From the first sub-opening 1110-1 to the sixth sub-opening 1110-6, the sizes of the sub-openings gradually increase (or increases to a threshold size where the size is no longer changed). For example, as shown in FIG. 11, a size of the first sub-opening 1110-1 is smaller than a size of the second sub-opening 1110-2, a size of the second sub-opening 1110-2 is smaller than a size of the third sub-opening 1110-3, the third sub-opening 1110-3 has a size that is same as the threshold size, and the fourth sub-opening 1110-4, the fifth sub-opening 1110-5, and the sixth sub-opening 1110-6 have the same size as the size of the third sub-opening 1110-3. From the first sub-opening 1110-1 to the sixth sub-opening 1110-6, the distance between adjacent sub-openings gradually decreases (or decreases to a threshold distance where the distance is no longer changed). For example, a distance between the first sub-opening 1110-1 and the second sub-opening 1110-2 is greater than a distance between the second sub-opening 1110-2 and the third sub-opening 1110-3; a distance between the second sub-opening 1110-2 and the third sub-opening 1110-3 is greater than a distance between the third sub-opening 1110-3 and the fourth sub-opening 1110-4. Configurations of the sub-openings in the second set of openings 1120, the third set of openings 1130, and the fourth set of openings 1140 are substantially the same as the configuration of the sub-openings in the first set of openings 1110. It should be noted that the distance between two adjacent openings (or sub-openings) described in embodiments of the present disclosure refers to a distance between geometric centers of the two adjacent openings 1310.

In some embodiments of the present disclosure, by setting different sizes of the plurality of openings on the central reinforcing part 1100 and varying the distance between two adjacent openings of the plurality of openings, the stiffness of the central reinforcing part 1100 at different positions may be different (i.e., the central reinforcing part 1100 has a variable stiffness structure), which may adjust the frequency response of the speaker at high frequencies. For example, when the plurality of openings are distributed on the central reinforcing part 1100 in the manner shown in FIG. 11, the stiffness of the central reinforcing part 1100 may gradually decrease from the middle (i.e., the point A) of the central reinforcing part 1100 towards two ends of the central reinforcing part along the length direction of the central reinforcing part.

It should be understood that the manner of adjusting the stiffness of the central reinforcing part 1100 by configuring the sizes of the plurality of openings and/or the distances between two adjacent openings of the plurality of openings, as described herein, is only illustrative. Adjusting the stiffness of the central reinforcing part 1100 by configuring the openings may simplify operations and allow for adjustment of the sizes of the plurality of openings and/or the distances between two adjacent openings according to different application scenarios, thereby offering broader adaptability. In some embodiments, the variable stiffness structure of the central reinforcing part 1100 may be achieved by other means. For example, the stiffness of the central reinforcing part along the length direction may be varied by configuring the structure of the central reinforcing part (e.g., a width or a thickness of the central reinforcing part along the vibration direction of the central reinforcing part), or the like. Merely by way of example, the thickness of the central reinforcing part may be configured to gradually decrease from the middle of the central reinforcing part 1100 towards two ends of the central reinforcing part along the length direction of the central reinforcing part 1100 such that the stiffness may gradually decrease.

In some embodiments, the central reinforcing part may be configured as a variable stiffness structure by configuring the distance between two adjacent openings of the plurality of openings to be constant and the sizes of the plurality of openings to gradually change along the length direction of the central reinforcing part. FIG. 12 is a schematic diagram illustrating an exemplary structure of a central reinforcing part according to some embodiments of the present disclosure. As shown in FIG. 12, a central reinforcing part 1200 may include a plurality of openings 1210, wherein distances between two adjacent openings 1210 of the plurality of openings 1210 are equal, and along a length direction of the central reinforcing part 1200, sizes of the plurality of openings 1210 are different. For example, from a middle (i.e., point A) of the central reinforcing part 1200 towards two ends of the central reinforcing part 1200 along the length direction of the central reinforcing part 1200, the size of the openings 1210 gradually increases. In such cases, the stiffness of the central reinforcing part 1200 may gradually decrease from the middle (i.e., point A) towards the two ends along the length direction of the central reinforcing part 1200.

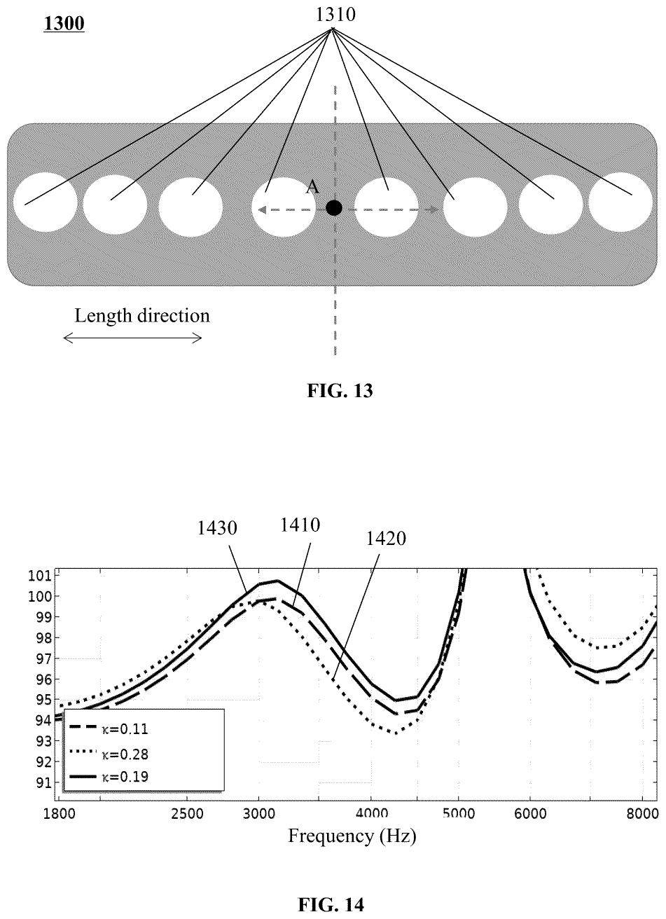

In some embodiments, the central reinforcing part may be configured as a variable stiffness structure by configuring the sizes of the plurality of openings to be equal and the distance between two adjacent openings to gradually change (increase or decrease). FIG. 13 is a schematic diagram illustrating an exemplary structure of a central reinforcing part according to some embodiments of the present disclosure. As shown in FIG. 13, a central reinforcing part 1300 may include a plurality of openings 1310, with each opening 1310 of the plurality of openings 1310 having the same size, and along a length direction of the central reinforcing part 1300, distances between two adjacent openings 1310 are different. For example, the distance between two adjacent openings 1310 may gradually decrease from a middle (i.e., point A) of the central reinforcing part 1300 towards two ends of the central reinforcing part 1300 along the length direction of the central reinforcing part 1300. In such cases, the stiffness of the central reinforcing part 1300 may gradually decrease from the middle (i.e., point A) towards the two ends along the length direction of the central reinforcing part 1300. In some embodiments, the two configurations shown in FIG. 12 and FIG. 13 may be used in combination to adjust the stiffness of the central reinforcing part. In some embodiments, the count of the plurality of openings 1310, for example, the count of the plurality of openings 1310 along a direction of a first line segment and/or a direction of a second line segment, may be changed.

FIG. 14 is a schematic diagram illustrating frequency response curves of a speaker with a central reinforcing part having different structures according to some embodiments of the present disclosure. As shown in FIG. 14, the horizontal axis represents frequencies in Hz, and the vertical axis represents sound pressure levels of a sound output by the speaker in dB. Curve 1410 represents a frequency response curve of the speaker when the central reinforcing part (e.g., the central reinforcing part section 900) has a uniform structure (i.e., sizes of a plurality of openings on the central reinforcing part are the same and distances between two adjacent openings of the plurality of openings are equal), and a ratio κ of a total area of the plurality of openings to an area of the central reinforcing part is κ=0.11. Curve 1420 represents a frequency response curve of the speaker when the central reinforcing part has a uniform structure, and the ratio κ of the total area of the plurality of openings to the area of the central reinforcing part is κ=0.28. Curve 1430 represents a frequency response curve of the speaker when the central reinforcing part (e.g., the central reinforcing part 1100) has a non-uniform structure (i.e., the sizes of the plurality of openings on the central reinforcing part are different, and/or the distances between two adjacent openings of the plurality of openings are unequal), and the ratio κ of the total area of the plurality of openings to the area of the central reinforcing part is κ=0.19. According to curve 1410 and curve 1420, as κ increases, the output of the speaker in a low-frequency range (e.g., frequencies less than 1500 Hz) and a mid-frequency range (e.g., 1500 Hz-3000 Hz) increases significantly, however, the output of the speaker decreases (e.g., forms a valley) in a relatively high-frequency range (i.e., a frequency range (e.g., 3000 Hz-4500 Hz) in which the central reinforcing part provides a vibration mode), and then increases again at a higher frequency range (e.g., greater than 4500 Hz), which makes the frequency response curve of the speaker not flat enough, and the sound output by the speaker have relatively large fluctuations in sound pressure level. Therefore, to improve the valley of the frequency response curve of the speaker in the high-frequency range and make the frequency response curve of the speaker flatter over a wider frequency range, the central reinforcing part may be configured as a variable stiffness structure, with the stiffness of the central reinforcing part gradually decreasing from a middle of the central reinforcing part towards two ends of the central reinforcing part along a length direction central reinforcing part (corresponding to curve 1430). Comparing curve 1430 with curve 1410 and curve 1420, when the area ratio κ of the central reinforcing part with the variable stiffness structure is κ=0.19, the output of the speaker in the relatively high-frequency range (e.g., 3000 Hz-4500 Hz) is higher compared to curve 1410 (κ=0.11). In other words, compared with the situation where the output of the speaker in the high-frequency range decreases as the area ratio κ increases when the central reinforcing part has a uniform structure, the output of the speaker in the high-frequency range increases as the area ratio κ increases when the central reinforcing part has the non-uniform structure. In addition, compared to curve 1420 (κ=0.28), the speaker corresponding to curve 1430 has a lower output at even higher frequencies. Thus, it may be understood that by configuring the central reinforcing part as a variable stiffness structure, the valley of the response curve in a high-frequency range (i.e., the frequency range in which the central reinforcing part provides the vibration mode) may be improved while avoiding a relatively large output at higher frequencies, thereby making the frequency response curve of the speaker flatter over a wider frequency range.

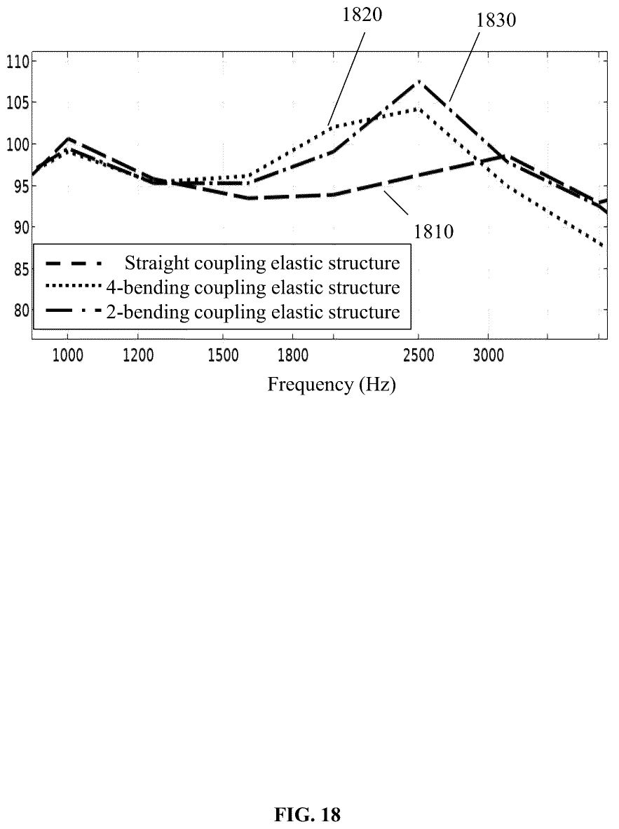

In some embodiments, the vibration transmission part may include a coupling elastic structure and a vibration transmission column (e.g., the vibration transmission column 131 and the coupling elastic structure 132 described above), the driving unit (e.g., a piezoelectric beam) may be connected to one end of the vibration transmission column through the coupling elastic structure, and another end of the vibration transmission column may be connected to the vibrating unit to transmit vibrations, causing the vibrating unit to vibrate, thus causing the speaker to produce sound radiated outward. In some embodiments, when the impedance of the coupling elastic structure is matched with the impedance of the driving unit and the impedance of the vibrating unit, a driving force and a driving displacement of the driving unit may be effectively transferred to the vibrating unit. If the impedance of the coupling elastic structure is too small (e.g., a stiffness of the coupling elastic structure is too small), the driving force and the driving displacement of the driving unit may generate a large displacement inside the coupling elastic structure and dissipate energy through thermal losses, failing to transfer the driving force and the driving displacement to the vibrating unit. If the impedance of the coupling elastic structure is too large (e.g., the stiffness of the coupling elastic structure is too large), the driving force and the driving displacement of the driving unit may be limited inside the coupling elastic structure, resulting in reduced driving force and driving displacement transmitted to the vibrating unit. Therefore, the configuration of the coupling elastic structure is crucial in transmitting the driving force and the driving displacement of the driving unit to the vibrating unit. In some embodiments, the stiffness of the coupling elastic structure may be configured such that the impedance of the coupling elastic structure matches the impedance of the driving unit and the impedance of the vibrating unit, thereby ensuring that the driving force and the driving displacement of the driving unit may be effectively transmitted to the vibrating unit. In some embodiments, the stiffness of the coupling elastic structure may be adjusted by adjusting a size and a structure of the coupling elastic structure, as described in FIG. 15 A-FIG. 18. In some embodiments, the coupling elastic structure may be configured to facilitate an adjustment of a stiffness of the vibration transmission part as a whole, so that the stiffness of the vibration transmission part may be within a preset range. For example, when the vibration transmission part only includes a vibration transmission column, the stiffness of the vibration transmission part as a whole may be too large, which is unfavorable for the vibration transmission part to transmit vibrations. When the vibration transmission part includes a coupling elastic structure, the stiffness of the vibration transmission part may be adjusted by adjusting a count and a structure (e.g., size, etc.) of the coupling elastic structure, etc., so as to enhance a vibration transmitting effect of the vibration transmission part.

FIG. 15A is a schematic diagram illustrating an exemplary structure of a coupling elastic structure according to some embodiments of the present disclosure. FIG. 15A shows coupling elastic structures 1510, piezoelectric beams 1520, and a vibration transmission column 1530 connected to the coupling elastic structures 1510. A count of the piezoelectric beams 1520 may be four and a count of the coupling elastic structures 1510 may be eight. Each piezoelectric beam 1520 is connected to two coupling elastic structures 1510. In some embodiments, one end (also referred to as a fixed end) of the piezoelectric beam 1520 may be connected to a housing (e.g., the back plate 170 described in FIGS. 2A-2C) of a speaker, and another end (also referred to as a free end) of the piezoelectric beam 1520 may be connected to one end of the coupling elastic structure 1510, and another end of the coupling elastic structure 1510 may be connected to a vibrating unit through the transmission column 1530. A vibration force and a vibration displacement of the piezoelectric beams 1520 may be transmitted to the vibrating unit through the coupling elastic structures 1510 and the vibration transmission column 1530. In some embodiments, a region where the piezoelectric beam 1520 is connected to the back plate may be referred to as a fixed region, and a region on the piezoelectric beam 1520 other than the fixed region may be referred to as a suspended region. In some embodiments, the free end of each piezoelectric beam 1520 may be connected to a vibration transmission column 1530 via two coupling elastic structures 1510, as shown in FIG. 15A. In some embodiments, each piezoelectric beam 1520 may be connected to the vibration transmission column 1530 via more than two coupling elastic structures 1510. For example, the count of coupling elastic structures 1510 connected to each piezoelectric beam 1520 may be one, three, four, five, etc. In some embodiments, a material of the coupling elastic structures 1510 may be the same as a material of a substrate. In some embodiments, the material of the coupling elastic structures 1510 may be different from the material of the substrate.

In some embodiments, the coupling elastic structure 1510 may have a straight strip shape (also referred to as a straight-connected coupling elastic structure). For example, the coupling elastic structure 1510 may have a straight strip plate shape. Two ends of the straight strip plate-shaped coupling elastic structure along a length direction of the coupling elastic structure may be connected to the free end of the piezoelectric beam 1520 and the vibration transmission column 1530, respectively, to transmit a driving force and a driving displacement of the piezoelectric beam 1520 to the vibrating unit. In some embodiments, a size (e.g., a length, a thickness) of the coupling elastic structure 1510 may affect a stiffness of the coupling elastic structure 1510, and the stiffness of the coupling elastic structure 1510 may be adjusted by adjusting the size of the coupling elastic structure 1510, such that an impedance of the coupling elastic structure 1510 may match with an impedance of the piezoelectric beam 1520, and the impedance of the coupling elastic structure 1510 may match with an impedance of the vibrating unit.

FIG. 15B is a schematic diagram illustrating a distribution of layers of a piezoelectric beam along a vibration direction according to some embodiments of the present disclosure.

In some embodiments, a vibration direction of the piezoelectric beam 1520 may be the same as a thickness direction of the piezoelectric beam 1520 (and a thickness direction of the coupling elastic structure 1510). To facilitate subsequent understanding of the size (e.g., thickness) of the piezoelectric beam 1520 and the size (e.g., thickness) of the coupling elastic structure 1510, a thickness h of the piezoelectric beam 1520 and a thickness hₒ of the coupling elastic structure 1510 are illustrated in FIG. 15B. As shown in FIG. 15B, the piezoelectric beam 1520 may include eight electrode layers 1521 and six piezoelectric layers 1522 (e.g., lead zirconate titanate piezoelectric ceramics (PZT)). An upper portion and a lower portion of the piezoelectric beam 1520 may include four electrode layers 1521 and three piezoelectric layers 1522, respectively, and the four electrode layers 1521 and the three piezoelectric layers 1522 are distributed alternately. A substrate layer 1523 may be located between the two adjacent electrode layers 1521 at a boundary between the upper portion and the lower portion of the piezoelectric beam 1520. FIG. 15 B is intended to illustrate the thickness h of the piezoelectric beam 1520 and the thickness hₒ of the coupling elastic structure 1510. More descriptions of the piezoelectric beam 1520 and the layers thereof may be found in the related descriptions above.

In some embodiments, referring to FIGS. 15A and 15B, the size of the coupling elastic structure 1510 (e.g., a length Lₒ of the coupling elastic structure 1510 and the thickness hₒ of the coupling elastic structure 1510) may affect a stiffness of the coupling elastic structure 1510. For example, the greater the length Lₒ of the coupling elastic structure 1510, the smaller the stiffness of the coupling elastic structure 1510; the greater the thickness hₒ of the coupling elastic structure 1510, the larger the stiffness of the coupling elastic structure 1510. If the stiffness of the coupling elastic structure 1510 is too large or too small, the impedance of the coupling elastic structure 1510 may not match the impedance of the piezoelectric beam 1520 and/or the impedance of the vibrating unit. In addition, a size of the piezoelectric beam 1520 (e.g., a length Lₚ of the suspended region of the piezoelectric beam 1520 and the thickness h of the piezoelectric beam 1520) may also affect the impedance matching between the coupling elastic structure 1510 and the piezoelectric beam 1520 (and the vibrating unit). Therefore, by reasonably configuring a relationship between the length Lₒ of the coupling elastic structure 1510, the thickness hₒ of the coupling elastic structure, the length Lₚ of the suspended region of the piezoelectric beam 1520, and the thickness h of the piezoelectric beam 1520, the stiffness of the coupling elastic structure 1510 may be adjusted, such that the impedance of the coupling elastic structure 1510 may match with the impedance of the piezoelectric beam 1520, and the impedance of the coupling elastic structure 1510 may match with the impedance of the vibrating unit. In some embodiments, ζ=V (hₒ/Lₒ²)/(h/Lₚ²) may be defined, and a magnitude of ζ may determine whether the impedance of the coupling elastic structure 1510 may match with the impedance of the piezoelectric beam 1520 and the impedance of the vibrating unit. For example, if ζ is too small, it may indicate that the impedance of the coupling elastic structure 1510 is too small, and the impedance of the coupling elastic structure may not match the impedance of the piezoelectric beam and the impedance of the vibrating unit.

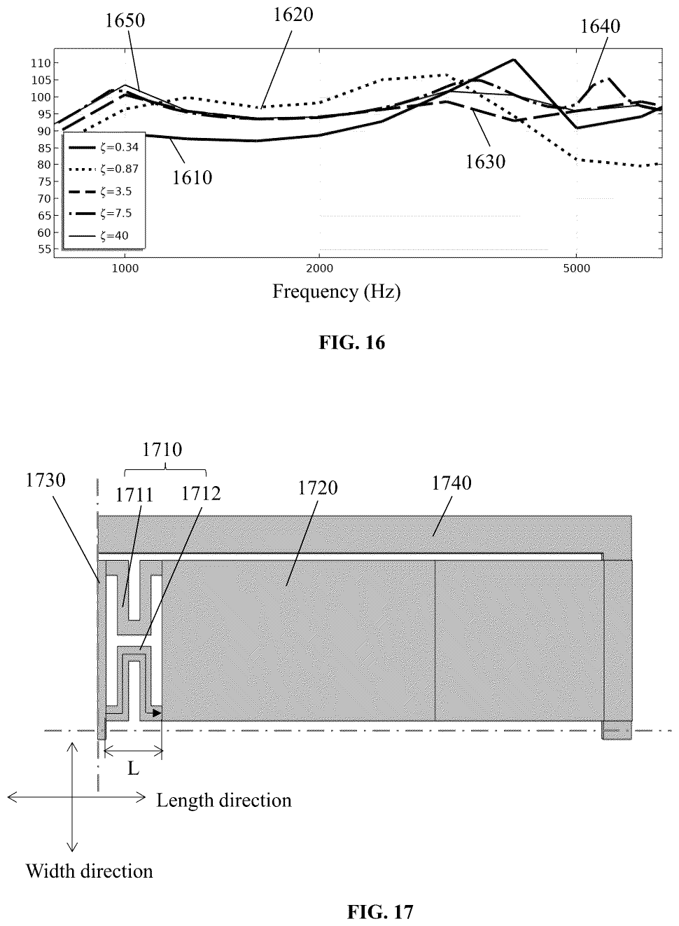

FIG. 16 is a schematic diagram illustrating frequency response curves of a speaker when a parameter of a coupling elastic structure varies according to some embodiments of the present disclosure. As shown in FIG. 16, the horizontal axis represents frequencies in Hz, and the vertical axis represents sound pressure levels of sound output by the speaker in dB. Curve 1610 represents a frequency response curve of the speaker when ζ=0.34; curve 1620 represents a frequency response curve of the speaker when ζ=0.87; curve 1630 represents a frequency response curve of the speaker when ζ=3.5; curve 1640 represents a frequency response curve of the speaker when ζ=7.5; and curve 1650 represents a frequency response curve of the speaker when ζ=40. Referring to FIGS. 15A-16, if ζ is too small (e.g., ζ=0.34), the impedance of the coupling elastic structure is too small compared to the impedance of the piezoelectric beam and the impedance of the vibrating unit, and the impedance of the coupling elastic structure may not match with the impedance of the piezoelectric beam and the impedance of the vibrating unit. In this case, the driving force and the driving displacement generated by the piezoelectric beam may not be effectively transmitted to the vibrating unit, and the sound pressure level of the sound output by the speaker is relatively low. Therefore, a value of ζ may not be less than 0.35. If the value of ζ is in a suitable range (e.g., ζ=0.87), the impedance of the coupling elastic structure 1510 may match with the impedance of the piezoelectric beam and the impedance of the vibrating unit, so that the driving force and the driving displacement generated by the piezoelectric beam may be effectively transmitted to the vibrating unit, and the sound pressure level of the sound output by the speaker may be relatively high. If ζ is too large (e.g., ζ=40), the impedance of the coupling elastic structure may be too large compared to the impedance of the piezoelectric beam and the impedance of the vibrating unit, so that the impedance of the coupling elastic structure may not match with the impedance of the piezoelectric beam and the impedance of the vibrating unit. In this case, the coupling elastic structure may limit the generation of the driving force and the driving displacement, and may lead to a relatively low sound pressure level of the sound output by the speaker (e.g., relative to the sound pressure level when ζ=0.87), but the sound pressure level is still higher than the sound pressure level when ζ=0.34, and the frequency response curve of the speaker (i.e., curve 1650) is relatively flat. Based on the above description, in some embodiments, to increase the sound pressure level of the sound output by the speaker and to enhance the flatness of the frequency response curve, the value of ζ may be in a range of not less than 0.35. In some embodiments, to further increase the sound pressure level of the sound output by the speaker, the value of ζ may be in a range of 0.5-40. In some embodiments, to further increase the sound pressure level of the sound output by the speaker, the value of ζ may be in a range of 0.87-38. In some embodiments, when ζ=0.87, the sound pressure level in the mid-and-high frequency (e.g., greater than 2500 Hz) range may be reduced and the frequency response curve may not be flat enough, thus, the value of ζ may be greater than 0.87. To increase the overall sound pressure level of the sound output by the speaker and to enhance the flatness of the frequency response curve, the value of ζ may be in a range of 3-36. In some embodiments, the value of ζ may be in a range of 5-34. In some embodiments, to increase the magnitude of the sound pressure level of the sound output by the speaker and to further enhance the flatness of the frequency response curve, the value of ζ may be in a range of 7-32. In some embodiments, the value of ζ may be in a range of 10-30. In some embodiments, the value of ζ may be in a range of 12-28. In some embodiments, the value of ζ may be in a range of 15-25.

Referring to the descriptions of FIG. 2C, in some embodiments, a material of the coupling elastic structure 132 may include various anisotropic materials such as metal, a single-layer semiconductor material, a multi-layer semiconductor material, a single-layer polymer material, a multi-layer composite polymer material, a semiconductor and polymer multi-layer composite material, carbon fiber, FR4, or the like.

In some embodiments, a material of the coupling elastic structure 132 may be the same as a material of vibration transmission column 131. By configuring the material of the coupling elastic structure 132 to be the same as the material of the vibration transmission column 131, the impedance of the coupling elastic structure 132 may match the impedance of the vibration transmission column 131, so that vibrations may be effectively transmitted. For example, the material of the coupling elastic structure 132 and the material of the vibration transmission column 131 may be the same as a material of a substrate layer (e.g., the substrate layer 1111) of the piezoelectric beam. By configuring the material of the coupling elastic structure 132 and the material of the vibration transmission column 131 to be the same as the material of the substrate layer of the piezoelectric beam, the impedance of the coupling elastic structure 132 may match the impedance of the vibration transmission column 131 and the impedance of the driving unit 110, thereby further facilitating the transmission of the vibrations. In some embodiments, the coupling elastic structure 132 may be made of the same material as the vibration transmission column 131 to further simplify processing. In some embodiments, the coupling elastic structure 132 and the vibration transmission column 131 may be made by a one-piece molding process.

In some embodiments, the material of the coupling elastic structure 132 and the material of the vibration transmission column 131 may be different. For example, the material of the coupling elastic structure 132 and/or the material of the vibration transmission column 131 may be different from the material of the substrate layer of the piezoelectric beam. The use of different materials for the coupling elastic structure 132 and/or the vibration transmission column 131 from the substrate layer of the piezoelectric beam facilitates customization and refinement of parameters of the speaker or performance. It should be noted that the materials used for the coupling elastic structure 132 and the vibration transmission column 131 may be determined based on actual needs and adapted to different application scenarios.

In some embodiments, due to certain constraints (e.g., a volume of the speaker, an area of the piezoelectric beam, etc.), the size of the coupling elastic structure may be limited, such that the size of the coupling elastic structure may be adjusted only within a permissible area or a limited space to adjust the stiffness of the coupling elastic structure. In a limited space, if the coupling elastic structure has a straight strip shape, a range for adjusting the length of the coupling elastic structure is limited, which in turn limits a range for adjusting the stiffness of the coupling elastic structure. In some embodiments, by configuring the shape of the coupling elastic structure, the stiffness of the coupling elastic structure may be further adjusted within the limited space, thereby achieving better impedance matching between the coupling elastic structure, the piezoelectric beam, and the vibration unit.

FIG. 17 is a schematic diagram illustrating another exemplary structure of a coupling elastic structure according to some embodiments of the present disclosure. It may be understood that, compared to FIG. 15A, FIG. 17 only shows a piezoelectric beam 1720, two coupling elastic structures 1710 connected to the piezoelectric beam 1720, and a portion of a vibration transmission column 1730. In addition, a back plate 1740 is shown in FIG. 17, and a fixed end of the piezoelectric beam 1720 is connected to the back plate 1740.

In some embodiments, a projection of the coupling elastic structure 1710 along a vibration direction of the piezoelectric beam 1720 may have at least one bending structure (also referred to as a bending coupling elastic structure). As shown in FIG. 17, two ends of each of the at least one bending structure (two bending structures in FIG. 17) along a length direction of the coupling elastic structure are connected to a free end of the piezoelectric beam 1720 and the vibration transmission column 1730, respectively, and each of the two bending structures bents along a width direction toward the other bending structure connected to the piezoelectric beam 1720. For example, the two coupling elastic structures 1710 connected to the same piezoelectric beam 1720 may be denoted as a first coupling elastic structure 1711 and a second coupling elastic structure 1712, respectively. Two ends of each of the first coupling elastic structure 1711 and the second coupling elastic structure 1712 along the length direction are connected to the free end of the piezoelectric beam 1720 and the vibration transmission column 1730, respectively. At the same length position, the first coupling elastic structure 1711 and the second coupling elastic structure 1712 bent in opposite directions. As shown in FIG. 17, a structure formed by the two coupling elastic structures 1710 connected to the same piezoelectric beam 1720 bending once (i.e., each of the first coupling elastic structure 1711 and the second coupling elastic structure 1712 bending once) may be referred to as a double-bending coupling elastic structure (or a 2-bending coupling elastic structure).

In some embodiments, the coupling elastic structure 1710 may also be configured as a multi-bending coupling elastic structure, for example, a 4-bending coupling elastic structure, a 6-bending coupling elastic structure, an 8-bending coupling elastic structure, or the like. Taking the 4-bending coupling elastic structure as an example, a structure formed by the two coupling elastic structures 1710 connected to the same piezoelectric beam 1720 bending twice (i.e., each of the first coupling elastic structure 1711 and the second coupling elastic structure 1712 bending twice) may be referred to as the 4-bend coupling elastic structure. By configuring the bending coupling elastic structure, the stiffness of the coupling elastic structure may be adjusted in a limited space, and a better impedance matching between the coupling elastic structure, the piezoelectric beam, and the vibrating unit may be achieved, which is also conducive to the miniaturization of the speaker.

It should be noted that a count of bendings of the bending coupling elastic structure may be reasonably set according to actual needs (e.g., stiffness requirements), and the present disclosure does not specifically limit this aspect.

In some embodiments of the present disclosure, by configuring the shape of the coupling elastic structure 1710 as the bending coupling elastic structure, a length L of a region in which the coupling elastic structure 1710 is located may be reduced while ensuring that the impedance of the coupling elastic structure 1710 remains constant, thereby providing more space for the piezoelectric beam structure 1720, increasing the driving force generated by the piezoelectric beam structure 1720, and enhancing the sound pressure level of the sound output by the speaker. It may also be understood that a length Lₒ of the bending coupling elastic structure 1710 may be set larger in the finite region with the length L, thereby increasing the value of ζ, and thus increasing the sound pressure level of the sound output by the speaker.

It may be understood that if the shape of the coupling elastic structure 1710 is the bending coupling elastic structure, the length Lₒ of the coupling elastic structure 1710 refers to a length of a path through which the coupling elastic structure 1710 travels (e.g., the path shown by the arrow in FIG. 17).

FIG. 18 is a schematic diagram illustrating frequency response curves of speakers having coupling elastic structures with different structures according to some embodiments of the present disclosure. As shown in FIG. 18, the horizontal axis represents frequencies in Hz, and the vertical axis represents sound pressure levels of sound output by the speaker in dB. Curve 1810 represents a frequency response curve of a speaker having a straight-connected coupling elastic structure (e.g., the coupling elastic structure 1510 shown in FIG. 15A). Curve 1820 represents a frequency response curve of a speaker having a 4-bending coupling elastic structure. Curve 1830 represents a frequency response curve of a speaker having a 2-bending coupling elastic structure. Comparing curve 1810 with curve 1820 and curve 1830, the sound pressure level of the sound output by the speaker with the bending coupling elastic structure is greater (especially in the frequency range of about 1500 Hz-3000 Hz) than the sound pressure level of the sound output by the speaker with the straight-connected coupling elastic structure. Therefore, the bending coupling elastic structure may be configured to reduce the length of the region in which the coupling elastic structure is located while ensuring that the impedance of the coupling elastic structure remains constant, and increase the sound pressure level of the sound output by the speaker.

It should be noted that configuring the bending coupling elastic structure to adjust the stiffness of the coupling elastic structure and thus the impedance thereof is illustrative only. In some embodiments, the stiffness of the coupling elastic structure may be adjusted by combining the straight-connected coupling elastic structure with the bending coupling elastic structure. In some embodiments, the stiffness of the coupling elastic structure may also be adjusted by adjusting a width of the coupling elastic structure (the straight-connected coupling elastic structure and/or the bending coupling elastic structure).

In some embodiments, a structure or a size of the piezoelectric beam may affect its intrinsic frequency. For example, a thickness h of the piezoelectric beam may be positively correlated with a stiffness of the piezoelectric beam, and a length l of the piezoelectric beam may be negatively correlated with the stiffness of the piezoelectric beam, which affects the intrinsic frequency of the piezoelectric beam. The thickness h refers to a thickness of the piezoelectric beam along a vibration direction (e.g., the z-direction as shown in FIG. 4) of the piezoelectric beam, and the length l refers to a length of the piezoelectric beam along a length direction (e.g., the x-direction as shown in FIG. 4) of the piezoelectric beam. In some embodiments, a driving unit (e.g., the piezoelectric beam) of the speaker may be configured so as to enhance the driving capability of the driving unit, and optimize a vibration structure of the speaker, thereby enhancing the sound pressure level of the sound output by the speaker.

In some embodiments, a single piezoelectric beam (e.g., the piezoelectric beam 1520) may be understood as a rectangular cantilever beam structure with a load whose intrinsic frequency is determined according to the following equation:

$${ω}_{n} = {( {β}_{n} l )}^{2} {( \frac{E {h}^{2}}{12 ρ {l}^{4}} )}^{1 / 2} , n = 1 , 2 , … , \qquad ( 1 )$$

where βₙl is a constant term, which may be different constants depending on the value of n. For example, if n=1, β₁l=1.875104; if n=2, β₂l=4.694091; if n=3, β₃l=7.854757; if n=4, β₄l=10.995541; if n=5, β₅l=14.1372. E denotes a material density of the cantilever beam (i.e., the piezoelectric beam), l is the length of the cantilever beam (i.e., the piezoelectric beam), and h denotes the thickness of the cantilever beam (i.e., the piezoelectric beam).

Referring to FIG. 15A and FIG. 15B, in some embodiments, the piezoelectric beam 1520 may include a fixed region and a suspended region. By configuring the piezoelectric beam 1520 (e.g., configuring the shape, size, count, etc., of the piezoelectric beam 1520), vibration modes of the speaker may be adjusted to achieve mode adjustment of the speaker. Referring to Equation (1), the intrinsic frequency of the piezoelectric beam 1520 is related to the material density, the length, and the thickness of the piezoelectric beam 1520. Therefore, the vibrational modes of the piezoelectric beam 1520 may be adjusted by adjusting the length and/or the thickness of the piezoelectric beam 1520. As shown in FIGS. 15A and 15B, a length of the suspended region is Lₚ and a thickness of the piezoelectric beam 1520 is h. A parameter α is defined as a square root of a ratio of the thickness h of the piezoelectric beam 1520 to a square of the length Lₚ² of the suspended region, i.e.,

$$α = {( \frac{h}{{l}^{2}} )}^{1 / 2} . \qquad ( 2 )$$

FIG. 19 is a schematic diagram illustrating frequency response curves of a speaker corresponding to different parameters a according to some embodiments of the present disclosure. As shown in FIG. 19, the horizontal axis represents frequencies in Hz, and the vertical axis represents sound pressure levels of sound output by the speaker in dB. Curve 1910 represents a frequency response curve of the speaker when parameter α=0.009; curve 1920 represents a frequency response curve of the speaker when parameter α=0.04; curve 1930 represents a frequency response curve of the speaker when parameter α=0.05; curve 1940 represents a frequency response curve of the speaker when parameter α=0.07; and curve 1950 represents a frequency response curve of the speaker when parameter α=0.21. In some embodiments, the parameter α may be configured to embody a stiffness of the piezoelectric beam 1520, with a larger a indicating a larger stiffness of the piezoelectric beam 1520. Comparing curves 1910-1950, when α=0.009, the stiffness of the corresponding piezoelectric beam 1520 is relatively small, the frequency of a first resonant peak (shown by the dashed circle in FIG. 19) of the speaker is relatively small, and the sound pressure level of the sound output by the speaker 100 is relatively low. As α increases, the stiffness of the piezoelectric beam 1520 also increases correspondingly. When α=0.04, the stiffness of the piezoelectric beam 1520 increases, the frequency of the first resonant peak of the speaker is relatively small, and the speaker outputs a relatively high sound pressure level at low frequencies (e.g., less than 1500 Hz) but outputs a relatively low sound pressure level at mid-and-high frequencies (e.g., greater than 1500 Hz). When α=0.07, the stiffness of the piezoelectric beam 1520 continues to increase, the frequency of the first resonant peak of the speaker increases, the output sound pressure level of the speaker is relatively high at mid-and-high frequencies but relatively low at low frequencies. When a is too large, for example, when α=0.21, the stiffness of the piezoelectric beam 1520 is too large, which may cause the frequency of the first resonance peak of the speaker to be too large and limits a displacement output of the piezoelectric beam 1520, and reduce the sound pressure level of the speaker. In some embodiments, for specific high-frequency ranges and cases with high load impedance, the physical parameter α of the piezoelectric beam may be relatively large.

In summary, when the value of a is in a range of 0.009-0.21, the speaker has a relatively high output sound pressure level over a relatively large frequency range. In some embodiments, taking into account the output of the speaker in various frequency ranges from low to high frequencies, the value of a may be in a range of 0.01-0.2. In some embodiments, to further improve the output of the speaker in various frequency ranges in the low to high frequencies, the value of a may be in a range of 0.01-0.15. In some embodiments, to increase the output sound pressure level of the speaker at mid-and-high frequencies, the parameter α may take a value towards a lower end in a range of 0.01-0.2. For example, the parameter α may take a value in a range of 0.01-0.1. As another example, to further increase the output sound pressure level of the speaker at mid-and-high frequencies, the parameter α maybe in a range of 0.02-0.07. As yet another example, to increase the output sound pressure level of the speaker at mid-and-high frequencies while ensuring the output sound pressure level of the speaker at low frequencies, the parameter α may be in a range of 0.03-0.06.

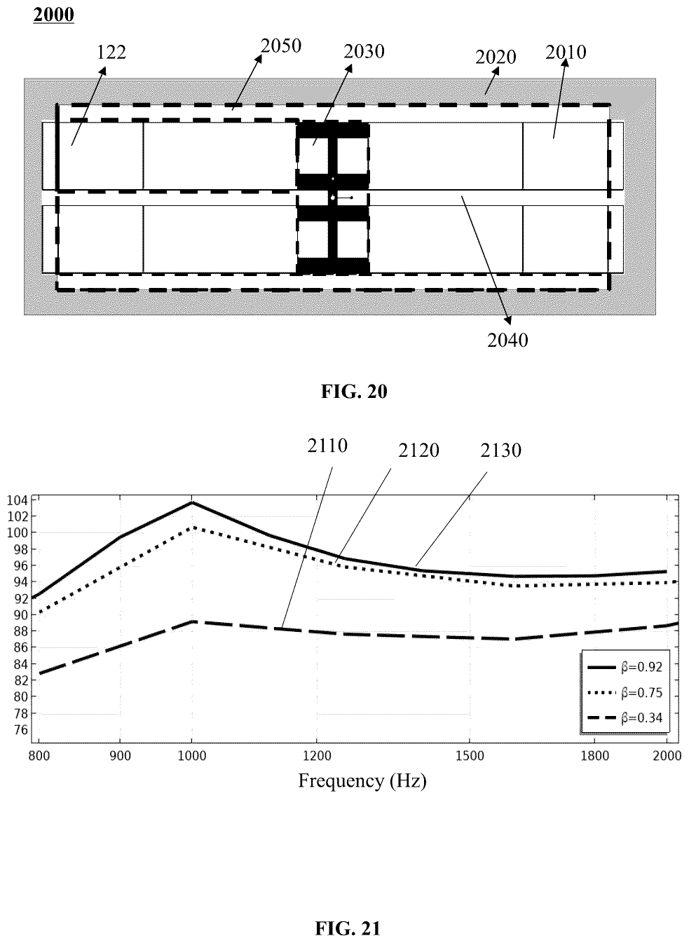

FIG. 20 is a schematic diagram illustrating a structure of a speaker according to some embodiments of the present disclosure.

As shown in FIG. 20, a driving force of a speaker 2000 may be positively correlated with an area of a driving unit of the speaker 2000. The area of the driving unit refers to a total projection area of one or more piezoelectric beams 2010 in a vibration direction of the driving unit. Therefore, the driving force of the speaker 2000 may be enhanced by increasing the area of the driving unit, thereby enhancing an output sound pressure level of the speaker 2000.

In some embodiments, under the condition that a size of a back plate 2020 of the speaker 2000 is limited, maximizing an area ratio of the driving unit may significantly enhance the output sound pressure level of the speaker 2000. In some embodiments, in a vibration direction of the piezoelectric beams 2010, the area of the driving unit is not equivalent to an area of an internal cavity of the back plate 2020 due to a region (region one 2030) occupied by a coupling elastic structure, a region (region two 2040) of a gap between adjacent piezoelectric beams 2010, a region (region three 2050) of a gap between the piezoelectric beams 2010 and the back plate 2020. For region one 2030 occupied by the coupling elastic structure, the area of region one 2030 may affect the stiffness of the coupling elastic structure, thus affecting the impedance of the coupling elastic structure and an impedance matching between a driving end and a load end. For example, if the area of region one 2030 is too large, the stiffness of the coupling elastic structure may be too small compared to a stiffness of the drive end and a stiffness of the load end, so that the driving force and displacement are concentrated in the coupling elastic structure, and vibrations generated by the driving unit may not be effectively transmitted to the vibrating unit. If the area of region one 2030 is too small, the stiffness of the coupling elastic structure may be too large compared to the stiffness of the driving end and the stiffness of the load end, and a mass of the coupling elastic structure may be increased, thereby limiting the driving force and displacement output by the driving unit. For the region, two 2040 corresponding to the gap between the adjacent piezoelectric beams 2010 and region three 2050 corresponding to the gap between the piezoelectric beams 2010 and the back plate 2020, the areas of the two regions may affect processing and manufacturing of the speaker 2000. For example, if the area of region two 2040 and the area of region three 2050 are too small, it may lead to an increase in the difficulty of an etching process or assembly. Therefore, under the condition that the size of the back plate 2020 of the speaker 2000 is constant, when increasing the area of the driving unit, it is necessary to take into account the area of region one 2030, the area of region two 2040, and the area of the region three 2050. In some embodiments, in the vibration direction of the piezoelectric beam 2010, a first projection area of the suspended region of the piezoelectric beam 2010 (i.e., a region outside of region one 2030, region two 2040, and region three 2050) may be defined as Sₚ, and a second projection area of the internal cavity of the back plate 2020 may be defined as S_{c}, a physical parameter β may be defined as a ratio of Sₚ to S_{c}, i.e:

$$β = \frac{{S}_{p}}{{S}_{c}} . \qquad ( 3 )$$

FIG. 21 is a schematic diagram illustrating frequency response curves of a speaker when a physical parameter β takes different values according to some embodiments of the present disclosure. As shown in FIG. 21, the horizontal axis represents frequencies in Hz and the vertical axis represents sound pressure levels of a sound output by the speaker in dB. Curve 2110 represents a frequency response curve of the speaker when parameter β=0.34; curve 2120 represents a frequency response curve of the speaker when parameter β=0.75; and curve 2130 represents a frequency response curve of the speaker when parameter β=0.92. Comparing curves 2110-2130, the sound pressure level of the sound output by the speaker is relatively low when β is 0.34. When β increases from 0.34 to 0.75 and then to 0.92, the sound pressure level of the sound output by the speaker increases significantly. Thus, by increasing the parameter β (i.e., the ratio of Sₚ to S_{c}), the driving force of the driving unit may be effectively increased to enhance the output of the speaker. As the value of β approaches 1, an increase in the output of the speaker decreases as the value of β increases. As the value of β approaches 1, the difficulty of processing the piezoelectric beams 2010 within the internal cavity of the back plate 2020 increases, and the risk of the piezoelectric beams 2010 touching a side wall of the cavity also increases.

In some embodiments, to improve the sound pressure level of the speaker, the value of β may be in a range of 0.35-0.92. In some embodiments, since the speaker requires a certain clearance space for processing and assembling in an actual production process, the value of β may be in a range of 0.4-0.9. In some embodiments, to further improve the sound pressure level of the speaker, and at the same time reduce the difficulty of processing the piezoelectric beams 2010 within the internal cavity of the back plate 2020 and to avoid the risk of the piezoelectric beams 2010 touching the side wall of the cavity, the value of β may be in a range of 0.5-0.8.

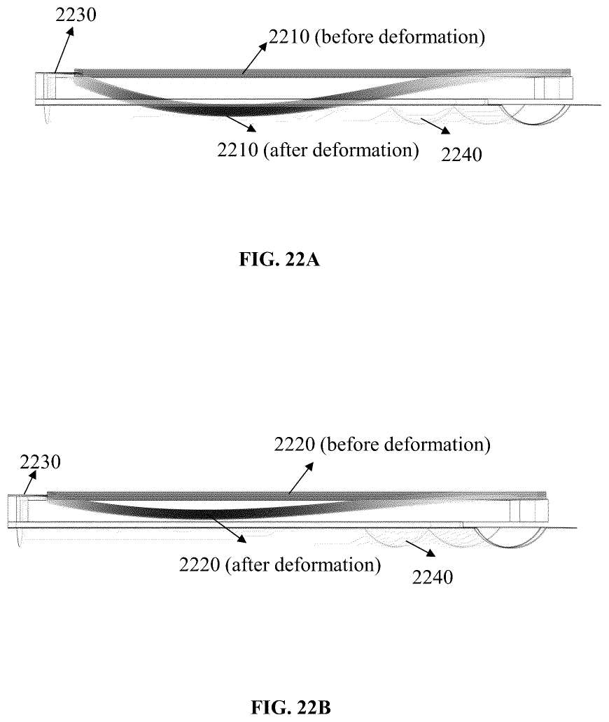

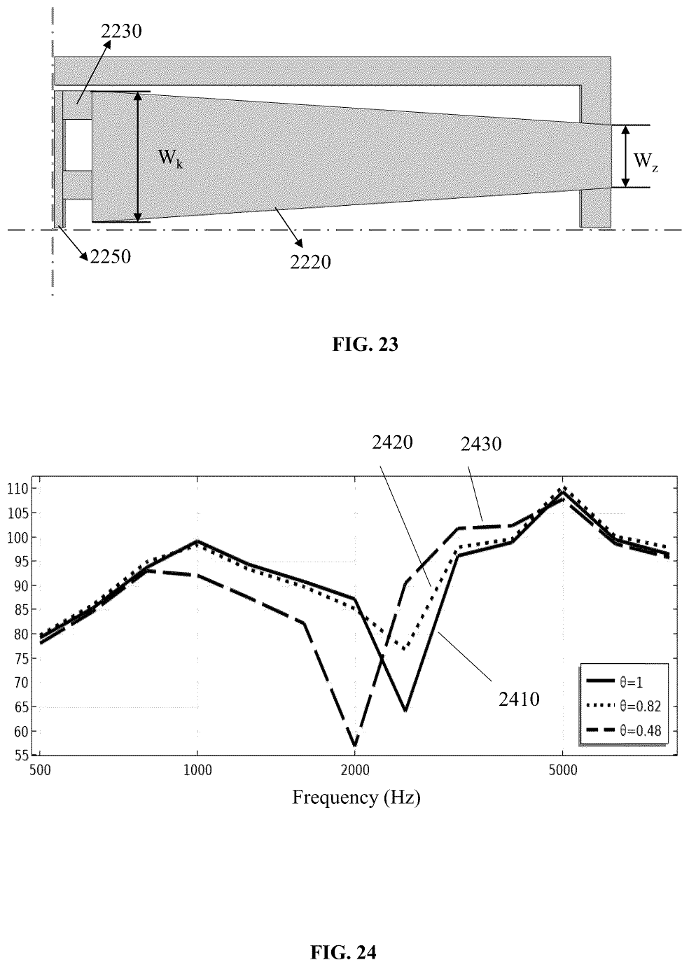

In some embodiments, a shape of the piezoelectric beam of the speaker has a significant role in modulating the vibration mode of the speaker at mid-and-high frequencies. FIG. 22A and FIG. 22B are schematic diagrams illustrating deformations of piezoelectric beams with different shapes according to some embodiments of the present disclosure. FIG. 22A shows a deformation of a rectangular piezoelectric beam 2210, and FIG. 22B shows a deformation of a trapezoidal piezoelectric beam 2220. As shown in FIG. 22A, the rectangular piezoelectric beam 2210 has a second-order vibration mode at middle frequencies, with relatively small displacements at two ends of the rectangular piezoelectric beam 2210 and a relatively large displacement in the middle of the rectangular piezoelectric beam 2210. This uneven distribution of displacement of the piezoelectric beam 2210 may result in the displacement of the piezoelectric beam 2210 not being effectively transmitted to the coupling elastic structure 2230 and a vibration transmission column (e.g., the vibration transmission column 2250 shown in FIG. 23), and subsequently to the vibrating unit 2240, which results in a very low output sound pressure level of the speaker at middle frequencies. Therefore, in some embodiments, the shape of the piezoelectric beam may be configured to modulate the output frequency response of the piezoelectric beam of the speaker at mid-and-high frequencies, thereby enhancing the output sound pressure level of the speaker.

In some embodiments, the piezoelectric beam may have at least two different widths at different locations in an extending direction of the piezoelectric beam. In other words, the piezoelectric beam may have an unequal width in the extending direction. The extending direction of the piezoelectric beam may also be understood as a length direction of the piezoelectric beam. FIG. 23 is a schematic diagram illustrating a structure of a trapezoidal piezoelectric beam according to some embodiments of the present disclosure. As shown in FIG. 23, the piezoelectric beam 2220 has gradually varying widths in the extending direction. By configuring the shape of the piezoelectric beam 2220 to have at least two different widths at different positions, a distribution of mass and a distribution of stiffness of the piezoelectric beam 2220 along the length direction of the piezoelectric beam may be adjusted. As shown in FIG. 22B, the trapezoidal piezoelectric beam 2220 has a relatively small displacement in the middle portion when vibrating at middle frequencies, and the displacement of the piezoelectric beam 2220 may be efficiently transmitted to the coupling elastic structure 2230 and then to the vibrating unit 2240, thereby increasing the vibration of the vibrating unit 2240 and enhancing the output sound pressure level of the speaker.

In some embodiments, a maximum width in different widths (e.g., a width of a wide side of the trapezoidal piezoelectric beam 2220) may be defined as Wₖ, a minimum width in the different widths (e.g., a width of a narrow side of the trapezoidal piezoelectric beam 2220) may be defined as W_{z}, and a physical parameter θ may be defined as a ratio of the minimum width W_{z} to the maximum width Wₖ, i.e.

$$θ = \frac{{W}_{z}}{{W}_{k}} . \qquad ( 4 )$$

By taking different values of θ, the distribution of mass and the distribution of stiffness of the piezoelectric beam 2220 along the length direction may be adjusted to improve the output of the speaker.

FIG. 24 is a schematic diagram illustrating frequency response curves of a speaker when a physical parameter θ takes different values according to some embodiments of the present disclosure. As shown in FIG. 24, the horizontal axis represents frequencies in Hz, and the vertical axis represents sound pressure levels of sound output by the speaker in dB. Curve 2410 represents a frequency response curve of the speaker when parameter θ=1; curve 2420 represents a frequency response curve of the speaker when parameter θ=0.82; and curve 2430 represents a frequency response curve of the speaker when parameter θ=0.48. Comparing curves 2410-2430, the frequency response curve of the aspeaker has a relatively deep valley in a mid-frequency range when θ is too large (e.g., θ=1) or too small (e.g., θ=0.48). However, when θ is moderate (e.g., θ=0.82), the mid-frequency valley is significantly improved. Therefore, in some embodiments, to enhance the output of the speaker in the mid-frequency range, the value of θ may be in a range of 0.5-0.99. In some embodiments, to further enhance the output of the speaker in the mid-frequency range, the value of θ may be in a range of 0.58-0.92. In some embodiments, the value of θ may be in a range of 0.6-0.9.

In some embodiments, the minimum width and the maximum width may be located at two ends of the piezoelectric beam in the extending direction of the piezoelectric beam. As shown in FIG. 23, the piezoelectric beam has a trapezoidal shape, and the minimum width and the maximum width are located at the two ends of the piezoelectric beam in the extension direction of the piezoelectric beam. In some embodiments, the piezoelectric beam may have other shapes, so as to adjust the distribution of mass and the distribution of stiffness of the piezoelectric beam along the length direction thereof, thereby enhancing the output of the speaker. In some embodiments, the shape of the piezoelectric beam may include at least one of a rectangular shape, a trapezoidal shape, a stepped shape, or the like.

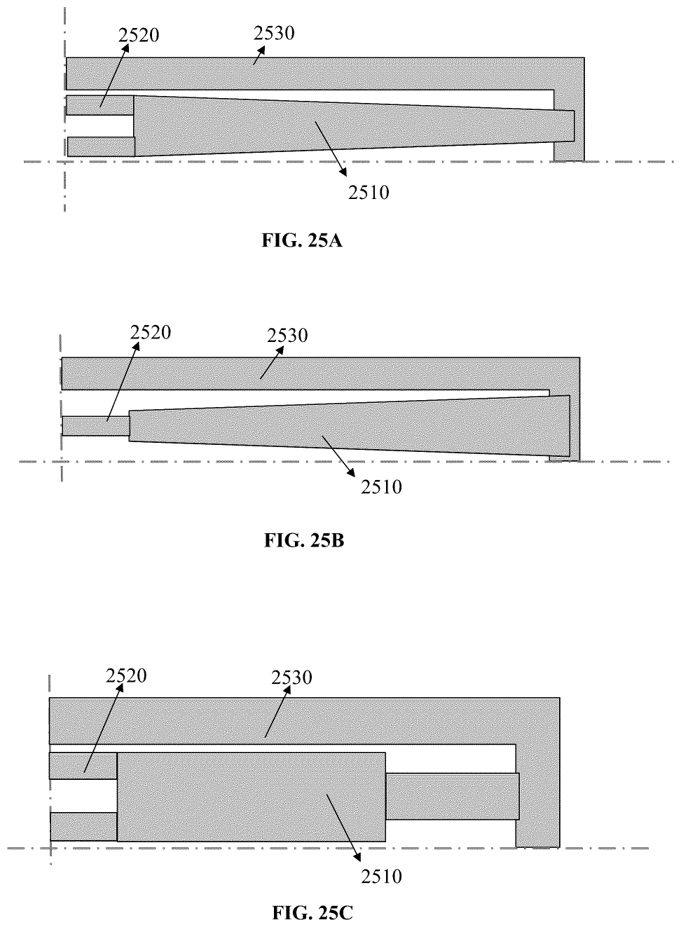

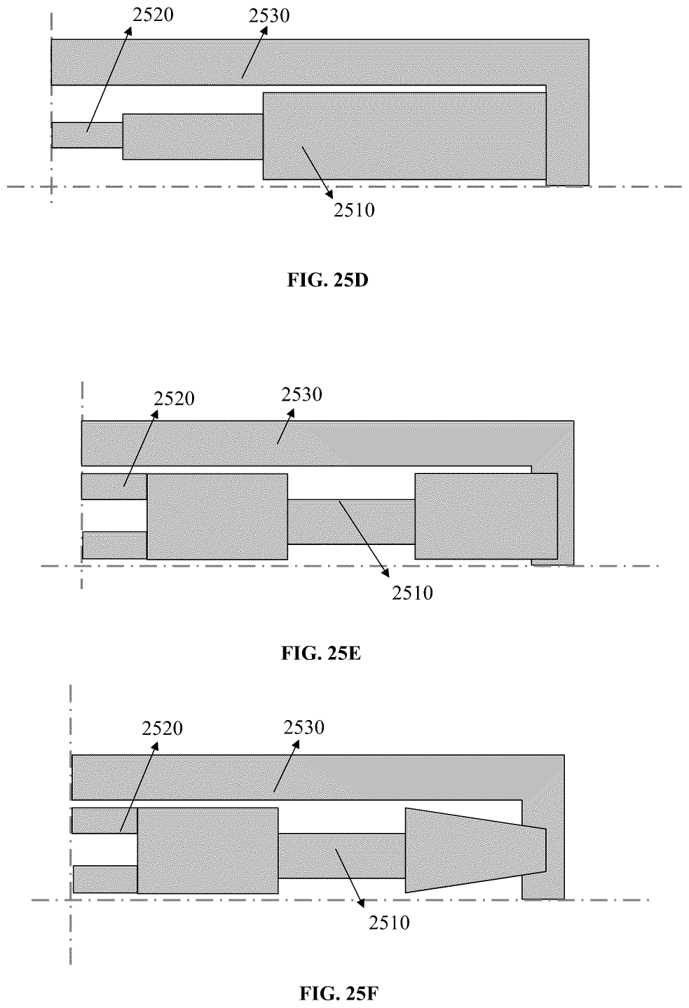

FIG. 25A-FIG. 25F are schematic diagrams illustrating structures of piezoelectric beams with different shapes according to some embodiments of the present disclosure. FIG. 25A shows a piezoelectric beam 2510 having a trapezoidal shape and a wide side of the trapezoidal shape being connected to a coupling elastic structure 2520. FIG. 25B shows a piezoelectric beam 2510 having a trapezoidal shape and a narrow side of the trapezoidal shape being connected to a coupling elastic structure 2520. FIG. 25C shows a piezoelectric beam 2510 having two rectangles in a stepped shape and a wide side of the stepped shape being connected to a coupling elastic structure 2520. FIG. 25 D shows a piezoelectric beam 2510 having two rectangles in a stepped shape and a narrow side of the stepped shape being connected to a coupling elastic structure 2520. FIG. 25 E shows a piezoelectric beam 2510 having three rectangles in a stepped shape. FIG. 25 F shows a piezoelectric beam 2510 having two rectangles and one trapezoid in a step shape.

In some embodiments, the piezoelectric beam 2510 may have a trapezoidal shape, the wide side of the trapezoid may be connected to the coupling elastic structure 2520, and a narrow side of the trapezoid may be connected to a back plate 2530 as shown in FIG. 25A. The value of the parameter θ of the trapezoidal piezoelectric beam 2510 shown in FIG. 25A may differ from the value of the parameter θ of the trapezoidal piezoelectric beam 2220 shown in FIG. 23. In some embodiments, the piezoelectric beam 2510 may have a trapezoidal shape as shown in FIG. 25B, a narrow side of the trapezoidal shape may be connected to the coupling elastic structure 2520, and the wide side of the trapezoid may be connected to the back plate 2530. In some embodiments, as shown in FIG. 25C, the piezoelectric beam 2510 may be a combination of a rectangle and a stepped shape, i.e., the piezoelectric beam 2510 may include two rectangles of different sizes and the two rectangles may be connected to form a stepped structure, with a wide side of the stepped structure (i.e., a relatively large rectangle) connected to the coupling elastic structure 2520 and a narrow side of the stepped structure (i.e., a relatively small rectangle) connected to the back plate 2530. In some embodiments, as shown in FIG. 25D, the piezoelectric beam 2510 may be a combination of a rectangle and a stepped shape, i.e., the piezoelectric beam 2510 may include two rectangles of different sizes and the two rectangles may be connected to form a stepped structure, with a narrow side of the stepped structure (i.e., a relatively small rectangle) connected to the coupling elastic structure 2520 and a wide side of the stepped structure (i.e., a relatively large rectangle) connected to the back plate 2530. As shown in FIGS. 25A-25D, the minimum width and the maximum width are located at the two ends of the piezoelectric beam in the extending direction of the piezoelectric beam, respectively.

In some embodiments, the minimum width may be disposed in a central region of the piezoelectric beam in the extending direction of the piezoelectric beam. FIGS. 25E-25F illustrate embodiments in which the minimum width is located in the central region of the piezoelectric beam in the extending direction thereof. As shown in FIG. 25E, the piezoelectric beam 2510 may include three rectangles, the three rectangles may include two relatively large rectangles and one relatively small rectangle, the three rectangles may be sequentially connected and the relatively small rectangle may be disposed between the two relatively large rectangles to form a stepped structure, with two ends of the stepped structure (i.e., the two relatively large rectangles) being connected to coupling elastic structures 2520 and the back plate 2530, respectively. As shown in FIG. 25F, the piezoelectric beam 2510 may include two rectangles and one trapezoid, the two rectangles may include two rectangles of different sizes, the two rectangles and the one trapezoid may be sequentially connected, and a relatively small rectangle may be disposed between a relatively large rectangle and the trapezoid to form a stepped structure. A wide side of the trapezoid may be connected to the relatively small rectangle, one end of the stepped structure (the relatively large rectangle) may be connected to the coupling elastic structure 2520, and the other end of the stepped structure (a narrow side of the trapezoid) may be connected to the back plate 2530. In some embodiments, regardless of the shape of the piezoelectric beam, to enhance the output effect of the speaker, the value of the parameter θ (the ratio of the minimum width W_{z} to the maximum width Wₖ) of the piezoelectric beam may still be in the range of 0.5-0.99.

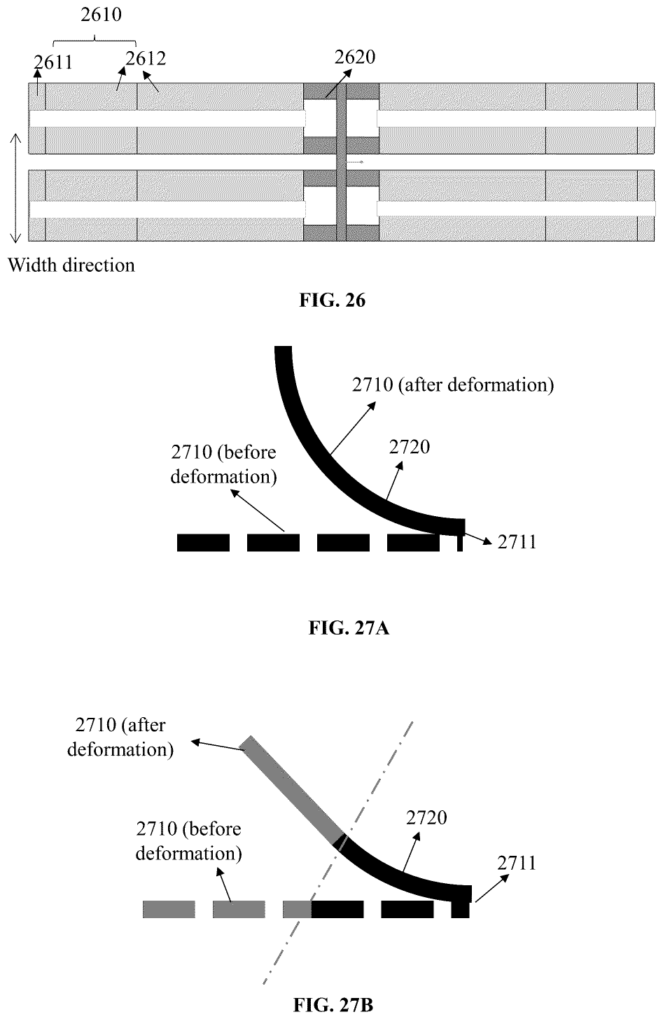

In some embodiments, a count of piezoelectric beams may also be configured to adjust the stiffness of the driving unit, thereby improving the vibration mode of the speaker at middle frequencies and enhancing the output of the speaker. FIG. 26 is a schematic diagram illustrating a structure including a plurality of piezoelectric beams according to some embodiments of the present disclosure. As shown in FIG. 26, in some embodiments, a speaker may include a plurality of piezoelectric beams 2610, and the plurality of piezoelectric beams 2610 may be spaced apart in a width direction. Each of the plurality of piezoelectric beams 2610 may include a fixed region 2611 and a suspended region 2612. A fixed end of each piezoelectric beam 2610 may be connected to a back plate at its fixed region 2611, and a free end of each piezoelectric beam 2610 may be connected to a coupling elastic structure 2620. By configuring the count of piezoelectric beams 2610, the stiffness of the driving unit may be adjusted so as to improve the output of the speaker.

According to some embodiments of the present disclosure, by configuring the shape and structure of the piezoelectric beam, the vibration mode of the speaker at mid-and-high frequencies may be adjusted, and the second-order vibration mode of the piezoelectric beam of the speaker that occurs at middle frequencies may be effectively adjusted, thereby improving the valley of the frequency response of the speaker.

Referring to the descriptions of FIGS. 5-6, FIGS. 15A-15B, etc., the piezoelectric beam may include a piezoelectric layer and an electrode layer, the piezoelectric layer may be configured to deform in response to an electrical signal, and the deformation may drive the piezoelectric beam to generate vibrations.

In some embodiments, the mid-frequency vibration mode of the piezoelectric beam may be modulated by adjusting an electrode distribution (or referred to as the electrode layer) of the piezoelectric beam, which improves the valley of the frequency response of the speaker.

FIG. 27A and FIG. 27B are schematic diagrams illustrating deformations of piezoelectric beams with different electrode distributions according to some embodiments of the present disclosure. In a projection plane along a vibration direction of a piezoelectric beam 2710, a surface of the piezoelectric beam 2710 shown FIG. 27A is fully covered by an electrode 2720, and the piezoelectric beam 2710 shown in FIG. 27B is partially covered by the electrode 2720 at an end of the piezoelectric beam 2710 near a fixed region 2711. As shown in FIG. 27A, when the surface of the piezoelectric beam 2710 is fully covered by the electrode 2720, the piezoelectric beam 2710 is subjected to a bending deformation at all positions of the piezoelectric beam 2710 along a length direction thereof when a voltage is applied to the piezoelectric beam 2710. As in FIG. 27B, in the projection plane along the vibration direction of the piezoelectric beam 2710, when the piezoelectric beam 2710 is partially covered by electrodes at an end (or referred to as a fixed end) near the fixed region 2711 and is not covered by electrodes at a portion away from the fixed region 2711, only a portion of the piezoelectric beam 2710 covered by electrodes undergoes a bending deformation after the piezoelectric beam 2710 is subject to the applied voltage, and the portion of the piezoelectric beam 2710 not covered by electrodes is not deformed. Thus, by designing the electrode distribution on the piezoelectric beam 2710, the vibration mode of the piezoelectric beam 2710 may be effectively regulated in different frequency ranges, thereby improving the output effect of the speaker.

It should understood that the surface of the piezoelectric beam being fully (or partially) covered by electrodes refers to an area of the piezoelectric layer being equal to an area of the substrate layer, with the electrode layer fully (or partially) covering the piezoelectric layer; or refer to the piezoelectric layer and the electrode layer fully (or partially) covering the substrate layer, which is not limited in the present disclosure. For ease of description, the aforementioned situations are referred to as the surface of the piezoelectric beam being fully (or partially) covered by electrodes.

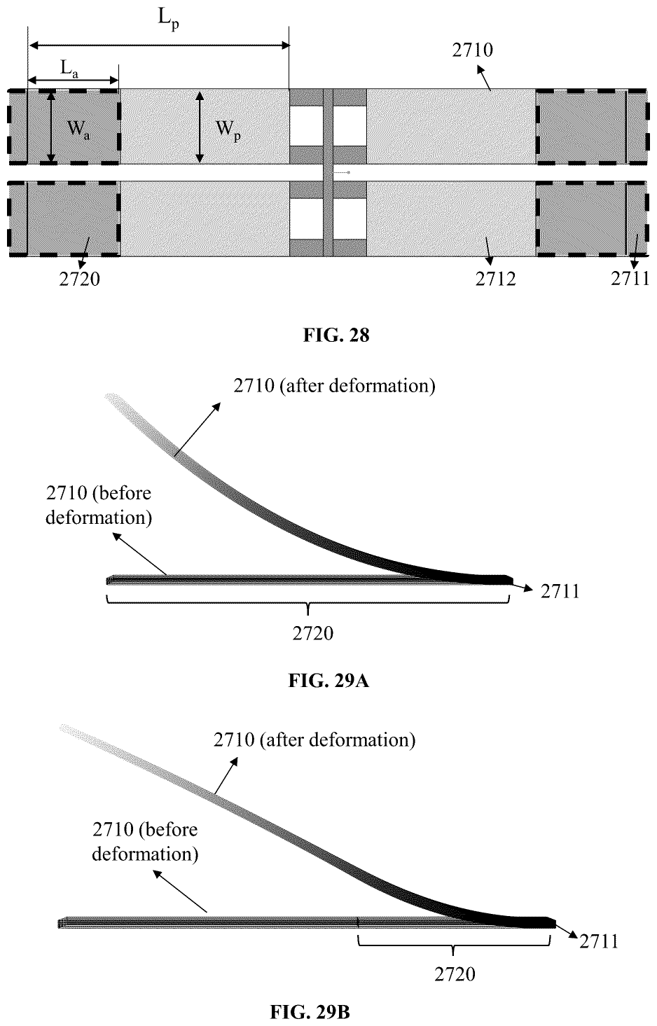

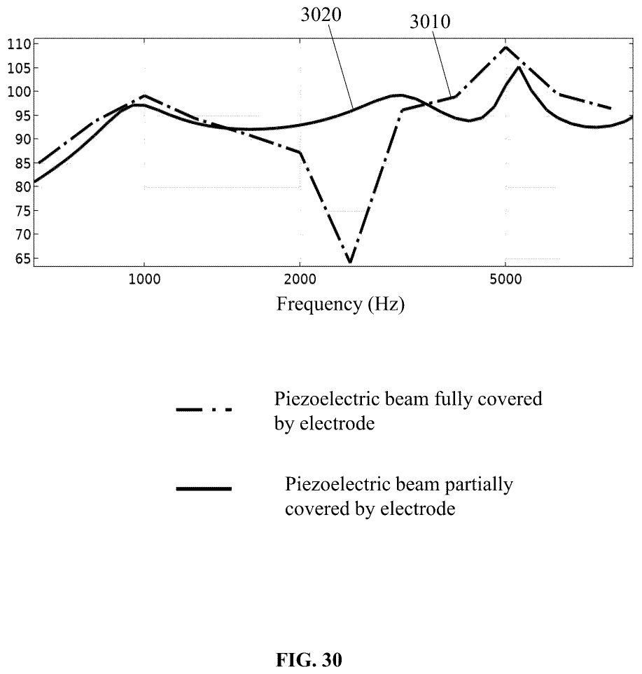

FIG. 28 is a schematic diagram illustrating a distribution of electrodes on a piezoelectric beam according to some embodiments of the present disclosure. FIG. 29A and FIG. 29B are schematic diagrams illustrating simulated deformations of piezoelectric beams with different electrode distributions according to some embodiments of the present disclosure. FIG. 30 is a schematic diagram illustrating frequency response curves of a speaker corresponding to the two electrode distributions shown in FIG. 29 A and FIG. 29 B. FIG. 29A is a schematic diagram illustrating a simulated deformation of a piezoelectric beam 2710 fully covered by electrodes 2720 in a length direction of the piezoelectric beam 2710. FIG. 29 B is a schematic diagram illustrating a simulated deformation of a piezoelectric beam 2710 partially covered by electrodes 2720 near a fixed end of the piezoelectric beam 2710. As shown in FIG. 30, the horizontal axis represents frequencies in Hz, and the vertical axis represents sound pressure levels of sound output by the speaker in dB. Curve 3010 represents a frequency response curve of a speaker when the piezoelectric beam 2710 is fully covered by the electrodes 2720; and curve 3020 represents a frequency response curve of the speaker when the piezoelectric beam 2710 is partially covered by the electrodes 2720. Compared to the piezoelectric beam 2710 that is fully covered by the electrodes 2720, the piezoelectric beam 2710 that is partially covered by the electrodes 2720 near the fixed end better improves the valley in the frequency response curve in a mid-frequency range (e.g., around 2500 Hz), resulting in a flatter frequency response curve and improved speaker output.

Therefore, in the projection plane along the vibration direction of the piezoelectric beam 2710, partial coverage of the piezoelectric layer can flatten the frequency response curve of the speaker, thereby enhancing the output effect of the speaker.

It should be noted that the positions of the electrodes may be determined according to actual situations, and the present disclosure does not impose limitations thereon. In some embodiments, as shown in FIG. 28, an end (i.e., the free end) of the piezoelectric beam 2710 opposite to the fixed region 2711 in the extending direction of the piezoelectric beam 2710 may be connected to the vibration transmission part. A distance between a center of the electrode layer and the fixed region 2711 may be less than a distance from the center of the electrode layer to the end of the piezoelectric beam 2710 connected to the vibration transmission part. In short, the electrode may be provided at a position of the piezoelectric beam 2710 near the fixed end. In some embodiments, the distance between the center of the electrode layer and the fixed region 2711 may be greater than the distance from the center of the electrode layer to the end of the piezoelectric beam 2710 connected to the vibration transmission part. In short, the electrode may be disposed on the piezoelectric beam 2710 away from the fixed end. For example, the electrode may be disposed on a middle section of the piezoelectric beam 2710.

In some embodiments, a size of the electrode distributed on the piezoelectric beam may be configured so that the vibration mode of the piezoelectric beam may be effectively modulated. In some embodiments, a relationship between a length of the electrode distributed on the piezoelectric beam and a length of the piezoelectric beam may have an important effect in modulating the vibration mode of the piezoelectric beam. As shown in FIG. 28, the electrode 2720 may be rectangular, a length of the electrode 2720 covering a suspended region 2712 of the piezoelectric beam 2710 may be defined as Lₐ and a length of the suspended region 2712 may be defined as Lₚ. A physical parameter γ may be defined as a ratio of the length Lₐ of the electrode covering the suspended region 2712 to the length Lₚ of the suspended region 2712, i.e.

$$γ = \frac{{L}_{a}}{{L}_{p}} . \qquad ( 5 )$$

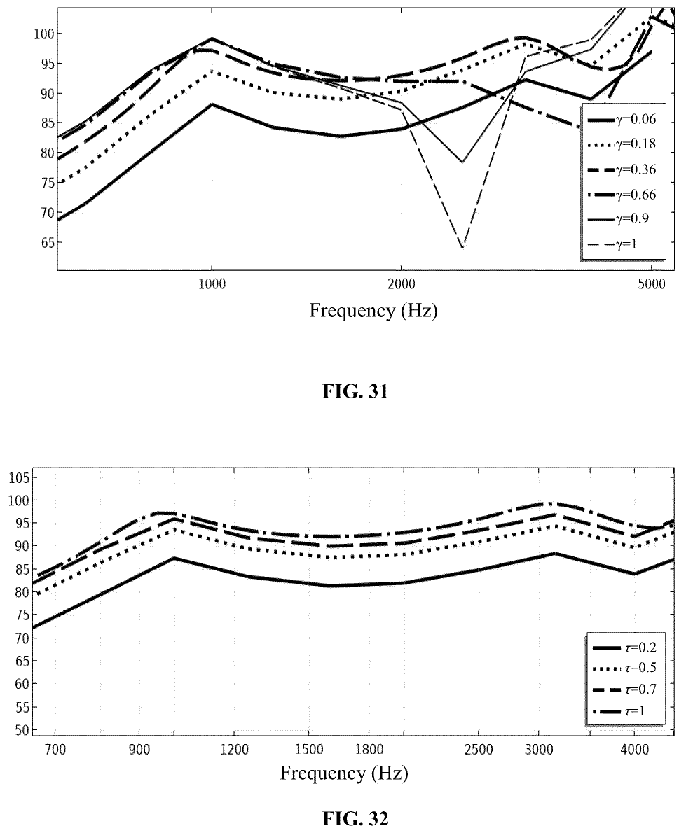

FIG. 31 is a schematic diagram illustrating frequency response curves of a speaker when a physical parameter γ takes different values according to some embodiments of the present disclosure. As shown in FIG. 31, when the ratio γ is relatively large (e.g., when γ=1), which indicates that the length of the electrode 2720 is relatively large, the low-frequency sound pressure level output by the speaker is relatively high, but there is an obvious valley in a mid-frequency range (e.g., around 2500 Hz). As γ gradually decreases (e.g., from 1 to 0.06), the mid-frequency valley of the speaker is improved, but the low-frequency output decreases. When the ratio γ is too small (e.g., γ=0.06), although the mid-frequency valley of the speaker is improved significantly, a deformed portion of the piezoelectric beam 2710 is too small since the length of the electrode 2720 is too short, which may reduce the length of the piezoelectric beam 2710 that contributes to generating a driving force, thereby resulting in insufficient driving force and ultimately reducing the sound pressure level output by the speaker.

In some embodiments, to improve the mid-frequency valley of the speaker and ensure that the speaker has a relatively high output sound pressure level at low frequencies, the value of γ may be in a range of 0.1-0.9. In some embodiments, to make the speaker have a relatively flat output at mid-frequencies, the value of γ may be in a range of 0.2-0.6. In some embodiments, to reduce a difference between the low-frequency output and the mid-frequency output of the speaker, the value of γ may be in a range of 0.3-0.6. In some embodiments, the value of γ may be in a range of 0.3-0.6. In some embodiments, the value of γ may be in a range of 0.3-0.5.

In some embodiments, a width of the electrode may affect a size of a deformation region on the piezoelectric beam. Therefore, the width of the electrode on the piezoelectric beam may be adjusted to regulate the driving force generated by the piezoelectric beam, thereby improving the output of the speaker. As shown in FIG. 28, the width of the electrode 2720 on the suspended region 2712 may be defined as Wₐ, and a physical parameter τ may be defined as a ratio of the width Wₐ of the electrode 2720 to a width Wₚ of the suspended region of the piezoelectric beam 2710, i.e.,

$$τ = \frac{{W}_{a}}{{W}_{p}} . \qquad ( 6 )$$

FIG. 32 is a schematic diagram illustrating frequency response curves of a speaker when a physical parameter τ takes different values according to some embodiments of the present disclosure. As shown in FIG. 32, as the value of the physical parameter τ increases (e.g., the value of τ gradually increases from 0.2 to 1), the width Wₐ of the electrode 2720 and the width Wₚ of the suspended region of the piezoelectric beam 2710 gradually approach each other, and the output sound pressure level of the speaker gradually increases. In some embodiments, under a condition that the length of the electrode distributed on the piezoelectric beam 2710 remains constant (e.g., γ takes a value in the range of 0.1-0.9), the value of τ may be in a range of 0.3-1 to ensure that the speaker has a relatively high output sound pressure level. In some embodiments, the value of τ may be in a range of 0.4-1. In some embodiments, the value of τ may be in a range of 0.5-1.

In some embodiments, the electrode layer may include a first region (or first electrode) near a fixed region (or referred to as a fixed end) and a second region (or second electrode) near a coupling elastic structure (or referred to as a free end). In some embodiments, if a width of the second electrode provided near the free end of the piezoelectric beam is too large, the mid-frequency vibration mode of the piezoelectric beam may tend to have an effect of the piezoelectric beam being fully covered by the electrode, resulting in an obvious mid-frequency valley in the frequency response curve of the speaker. If the width of the second electrode provided near the free end is too small, the area of the piezoelectric beam covered by the second electrode that participates in generating the driving force may be too small, making the improvement in the output sound pressure level of the speaker insignificant. Therefore, in some embodiments, the electrode distribution may be gradient. For example, the width of the first region may be greater than the width of the second region. This configuration may effectively modulate the vibration mode of the piezoelectric beam, thereby improving the output sound pressure level while improving the mid-frequency valley.

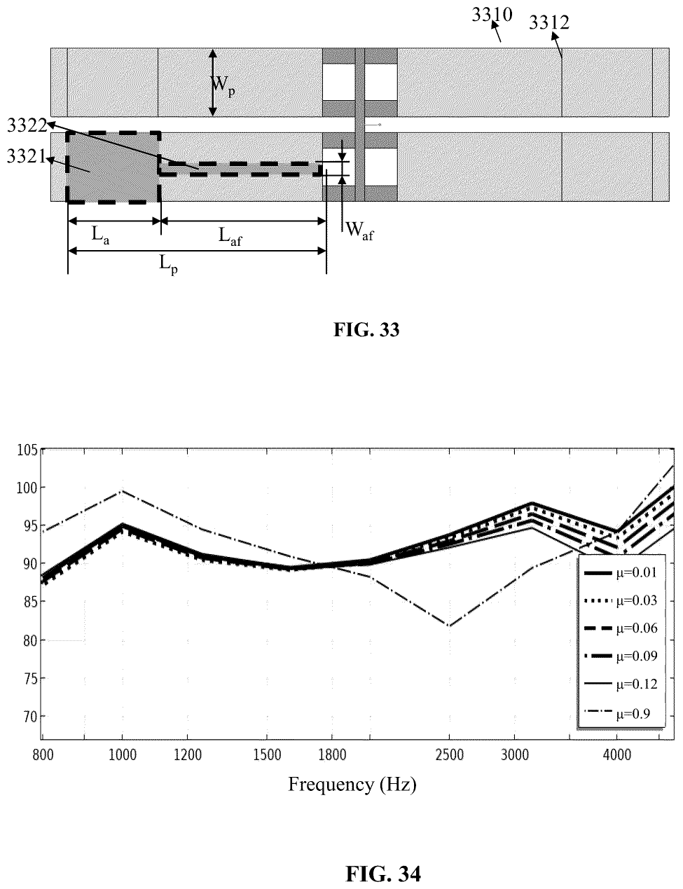

FIG. 33 is a schematic diagram illustrating a distribution of electrodes on a piezoelectric beam according to some embodiments of the present disclosure. As shown in FIG. 33, a piezoelectric beam 3310 may be provided with a first electrode 3321 having a relatively large width and a second electrode 3322 having a relatively small width. The first electrode 3321 and the second electrode 3322 may both be rectangular structures. It should be noted that the distribution of the electrodes (the first electrode 3321 and the second electrode 3322) on only one piezoelectric beam 3310 is shown in FIG. 33, and the distribution of the electrodes on other piezoelectric beams 3310 may refer to the above-described distribution, which will not be repeated herein.

In some embodiments, the width of the second electrode 3322 may be defined as W_{af}, a width of a suspended region 3312 (or the piezoelectric beam 3310) may be defined as Wₚ, and a physical parameter μ may be defined as a ratio of the width W_{af} of the second electrode 3322 to the width Wₚ of the suspended region 3312, i.e.,

$$μ = \frac{{W}_{af}}{{W}_{p}} . \qquad ( 7 )$$

FIG. 34 is a schematic diagram illustrating frequency response curves of a speaker when a physical parameter μ takes different values according to some embodiments of the present disclosure. As shown in FIG. 34, when μ is relatively small, for example, when μ=0.01, an output of the speaker at mid-and-high frequencies is relatively high and a valley of an output sound pressure level of the speaker at the middle frequency (e.g., near 2500 Hz) is improved, but an output of the speaker at low-and-mid frequencies (e.g., 800 Hz-1800 Hz) is relatively small. When μ is relatively large, for example, when μ=0.9, the output of the speaker at mid-and-high frequencies is relatively low, but the output of the speaker at low-and-mid frequencies is relatively high. Referring to FIG. 34, in some embodiments, to enhance the output of the speaker in a full-frequency range, the value of μ may be in a range of 0.01-0.89. In some embodiments, to enhance the output of the speaker in the full-frequency range, the value of μ may be in a range of 0.01-0.7. In some embodiments, to reduce a difference between the output of the speaker at the low and mid frequencies and the output of the speaker at the mid and high frequencies, the value of μ may be in a range of 0.1-0.7. In some embodiments, the value range of μ may also be selected according to the needs of different application scenarios. For example, in a scenario with a high requirement for mid-and-high frequencies, the value of μ may be in a range of 0.01-0.4. As another example, in a scenario with a high requirement for low and mid frequencies, the value of μ may be in a range of 0.4-0.9.

Referring to FIG. 33, in some embodiments, a length of the second electrode 3322 on the piezoelectric beam 3310 near a free end may be defined as L_{af}, a length of the suspended region 3312 may be defined as Lₚ, and a physical parameter x may be defined as a ratio of the length L_{af} of the second electrode 3322 to the length Lₚ of the suspended region 3312, i.e.,

$$x = \frac{{L}_{af}}{{L}_{p}} . \qquad ( 8 )$$

In some embodiments, the length L_{af} of the second electrode 3322 may affect a length of a region on the piezoelectric beam 3310 that is involved in generating a driving force. The larger L_{af} is, the longer the length of the region on the piezoelectric beam 3310 that is involved in generating the driving force may be, the larger the driving force generated by the piezoelectric beam 3310 may be, and the higher the output sound pressure level of the speaker may be. However, the larger the L_{af} is, the closer the deformation of the piezoelectric beam 3310 at a middle frequency is to the case in which the piezoelectric beam 3310 is fully covered by electrodes, which results in the mid-frequency valley in the output frequency response curve of the speaker being more obvious.

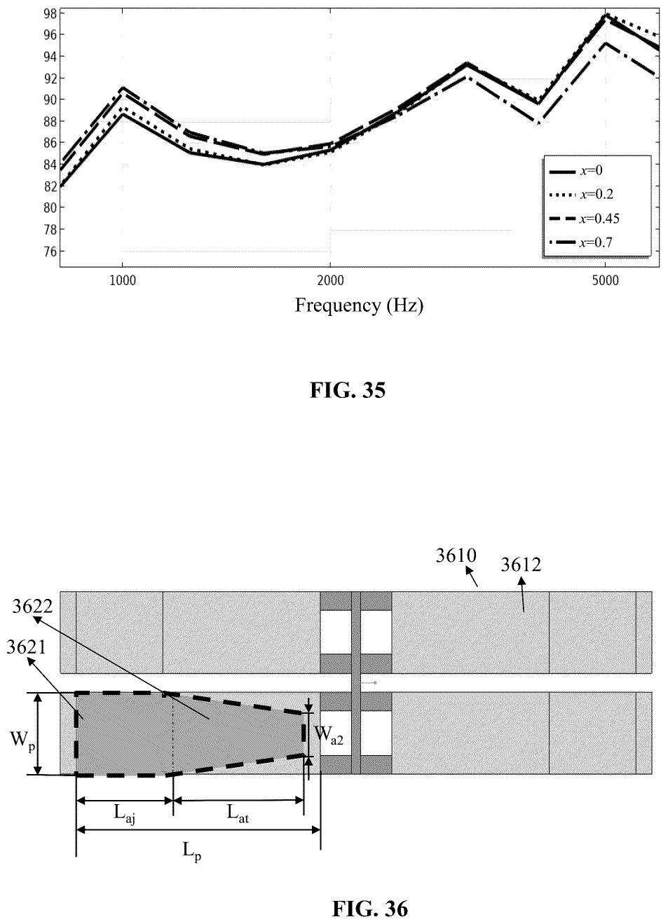

FIG. 35 is a schematic diagram illustrating frequency response curves of a speaker when a physical parameter x takes different values according to some embodiments of the present disclosure. As shown in FIG. 35, when x is relatively small, e.g., when x=0, a mid-frequency (e.g., near 4000 Hz) valley of the speaker is improved significantly, and thus an output of the speaker at mid-and-high frequencies is relatively high, while an output of the speaker at low-frequencies is relatively low. When x is relatively large, e.g., when x=0.7, the output of the speaker at the low-frequencies is relatively good, and the improvement of the mid-frequency valley is relatively poor, and thus the output of the speaker at mid-and-high frequencies is relatively low. Therefore, in some embodiments, taking into account the output effect of the speaker in a full frequency range, the value of x may be in a range of 0.01-0.69. In some embodiments, to further enhance the output of the speaker in the full frequency range, the value of x may be in a range of 0.1-0.5. In some embodiments, to reduce a difference between the output of the speaker at the low and mid frequencies and the output of the speaker at the mid and high frequencies, the value of x may be in a range of 0.2-0.45. In some embodiments, the value range of x may be selected according to the needs of different application scenarios. For example, in a scenario with a high requirement for mid-and-high frequencies, the value of μ may be in a range of 0-0.4. As another example, in a scenario with a high requirement for low-and-mid frequencies, the value of μ may be in a range of 0.4-0.7.

FIG. 36 is a schematic diagram illustrating another distribution of electrodes on a piezoelectric beam according to some embodiments according to the present disclosure. In some embodiments, the electrodes provided on the piezoelectric beam 3610 may include a trapezoidal electrode and a rectangular electrode. As shown in FIG. 36, an electrode layer may include a first region 3621 (or referred to as a first electrode 3621) near a fixed region and a second region 3622 (or referred to as a second electrode 3622) near a coupling elastic structure. The first electrode 3621 may be a rectangle electrode with a relatively large width, and the second electrode 3622 may be a trapezoid electrode with a relatively small width. In some embodiments, the width of the rectangular first electrode 3621 may be the same width as a width of a wide side of the trapezoidal second electrode 3622. It should be noted that only one distribution of the electrodes on the piezoelectric beam is shown in FIG. 36, and the distribution of the electrodes on other piezoelectric beams may refer to the above-described distribution, and will not be repeated herein. By combining the rectangular first electrode 3621 with the trapezoidal second electrode 3622, a vibration mode of the piezoelectric driver may be effectively modulated, a mid-frequency valley of the speaker may be improved, and an output sound pressure level of the speaker may be improved.

Referring to FIG. 36, the length of the rectangular first electrode 3621 covering a suspended region 3612 may be defined as Lₐⱼ, the length of the second electrode 3622 may be defined as Lₐₜ, a length of the suspended region 3612 may be defined as Lₚ, and a physical parameter z may be defined as a ratio of the length Lₐⱼ of the first electrode 3621 to the length Lₚ of the suspended region 3612, i.e.,

$$z = \frac{{L}_{aj}}{{L}_{p}} . \qquad ( 9 )$$

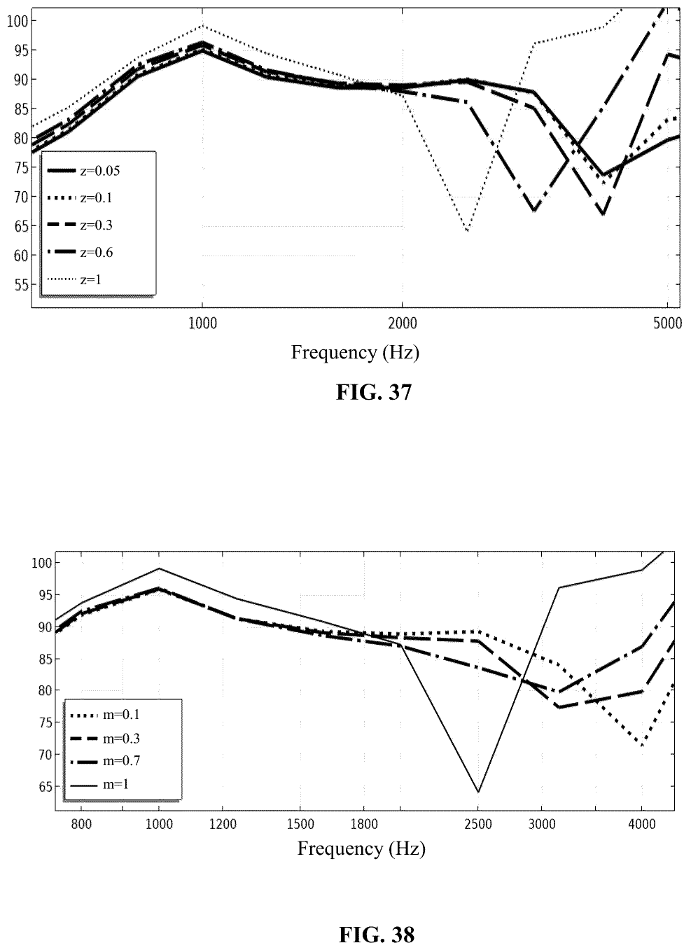

FIG. 37 is a schematic diagram illustrating frequency response curves of a speaker when a physical parameter z takes different values according to some embodiments of the present disclosure. As shown in FIG. 37, as the value of z decreases, e.g., from 1 to 0.05, a mid-frequency (e.g., near 3000 Hz) valley of the speaker moves to high frequencies and the sound pressure level at the valley gradually increases. In addition, as the value of z decreases, an output of the speaker at low frequencies decreases. In some embodiments, to enhance the output of the speaker at mid-to-high frequencies, and ensure the output of the speaker at low frequencies, the value of z may be in a range of 0.05-0.9. In some embodiments, to achieve a relatively flat output over a wider mid-and-low frequency range, the value of z may be in a range of 0.05-0.6. In some embodiments, to ensure the output of the speaker at low frequencies and to better reduce the effect of the mid-frequency valley on the output of the speaker at middle frequencies, the value of z may be in a range of 0.1-0.5.

Continuing to refer to FIG. 36, a width of a narrow side of the second electrode 3622 may be defined as Wₐ₂, a width of the suspended region 3612 may be defined as Wₚ, and a physical parameter m may be defined as a ratio of the width Wₐ₂ of the narrow side of the second electrode 3622 to the width Wₚ of the suspended region 3612, i.e.,

$$m = \frac{{W}_{a 2}}{{W}_{p}} . \qquad ( 10 )$$

FIG. 38 is a schematic diagram illustrating frequency response curves of a speaker when a physical parameter m takes different values according to some embodiments of the present disclosure. As shown in FIG. 38, as the value of the physical parameter m gradually increases, e.g., from 0.1 to 1, an output sound pressure level of the speaker at low frequencies increases, a valley at middle frequencies (e.g., near 2500 Hz) moves toward low frequencies, and the sound pressure level at the valley is significantly reduced when the value of m is too large (e.g., when m=1). In some embodiments, to enhance an output effect of the speaker at low-to-mid frequencies, the value of m may be in a range of 0.1-0.9. In some embodiments, to further reduce an effect of the mid-frequency valley on the output of the speaker at mid frequencies, the value of m may be in a range of 0.1-0.7. In some embodiments, to improve the output of the speaker at low frequencies and reduce the effect of the mid-frequency valley on the output of the speaker at mid frequencies, the value of m may be in a range of 0.3-0.7.

Continuing to refer to FIG. 36, the length of the second electrode 3622 may be defined as Lₐₜ, and a physical parameter γ may be defined as a ratio of the length Lₐₜ of the second electrode 3622 to the length Lₚ of the suspended region 3612, i.e.,

$$y = \frac{{L}_{a t}}{{L}_{p}} . \qquad ( 11 )$$

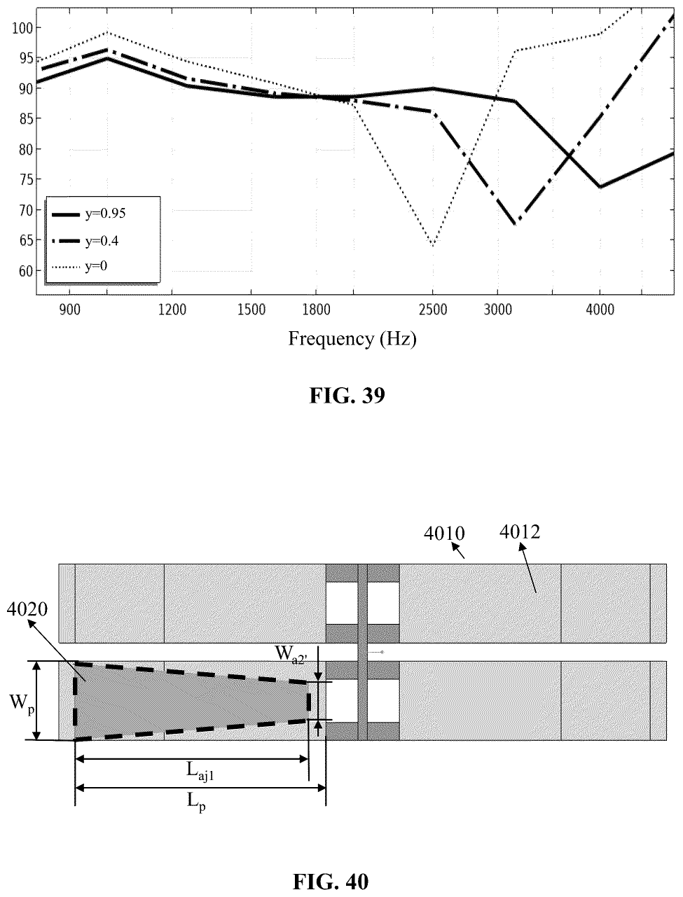

FIG. 39 is a schematic diagram illustrating frequency response curves of a speaker when a physical parameter γ takes different values according to some embodiments of the present disclosure. As shown in FIG. 39, an effect of the physical parameter γ on the output sound pressure level of the speaker is opposite to an effect of the physical parameter z on the output sound pressure level of the speaker. As the value of y gradually increases, for example, from 0 to 0.95, the mid-frequency (e.g., around 2500 Hz) valley of the speaker moves to high frequencies, and the sound pressure level at the valley gradually increases. In addition, as the value of y gradually increases, the output of the speaker at low frequencies decreases. In some embodiments, to enhance the output of the speaker at mid-and-high frequencies while ensuring the output effect of the speaker at low frequencies, the value of y may be in a range of 0.1-0.95. In some embodiments, to achieve a relatively flat output of the speaker over a wider range of low-and-mid frequencies, the value of y may be in a range of 0.3-0.95. In some embodiments, to ensure the output of the speaker at low frequencies and to better reduce the effect of the mid-frequency valley on the output of the speaker at middle frequencies, the value of y may be in a range of 0.5-0.8.

FIG. 40 is a schematic diagram illustrating another distribution of an electrode on a piezoelectric beam according to some embodiments of the present disclosure. As shown in FIG. 40, the electrode 4020 may have a trapezoidal structure. A wide side of the trapezoidal electrode 4020 may be provided on the piezoelectric beam 4010 near a fixed end, and a narrow side of the trapezoidal electrode 4020 may be provided on the piezoelectric beam 4010 near a free end (i.e., an end near a coupling elastic structure). It should be noted that the distribution of the electrode on only one piezoelectric beam is shown in FIG. 40, and the distribution of the electrodes on other piezoelectric beams may refer to the above distribution, which will not be repeated here. By configuring the trapezoidal electrode 4020, a vibration mode of the piezoelectric beam may be effectively modulated, thereby improving the mid-frequency valley of the speaker and improving the output sound pressure level of the speaker.

Referring to FIG. 40, a width of the trapezoidal electrode 4020 near the coupling elastic structure (or referred to as a narrow-side width) may be defined as Wₐ₂′, a width of a suspended region 4012 may be defined as Wₚ, and a physical parameter μ′ may be defined as a ratio of the narrow-side width Wₐ₂′ of the trapezoidal electrode 4020 to the width Wₚ of the suspended region 4012, i.e.,

$${μ}^{′} = \frac{{W}_{a {2}^{′}}}{{W}_{p}} . \qquad ( 12 )$$

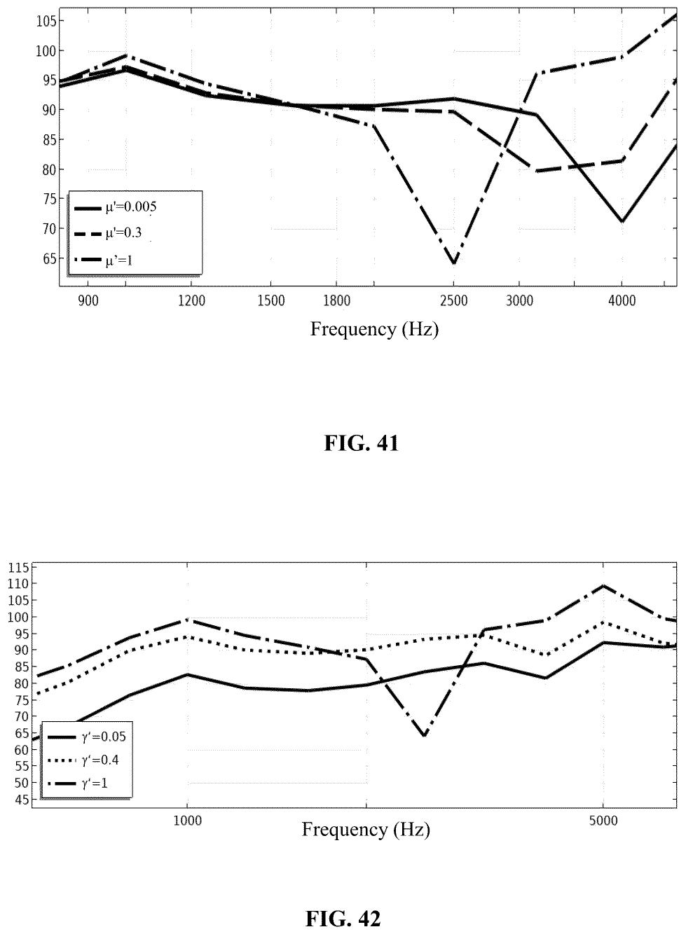

FIG. 41 is a schematic diagram illustrating frequency response curves of a speaker when a physical parameter μ′ takes different values according to some embodiments of the present disclosure. As shown in FIG. 41, as the value of the physical parameter μ′ decreases, e.g., from 1 to 0.005, a mid-frequency (e.g., near 2500 Hz) valley of the speaker gradually moves to high frequencies, the sound pressure level at the valley gradually increases, and an output of the speaker at mid-and-high frequencies increases. Furthermore, as the value of the physical parameter μ′ decreases, the output of the speaker at low frequencies decreases. In some embodiments, to enhance the output of the speaker at mid-and-high frequencies, and to ensure the output of the speaker at low frequencies, the value of μ′ may be in a range of 0.05-0.8. In some embodiments, to achieve a relatively flat output of the speaker over a wider range of low-and-mid frequencies, the value of μ′ may be in a range of 0.05-0.6. In some embodiments, to ensure the output of the speaker at low frequencies and to better reduce an effect of the mid-frequency valley on the output of the speaker at middle frequencies, the value of μ′ may be in a range of 0.2-0.5.

Referring to FIG. 40, in some embodiments, a length of the trapezoidal electrode 4020 covering the suspended region 4012 may be defined as Lₐⱼ₁, a length of the suspended region 4012 may be defined as Lₚ, and a physical parameter γ′ may be defined as a ratio of the length Lₐⱼ₁ of the trapezoidal electrode 4020 covering the suspended region 4012 to the length Lₚ of the suspended region 4012, i.e.,

$${γ}^{′} = \frac{{L}_{aj 1}}{{L}_{p}} . \qquad ( 13 )$$

FIG. 42 is a schematic diagram illustrating frequency response curves of a speaker when a physical parameter γ′ takes different values according to some embodiments of the present disclosure. As shown in FIG. 42, a mid-frequency (e.g., near 4000 Hz) valley of the speaker becomes more obvious (e.g., the sound pressure level at the valley decreases) as the value of γ′ increases, e.g., from 0.05 to 1. In addition, the output of the speaker at low frequencies increases as the value of γ′ increases. In some embodiments, to enhance the output of the speaker at mid-and-high frequencies while ensuring the output of the speaker at low frequencies, the value of γ′ may be in a range of 0.1-0.9. In some embodiments, to enhance the output of the speaker at mid-and-high frequencies while ensuring the output of the speaker at low frequencies, the value of γ′ may be in a range of 0.1-0.7. In some embodiments, to enhance the output of the speaker at mid-and-high frequencies while ensuring the output of the speaker at low frequencies, the value of γ′ may be in the range of 0.2-0.6.

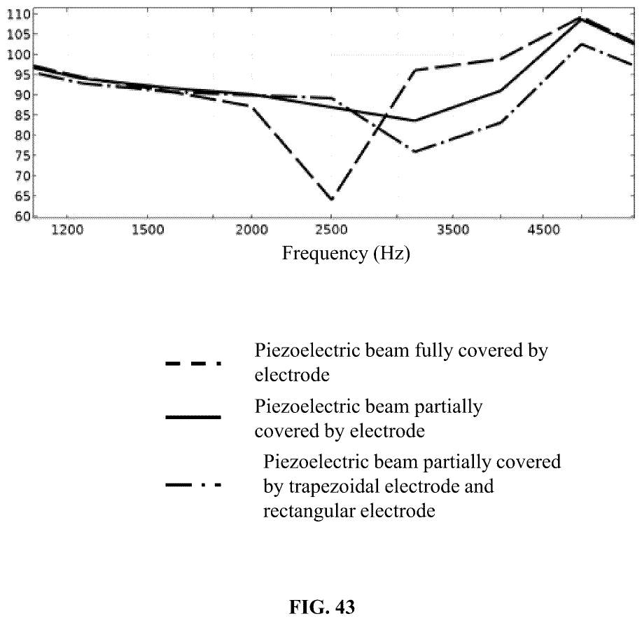

FIG. 43 is a schematic diagram illustrating frequency response curves of a speaker corresponding to different electrode shapes according to some embodiments of the present disclosure. As shown in FIG. 43, compared with a piezoelectric beam fully covered by an electrode, a piezoelectric beam partially covered by a trapezoidal electrode and a piezoelectric beam partially covered by a trapezoidal electrode and a rectangular electrode better realize the modulation of a vibration pattern of the piezoelectric beam at middle frequencies (e.g., near 2,500 Hz), thereby enhancing an output sound pressure level of the speaker and improving a mid-frequency valley of the speaker. Among the above three piezoelectric beams, the piezoelectric beam partially covered by a trapezoidal electrode and a rectangular electrode achieves the best effect. Therefore, to enhance the output of the speaker at mid-and-high frequencies while ensuring the output of the speaker at low frequencies, the distribution of electrodes on the piezoelectric beam may be configured in the form of a combination of a trapezoidal shape and a rectangular shape. It should be noted that the distribution of the electrodes on the piezoelectric beam may also be configured based on actual needs, which is not limited by the present disclosure.

In some embodiments, an electrode layer may include a first region (or referred to as a first electrode) near a fixed region, a second region (or referred to as a second electrode) near a coupling elastic structure, and a third region (or referred to as a third electrode) connecting the first region and the second region, wherein a width of the third region may be smaller than a width of the first region and a width of the second region.

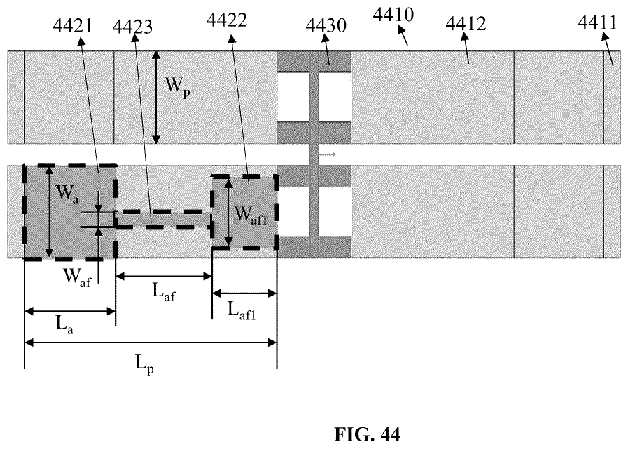

FIG. 44 is a schematic diagram illustrating another distribution of electrodes on a piezoelectric beam according to some embodiments of the present disclosure.

As shown in FIG. 44, a piezoelectric beam 4410 may be provided with a first electrode 4421, a second electrode 4422, and a third electrode 4423 having varying widths, and the first electrode 4421, the second electrode 4422, and the third electrode 4423 are all rectangular structures. The first electrode 4421 with the largest width may be disposed at an end of the piezoelectric beam 4410 near a fixed region 4411, the second electrode 4422 with a medium width may be disposed at an end of the piezoelectric beam 4410 near a coupling elastic structure 4430, and the third electrode 4423 with the smallest width may be disposed in a middle region of the piezoelectric beam 4410. In other words, along a length direction of the piezoelectric beam 4410, the third electrode 4423 is disposed between the first electrode 4421 and the second electrode 4422, and the first electrode 4421, the second electrode 4422, and the third electrode 4423 form a double-step structure. It should be noted that the distribution of the electrodes (the first electrode 4421, the second electrode 4422, and the third electrode 4423) on only one piezoelectric beam 4410 is shown in FIG. 44, and the distribution of the electrodes on other piezoelectric beams may refer to the above-described distribution, which will not be repeated herein.

In some embodiments, if a width and a length of the second electrode 4422 on the piezoelectric beam 4410 near a free end are too large, a vibration mode of the piezoelectric beam 4410 at middle frequencies may be close to a vibration mode of the piezoelectric beam fully covered by electrodes, so that the output sound pressure level of the speaker has an obvious mid-frequency valley. If the width and the length of the second electrode 4422 of the piezoelectric beam 4410 near the free end are too small, an area of a portion of the piezoelectric beam 4410 that is covered by the second electrode 4422 and involved in generating a driving force may be too small, and thus the enhancement of the output sound pressure level of the speaker is not obvious.

In some embodiments, a length of the second electrode 4422 may be defined as L_{af1}, a length of a suspended region 4412 may be defined as Lₚ, and a physical parameter n may be defined as a ratio of the length L_{af1} of the second electrode 4422 to the length Lₚ of the suspended region 4412, i.e.,

$$η = \frac{{L}_{af 1}}{{L}_{p}} . \qquad ( 14 )$$

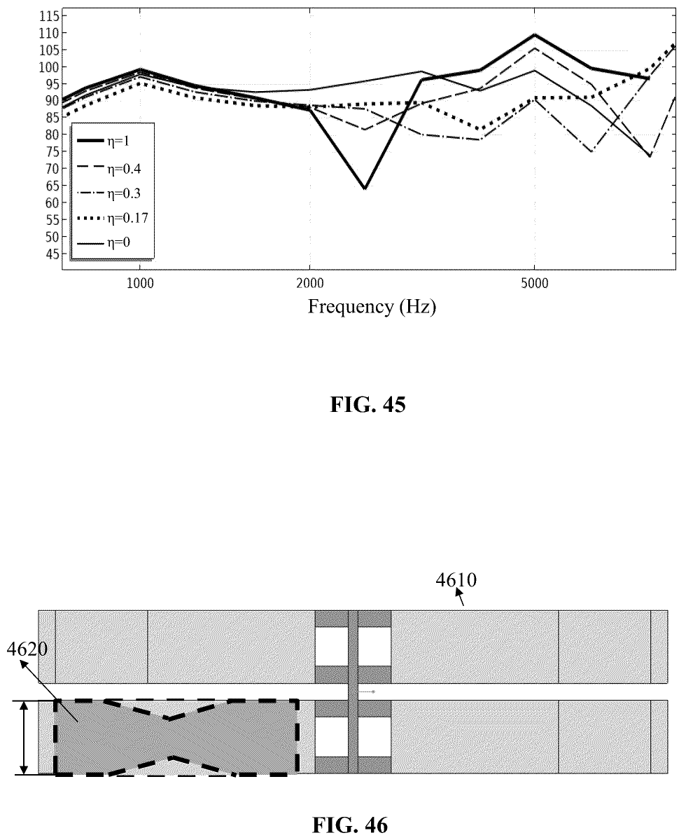

FIG. 45 is a schematic diagram illustrating frequency response curves of a speaker when a physical parameter η takes different values according to some embodiments of the present disclosure. As shown in FIG. 45, as η decreases gradually (e.g., from 1 to 0), a mid-frequency (e.g., near 2500 Hz) valley of the speaker gradually increases, and thus an output of the speaker at mid-and-high frequencies is improved while an output of the speaker at low frequencies is reduced. In some embodiments, to enhance the mid-frequency valley of the speaker while ensuring the output of the speaker at low frequencies, the value of η may be in a range of 0.1-0.8. In some embodiments, to better reduce an effect of the mid-frequency valley on the mid-frequency output of the speaker, the value of η may be in a range of 0.1-0.6. In some embodiments, to further enhance the output of the speaker at low frequencies while reducing the effect of the mid-frequency valley on the mid-frequency output of the speaker, the value of n may be in a range of 0.2-0.5.

In some embodiments, if a width W_{af1} of the second electrode 4422 is too large, the vibration mode of the piezoelectric beam 4410 at middle frequencies may be close to the vibration mode of the piezoelectric beam fully covered by electrodes, which makes the mid-frequency valley of the speaker obvious. If the width W_{af1} of the second electrode 4422 is too small, the area of the portion of the piezoelectric beam 4410 that is covered by the second electrode 4422 and involved in generating the driving force may be too small, so that the enhancement of the output sound pressure level of the speaker is not obvious. In some embodiments, a range of a ratio of the width W_{af1} of the second electrode 4422 to the width Wₚ of the suspended region 4412 may be the same as a range of the ratio u of the width W_{af} of the third electrode 4423 (or the second electrode 3322 shown in FIG. 33) to the width Wₚ of the suspended region 4412 (or the suspended region 3312 shown in FIG. 33), i.e., the ratio of W_{af1} to Wₚ may be in a range of 0.01-0.89. In some embodiments, to further enhance the output of the speaker in a full frequency range, the ratio of W_{af1} to Wₚ may be in a range of 0.01-0.7. In some embodiments, to reduce a difference between an output of the speaker at low-and-mid frequencies and an output of the speaker at mid-and-high frequencies, the ratio of W_{af1} to Wₚ may be in a range of 0.1-0.7. In some embodiments, the ratio of W_{af1} to Wₚ may be determined according to the needs of different application scenarios. For example, in a scenario with a high requirement for mid-and-high frequencies, the ratio of W_{af1} to Wₚ may be in a range of 0.01-0.4. As another example, in a scenario with a high requirement for low-and-mid frequencies, the ratio of W_{af1} to Wₚ may be in a range of 0.4 to 0.9.

FIG. 46 is a schematic diagram illustrating another distribution of electrodes on a piezoelectric beam according to some embodiments of the present disclosure.

In some embodiments, the electrodes provided on the piezoelectric beam may have a particular shape. In some embodiments, the second region may be arc-shaped. As shown in FIG. 46, the electrode provided on the piezoelectric beam 4610 may be double-arc shaped. In other words, in a width direction of the piezoelectric beam 4610, the electrode 4620 may have an arc-shaped groove at each of the two ends of the piezoelectric beam 4610. In some embodiments, a shape of the arc-shaped groove may include a circular arc, an elliptical arc, a hyperbolic arcs, or the like. It should be noted that the distribution of electrodes on only one of the piezoelectric beam 4610 is shown in FIG. 46, and the distribution of electrodes on other piezoelectric beams may refer to the above-mentioned distribution, which will not be repeated herein.

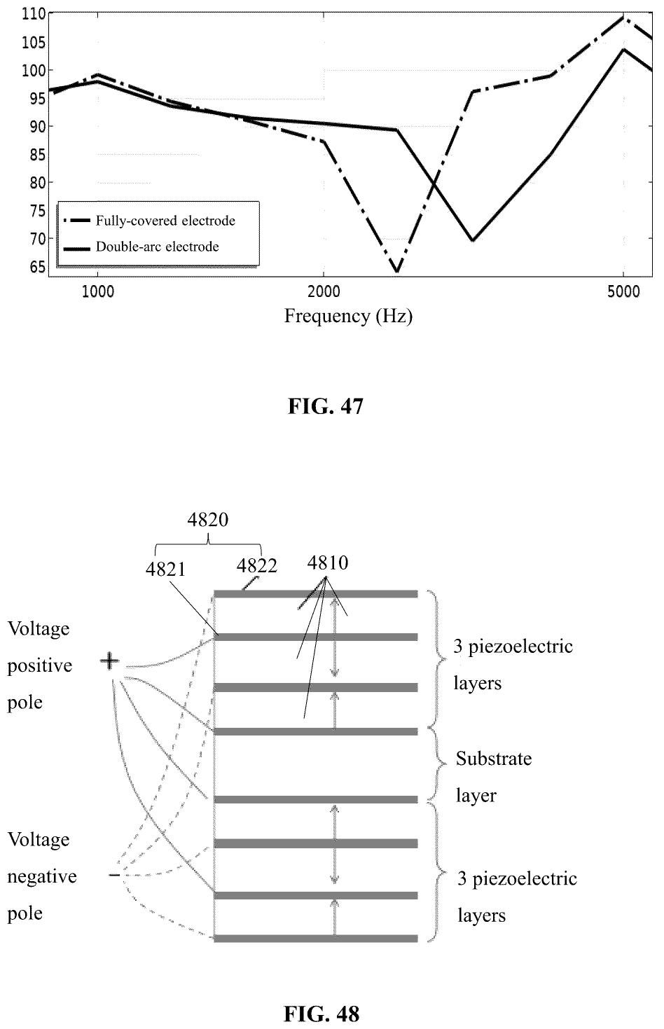

FIG. 47 is a schematic diagram illustrating frequency response curves of a speaker provided with a double-arc electrode and a fully-covered electrode, respectively, according to some embodiments of the present disclosure. As shown in FIG. 47, compared to a piezoelectric beam fully covered by electrodes, a mid-frequency (e.g., around 3000 Hz) valley moves to high frequencies and the sound pressure level at the valley is improved when the piezoelectric beam is provided with the double-arc electrode. Therefore, the speaker with a piezoelectric beam provided with the double-arc electrode may better adjust the mid-frequency valley.

FIG. 48 is a schematic diagram illustrating a structure of an electrode lead-out manner on a piezoelectric beam according to some embodiments of the present disclosure.

As shown in FIG. 48, the piezoelectric beam includes a plurality of piezoelectric layers 4810 which may be configured to deform in response to an electrical signal, the deformation of the plurality of piezoelectric layers may drive the piezoelectric beam to generate vibrations. In a vibration direction of the piezoelectric beam, each piezoelectric layer 4810 of the plurality of piezoelectric layers 4810 may be provided with an electrode layer 4820 (or referred to as an electrode) on each side of the piezoelectric layer, including a positive electrode layer 4821 and a negative electrode layer 4822. The positive electrode layer 4821 may be connected to a positive voltage pole and the negative electrode layer 4822 may be connected to a negative voltage pole.

In some embodiments, for the piezoelectric beam provided with the plurality of piezoelectric layers 4810, corresponding voltages may be applied to the electrodes 4820 of different piezoelectric layers 4810 such that the piezoelectric layers 4810 may deform under a piezoelectric action. Therefore, a plurality of electrode layers 4820 (the positive electrode layers 4821) may be connected to the positive pole of a power supply, and a plurality of electrode layers 4820 (the negative electrode layers 4822) may be connected to the negative pole of the power supply. In some embodiments, the plurality of electrode layers 4820 may be led out using techniques such as soldering wires or bonding a flexible printed circuit (FPC) using solder or conductive adhesive. For piezoelectric beams with a single or fewer piezoelectric layers, the lead-out of the electrode layer(s) may be completed quickly and easily. However, as a count of the piezoelectric layers increases, soldering wires to each layer may result in too many solder wires, a complex process, poor product yields and stability, and larger product sizes. The above problems may be effectively improved by configuring electrode leads.

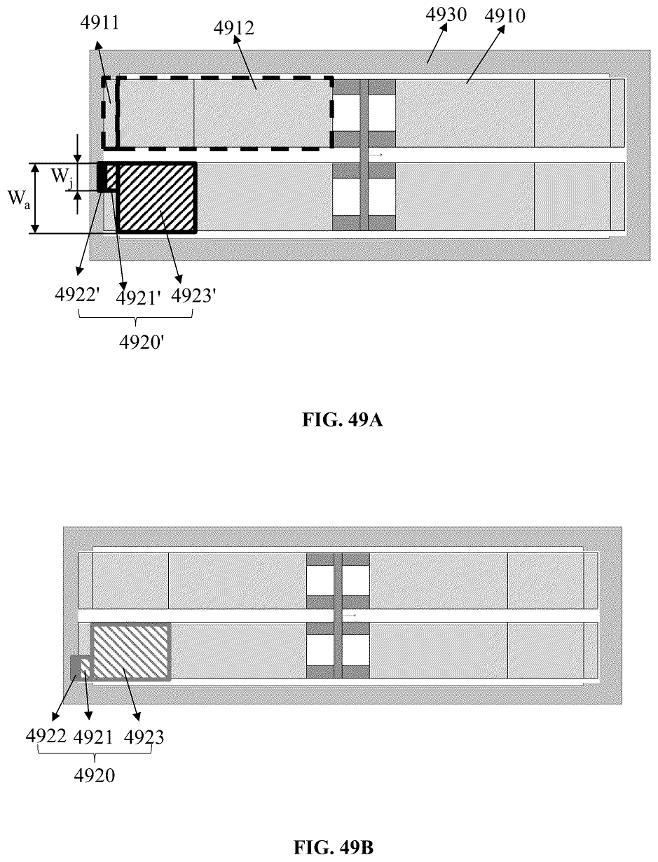

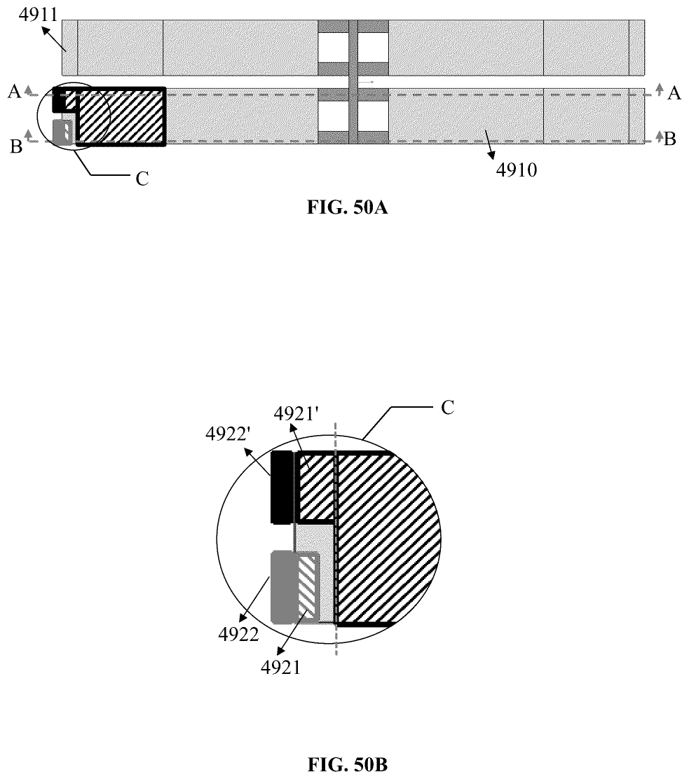

FIG. 49A and FIG. 49B are schematic diagrams illustrating electrodes on a piezoelectric beam according to some embodiments of the present disclosure. FIG. 49A shows an electrode layer (or referred to as a positive electrode layer) to which a positive voltage is applied, and FIG. 49B shows an electrode layer (or referred to as a negative electrode layer) to which a negative voltage is applied. It should be noted that FIG. 49A and FIG. 49B are illustrative only, and in some embodiments, the polarity of the electrodes shown in FIG. 49A and FIG. 49B may be reversed. For example, FIG. 49A may show an electrode layer (or referred to as the negative electrode layer) to which a negative voltage is applied, and FIG. 49B may show an electrode layer (or referred to as the positive electrode layer) to which a positive voltage is applied. In some embodiments, each piezoelectric layer on the piezoelectric beam may include a positive electrode layer and a negative electrode layer, and along a vibration direction of the piezoelectric beam 4910, the positive electrode layer and the negative electrode layer may be disposed on two sides of the piezoelectric layer, respectively. Referring to FIG. 49A and FIG. 49B, the piezoelectric beam 4910 may include a fixed region 4911 and a suspended region 4912. In some embodiments, the piezoelectric beam 4910 may be connected to a back plate 4930 in the fixed region 4911, which does not have, or has a minor contribution to providing a driving force due to the fixed configuration of the fixed region 4911. Therefore, in some embodiments, the structure of the electrodes may be configured in the fixed region 4911 without affecting the vibration of the piezoelectric beam 4910.

Taking a negative electrode layer as an example, as shown in FIG. 49B, a negative electrode layer 4920 may include a first electrode 4921 disposed on the fixed region 4911, a lead structure 4922 disposed on a side of the piezoelectric beam 4910, and a second electrode 4923 disposed on the suspended region 4912, wherein the side of the piezoelectric beam 4910 on which the lead structure 4922 is provided refers to a side of the piezoelectric beam 4910 that extends along a width direction of the piezoelectric beam 4910. In some embodiments, for each piezoelectric layer, the first electrode 4921 thereon may lead out the second electrode 4923 disposed on the suspended region 4912 and connect the second electrode 4923 to the lead structure 4922. In some embodiments, the lead structure 4922 may lead the electrodes of each layer that are required to be applied with the same voltage. For example, the lead structure 4922 of each piezoelectric layer may be interconnected to conduct the negative electrode layer of each piezoelectric layer. As another example, the positive electrode layer shown in FIG. 49A may have the same or similar configuration as the electrode layer shown in FIG. 49 B. For example, the positive electrode layer 4920′ shown in FIG. 49A may include a first electrode 4921′, a lead structure 4922′, and a second electrode 4923′, and the lead structure 4922′ of each piezoelectric layer may be connected so as to conduct the positive electrode layer of each piezoelectric layer. In other words, the side of the piezoelectric beam may be provided with two lead structures, one of the two lead structures may be electrically connected to a plurality of positive electrode layers of the plurality of piezoelectric layers, and the other of the two lead structures may be electrically connected to a plurality of negative electrode layers of the plurality of piezoelectric layers. In some embodiments, electrode layers applied with different voltages may not be electrically connected. For example, when a plurality of piezoelectric layers are stacked, in a projection plane along the vibration direction of the piezoelectric beam 4910, the first electrode 4921′ of each positive electrode layer and the first electrode 4921 of the negative electrode layer may not be interconnected. Correspondingly, the conduction structure 4922′ of each positive electrode layer and the lead structure 4922 of each negative electrode layer may also not be overlapped, so that the positive electrodes and the negative electrodes do not conduct.

In some embodiments, to dispose the two lead structures staggeringly along the width direction of the piezoelectric beam, i.e., there is no overlap between the lead structure of each positive electrode layer and the lead structure of each negative electrode layer in the projection plane along the vibration direction of the piezoelectric beam, in the width direction of the piezoelectric beam, a width of the lead structure of each positive electrode layer and a width of the lead structure of each negative electrode layer may both be less than half of a width of the piezoelectric beam. As shown in FIG. 49A, in some embodiments, the half-width of the piezoelectric beam 4910 may be defined as Wⱼ, a width of the electrode layer covering the fixed region may be defined as Wₐ, and a physical parameter WW may be defined as:

$$WW = \frac{{W}_{a}}{2} - {W}_{j} \qquad ( 15 )$$

In some embodiments, to ensure that the positive electrodes and the negative electrodes do not conduct, the physical parameter WW may be not less than 5 μm. In some embodiments, to further reduce the risk of conduction between the positive electrodes and the negative electrodes, the physical parameter WW may be not less than 10 μm.

In some embodiments, as shown in FIGS. 49A and 49B, the two lead structures may be disposed on a side of the piezoelectric beam that extends along the width direction of the piezoelectric beam. In some embodiments, the two lead structures may be disposed on two sides of the piezoelectric beam that extend along a length direction of the piezoelectric beam, respectively.

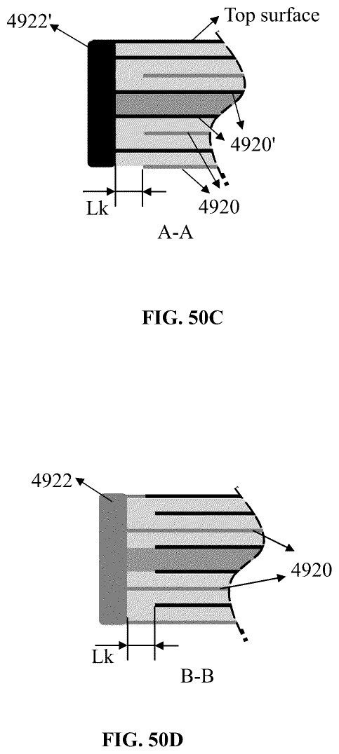

FIG. 50A and FIG. 50B are schematic diagrams illustrating structures of a piezoelectric beam according to some embodiments of the present disclosure. FIG. 50A shows the two structures shown in FIG. 49A and FIG. 49B, FIG. 50 B shows an enlarged view of the C region in FIG. 50A, FIG. 50C shows a cross-section view of the piezoelectric beam shown in FIG. 50A along section A-A, and FIG. 50D shows a cross-section view of the piezoelectric beam shown in FIG. 50A along section B-B. Referring to FIGS. 50A-50D, the first electrode 4921 may connect electrode layers of each piezoelectric layer that require a voltage of a same polarity (e.g., a negative voltage) through a lead structure 4922 located on the side of the piezoelectric beam 4910 that extends along the width direction of the piezoelectric beam 4910 (or on a side of the width direction of the piezoelectric beam that corresponds to the fixing region 4911), and the first electrode 4921′ may connect electrode layers of each piezoelectric layer that require a voltage of a same polarity (e.g., a negative voltage) through a lead structure 4922′ located on the side of the piezoelectric beam 4910 that extends along the width direction of the piezoelectric beam 4910 (or on a side of the width direction of the piezoelectric beam that corresponds to the fixing region 4911). For ease of description, the lead structure 4922 may be referred to as a side negative electrode and the lead structure 4922′ may be referred to as a side positive electrode.

In some embodiments, the first electrode 4921 may not overlap with the first electrode 4921′ in a projection plane along the vibration direction of the piezoelectric beam 4910, and correspondingly, the side negative electrode may not overlap with the side positive electrode. As shown in FIG. 50C and FIG. 50D, a plurality of negative electrode layers 4920 and a plurality of positive electrode layers 4920′ may be disposed on the piezoelectric beam 4910 along the vibration direction of the piezoelectric beam 4910 (or along a thickness direction of the fixed region 4911). Within a projection range of the fixed region 4911, the plurality of negative electrode layers 4920 and the plurality of positive electrode layers 4920′ may also be provided with avoidance regions, respectively. As shown in FIG. 50C, the positive electrode layers 4920′, which require to be applied with a positive voltage, may be connected to the side positive electrodes, and the negative electrode layers 4920, which require to be applied with a negative voltage, may be provided with avoidance regions each of which has a length of Lₖ, such that the negative electrode layers 4920 do not conduct with the side positive electrodes. Similarly, as shown in FIG. 50D, avoidance regions each of which has a length of Lₖ may be provided between the positive electrode layers 4920′ which require to be applied with a positive voltage and the side negative electrode, so that the positive electrode layers 4920′ do not conduct with the side negative electrodes. In some embodiments, the length Lₖ needs to be within a preset range to ensure that the positive electrode layers 4920′ and the negative electrode layers 4920 are connected to the corresponding side electrodes, respectively. In some embodiments, the value of Lₖ may be not less than 2 μm. In some embodiments, the value of Lₖ may be not less than 5 μm. In some embodiments, the value of Lₖ may be not less than 10 μm.

In some embodiments, the connection between the fixed region 4911 of the piezoelectric beam 4910 and the back plate may be achieved by gluing, mechanical snap-fits, bonding, or the like. Alternatively, the fixed region 4911 of the piezoelectric beam 4910 and the back plate may be electrically connected by soldering wires, binding, or the like. In some embodiments, to simplify the connection manner and avoid the instability issues of wire bonding, the piezoelectric beam 4910 may also be electrically and mechanically connected to the back plate through solder joints. In some embodiments, the piezoelectric beam 4910 may be electrically connected to the back plate through solder joints while using adhesive for mechanical reinforcement. In some embodiments, when using solder joints for electrical and mechanical connection, the first electrode 4921 and the first electrode 4921′ in the fixed region 4911 may serve as electrical connection solder points. For example, the first electrode 4921 and the first electrode 4921′ on the top surface of the piezoelectric beam 4910 may be used as electrical connection solder points, achieving both electrical and mechanical connection between the piezoelectric beam 4910 and the back plate.

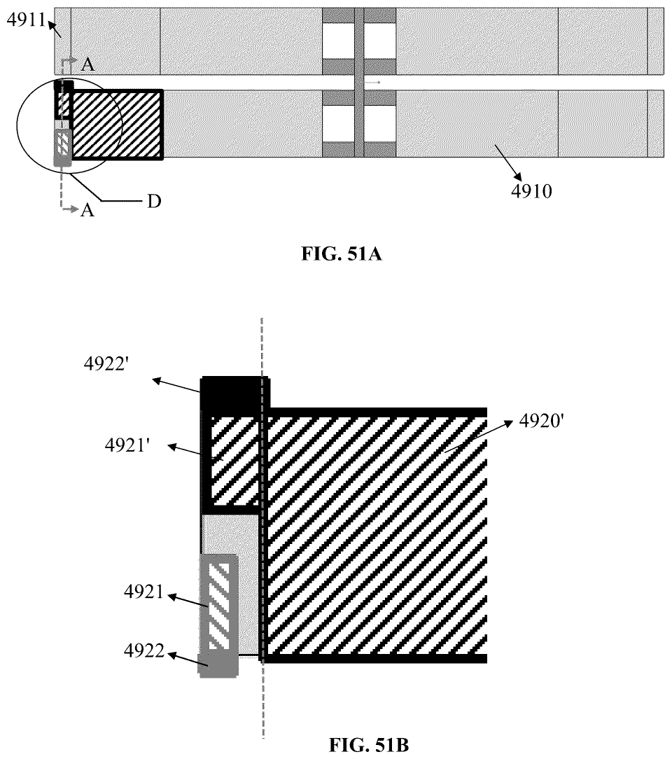

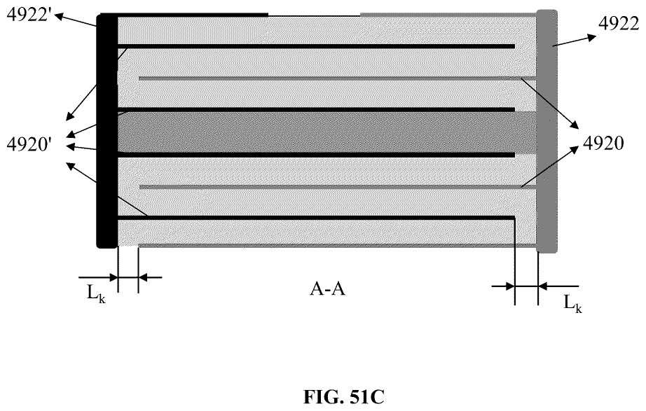

FIG. 51A is a schematic diagram illustrating another structure of a piezoelectric beam according to some embodiments of the present disclosure. FIG. 51B is a schematic diagram illustrating an enlarged view of region D in FIG. 51A. FIG. 51C is a schematic diagram illustrating a cross-section view of the piezoelectric beam shown in FIG. 51A along section A-A. FIG. 51A shows positive electrodes and negative electrodes to which positive and negative voltages are applied, respectively. In some embodiments, as shown in FIGS. 51A-51B, the lead structure 4922′ of the positive electrode layers 4920 (or referred to as side positive electrodes) and the lead structure 4922 of the negative electrode layers 4920′ (or referred to as side negative electrodes) may be located on two sides of the piezoelectric beam 4910 that extend along a length of the piezoelectric beam 4910, respectively. Within a projection range of the fixed region 4911, the negative electrode layers 4920 and the positive electrode layers 4920′ may also be provided with an avoidance region, respectively. As shown in FIG. 51 C, the positive electrode layers 4920′ which require to be applied with a positive voltage may be connected to the side positive electrodes, and avoidance regions each of which has a length of Lₖ may be provided between the side positive electrodes and the negative electrode layers 4920 which require to be applied with a negative voltage, such that the negative electrode layers 4920 do not conduct with the side positive electrodes. Similarly, avoidance regions each of which has a length of Lₖ may be provided between the side negative electrodes and the positive electrode layer 4920′ which require to be applied with a positive voltage, such that the positive electrode layer 4920′ does not conduct with the side negative electrodes.

Having thus described the basic concepts, it may be rather apparent to those skilled in the art after reading this detailed disclosure that the foregoing detailed disclosure is intended to be presented as illustrative example and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

As another example, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This way of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties configured to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims are approximations that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrating of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A speaker, comprising:
a driving unit configured to generate vibrations under the drive of an electrical signal;
a vibrating unit;
a vibration transmission part, the vibration transmission part being connected to the driving unit and the vibrating unit, and configured to transmit the vibrations to the vibrating unit to produce sound radiated outwardly; and
a housing configured to accommodate the driving unit, the vibrating unit, and the vibration transmission part, wherein
the driving unit includes a piezoelectric beam, the housing encloses a cavity,
a portion of the piezoelectric beam is fixedly connected to the housing to form a fixed region, and another portion of the piezoelectric beam is suspended over the cavity to form a suspended region,
the suspended region has a first projection area in a vibration direction of the piezoelectric beam,
the cavity has a second projection area in the vibration direction of the piezoelectric beam, and
a ratio of the first projection area to the second projection area is in a range of 0.35 to 0.92.

2. The speaker of claim 1, wherein the square root of a ratio of a thickness of the piezoelectric beam to the square of a length of the suspended region is in a range of 0.01 to 0.2.

3. The speaker of claim 1, wherein the piezoelectric beam has at least two different widths at different positions along an extending direction of the piezoelectric beam.

4. The speaker of claim 3, wherein a ratio of a minimum width in the at least two different widths to a maximum width in the at least two different widths is in a range of 0.5 to 0.99.

5. The speaker of claim 1, wherein the piezoelectric beam includes a piezoelectric layer and an electrode layer, the piezoelectric layer is configured to deform in response to the electrical signal, the deformation of the piezoelectric layer drives the piezoelectric beam to generate the vibrations, wherein,
on a projection plane along a vibration direction of the piezoelectric beam, the electrode layer partially covers the piezoelectric layer.

6. The speaker of claim 5, wherein
an end of the piezoelectric beam opposite to the fixed region in the extending direction of the piezoelectric beam is connected to the vibration transmission part, and
a distance from a center of the electrode layer to the fixed region is less than a distance from the center of the electrode layer to the end of the piezoelectric beam that is connected to the vibration transmission part.

7. The speaker of claim 5, wherein a ratio of a length of the electrode layer covering the suspended region to a length of the suspended region in the extending direction of the piezoelectric beam is in a range of 0.1 to 0.9.

8. The speaker of claim 5, wherein a ratio of a width of the electrode layer covering the suspended region to a width of the suspended region is in a range of 0.3 to 1.

9. The speaker of claim 5, wherein:
the vibration transmission part includes a vibration transmission column and a coupling elastic structure, the driving unit is connected to an end of the vibration transmission column through the coupling elastic structure, and another end of the vibration transmission column is connected to the vibrating unit to transmit the vibrations; and
the electrode layer includes a first region near the fixed region and a second region near the coupling elastic structure, wherein a width of the first region is greater than a width of the second region.

10. The speaker of claim 9, wherein the first region and the second region are rectangular electrodes, and a ratio of the width of the second region to a width of the suspended region is in a range of 0.01 to 0.89.

11. The speaker of claim 9, wherein the first region is a rectangular electrode and the second region is a trapezoidal electrode, a ratio of a length of the rectangular electrode to a length of the suspended region is in a range of 0.05 to 0.9.

12. The speaker of claim 5, wherein:
the vibration transmission part includes a vibration transmission column and a coupling elastic structure, the driving unit is connected to an end of the vibration transmission column through the coupling elastic structure, and another end of the vibration transmission column is connected to the vibrating unit to transmit the vibrations; and
the electrode layer includes a first region near the fixed region, a second region near the coupling elastic structure, and a third region connecting the first region and the second region, wherein a width of the third region is smaller than a width of the first region and a width of the second region.

13. The speaker of claim 12, wherein a ratio of a length of the second region to a length of the suspended region is in a range of 0.1 to 0.8, or a ratio of the width of the second region to a width of the suspended region is in a range of 0.01 to 0.89.

14. The speaker of claim 1, wherein
the piezoelectric beam includes a plurality of piezoelectric layers configured to deform in response to the electrical signal, the deformation of the plurality of piezoelectric layers driving the piezoelectric beam to generate the vibrations, and two lead structures are provided on a side of the piezoelectric beam, wherein one lead structure is electrically connected to a plurality of positive electrode layers in the plurality of piezoelectric layers, and another lead structure is electrically connected to a plurality of negative electrode layers in the plurality of piezoelectric layers, wherein
the two lead structures are staggered in a width direction of the piezoelectric beam, and a difference between half a width of the piezoelectric beam and a width of a portion of any one of the plurality of positive electrode layers or the plurality of negative electrode layers that covers the fixed region is not less than 5 μm.

15. The speaker of claim 1, wherein the vibrating unit includes:
a diaphragm, including a fixing part, a central part, and a corrugation part, wherein the diaphragm is connected to the housing via the fixing part, the corrugation part is located between the fixing part and the central part; and
a central reinforcing part configured to be connected to at least a portion of the central part to reinforce vibrations of the diaphragm, wherein
the central part has a suspended region that is not covered by the central reinforcing part, the suspended region of the central part has a first area, the central part has a second area, and a ratio of the first area to the second area is in a range of 0.01 to 0.35.

16. The speaker of claim 15, wherein one or more openings are provided on the central reinforcing part, and a ratio of an area of the one or more openings to an area of the central reinforcing part is in a range of 0.01 to 0.35.

17. The speaker of claim 15, wherein a stiffness of the central reinforcing part gradually decreases from a middle of the central reinforcing part towards two ends of the central reinforcing part along a length direction of the central reinforcing part.

18. The speaker of claim 1, wherein
the vibration transmission part includes a coupling elastic structure and a vibration transmission column, the driving unit is connected to an end of the vibration transmission column through the coupling elastic structure, and another end of the vibration transmission column is connected to the vibrating unit to transmit the vibrations, wherein
a width Lo and a thickness ho of the coupling elastic structure, a length Lp of the suspended region, and a thickness h of the piezoelectric beam satisfy
$$ζ = \frac{\sqrt{{h}_{o} / {L}_{o}^{2}}}{\sqrt{h / {L}_{p}^{2}}} ,$$
and ζ is not less than 0.35.

19. The speaker of claim 18, wherein a projection of the coupling elastic structure along a vibration direction of the piezoelectric beam has at least one bending structure.

20. The speaker of claim 18, wherein an end of the vibration transmission column is provided with a relief groove.
